(19) United States
(12) Patent Application Publication
(10) Pub. No.: US 2018/0254959 A1
(43) Pub. Date: Sep. 6, 2018

(54) USER INTERFACE METHOD AND APPARATUS FOR NETWORKED DEVICES

(71) Applicant: PCMS Holdings, Inc., Wilmington, DE (US)

(72) Inventors: Jani Mantyjarvi, Oulunsalo (FI); Jussi Ronkainen, Oulu (FI); Marko Palviainen, Espoo (FI); Markus Tuomikoski, Kempele (FI)

(73) Assignee: PCMS Holdings, Inc., Wilmington, DE (US)

(21) Appl. No.: 15/757,302

(22) PCT Filed: Sep. 1, 2016
(86) PCT No.: PCT/US2016/049978

§ 371 Date: Mar. 2, 2018

Related U.S. Application Data
(60) Provisional application No. 62/214,490, filed on Sep. 4, 2015.
(60) Provisional application No. 62/220,289, filed on Sep. 18, 2015.
(60) Provisional application No. 62/240,283, filed on Oct. 12, 2015.
(60) Provisional application No. 62/240,038, filed on Oct. 12, 2015.

(51) Int. Cl. H04L 12/24; G06F 3/0488

(52) U.S. Cl. CPC H04L 41/22; G06F 3/04883

(57) ABSTRACT

Methods, apparatus, and systems for performing any of generating, adapting, selecting, transferring, and displaying a user interface (UI) in a network are provided. A representative method of generating a user interface on a user interface device for operating a device on a network includes detecting a first predetermined user interaction with the user interface device indicative of a desire to use the user interface device to operate a device on a network, and responsive to detection of the first predetermined user interaction, generating by the user interface device a first user interface, wherein the first user interface is generated at a location relative to the user interface device based on the location of the detected first predetermined user interaction with the user interface device.

### FIELD

The present invention relates to the fields of user interfaces (UIs), wireless communications, user equipment (UE), smart homes, offices, factories, etc. (smart spaces), and more particularly, to methods, apparatuses, systems, mechanisms, and techniques for users to conveniently interface with smart appliances and other devices in a smart space, for provisioning and executing UIs via applications of UEs that may communicate via a wireless communication network, for provisioning UIs for devices without UIs (e.g., devices without UI display capabilities), and for provisioning UIs via alternate display devices based on device power state.

### BACKGROUND

Home, office, and other local area networks (LANs), particularly wireless networks, are becoming increasingly ubiquitous and sophisticated. Such networks may be populated with a multiplicity of electronic devices interconnected through the network. Such networks may include smart phones, computers, printers, smart televisions and other video equipment, smart appliances, smart thermostats, smart security systems, smart stereos and other audio equipment, modems for connecting to the Internet or other networks, digital storage devices, etc. The term “smart space” has been coined for networks (or portions thereof) in which a plurality of electronic devices utilize a shared view of resources and services so that, for instance, the user interface of one device in the smart space may be used to control another device in the smart space. Merely as an example, a smart refrigerator with wireless communication capabilities and an electronic user interface (e.g., a display device such as a touch screen) may be used to control other electronic devices in the smart space. Thus, for instance, the smart refrigerator may have a digital interface, such as a touch screen, on which a user may control functions of the refrigerator (e.g., setting the temperatures in the freezer and refrigerator compartments, controlling the door dispenser to selectively dispense ice cubes, crushed ice, or water, etc.). In addition, however, a user may be able to repurpose the user interface on the smart refrigerator so that the user may control another electronic device in the smart space from the user interface on the smart refrigerator. For example, a person standing at the refrigerator may wish to turn the volume up on the television and may do so by calling up a user interface for the television on the display device of the refrigerator and controlling the television from the refrigerator through the home wireless network.

A user interface (UI) allows a user of a device, such as a user equipment (UE), an electronic device, and/or any object that may include an electronic device, to control, use, and/or operate the device. A UI may provide a user information, for example, by displaying, providing, and/or outputting information to a user, and the UI may also receive a user input, for example, a command, user data, information, and/or any other similar and/or suitable user input. The UI may interact with and/or control a variety of other devices that are connected to and/or in communication with the device executing and/or providing the UI.

For example, the other device may be an input device (such as a mouse, a keyboard, a touchscreen, a microphone, a camera, and/or any other similar and/or suitable input device), an output device (such as a display device, a speaker, a haptic device, and/or any other similar and/or suitable output device), a storage device (which may store and/or record information), a processing device (which may perform computations), a wearable device (which a user may have on her body), and/or any other similar and/or suitable electronic device that may be connected to and/or communicating with a device that includes the UI. As devices and items increasingly include electronic components and wireless communication components, UIs may be included with and/or embedded in a variety of different devices and objects, such as clothing, jewelry, personal accessories, furnishings, home appliances, buildings, vehicles, and a variety of other objects having different capabilities, functions, and components, and such devices and items may be included in and or connected to a smart space, a smart space network, a personal smart space, and/or a communication network.

Existing home control solutions enable a user to monitor and control various home functions via a user device. However, existing solutions do not allow for smart interaction with devices having no user interface. In addition, existing solutions require availability of a user device for the control. This may be problematic when the user device is being used for another purpose or is unavailable.

In general, power saving functionality is commonplace in mobile devices, using various techniques such as transmission power control, display brightness adjustment, inactivity detection, and grouping activities and network access by wake-up cycles to maximize sleep states. These techniques may be implemented on the mobile device only, or may involve both the mobile device and a communication network, such as in the discontinuous transmission and reception features in 3G/4G cellular communication networks.

Generally, these techniques are applied whenever possible to reduce battery consumption. When the device battery is running low, additional power saving methods, typically based on power saving profiles, may be activated manually or at pre-determined levels of battery charge. These power saving methods usually restrict certain functions of the mobile device (e.g., Global Positioning System (GPS) and/or network data use), and may limit display brightness. But since power saving profiles are triggered at pre-determined levels of battery charge, they are generally activated when the battery is already running low. Thus, the user would need to recharge the device as soon as possible to avoid disconnectivity.

### SUMMARY

Methods, apparatuses, and systems to perform any of generating, adapting, selecting, transferring, and displaying a user interface (UI) in a network are provided. A representative method of generating a user interface on a user interface device for operating a device on a network includes detecting a first predetermined user interaction with the user interface device indicative of a desire to use the user interface device to operate a device on a network, and responsive to detection of the first predetermined user interaction, generating by the user interface device a first user interface, wherein the first user interface is generated at a location relative to the user interface device based on the location of the detected first predetermined user interaction with the user interface device.

A representative apparatus for generating a user interface on a user interface device for operating a device on a network includes a receiver, a transmitter, a user interface device for generating user interfaces and receiving user inputs, a processor configured to detect a first predetermined user interaction with the user interface device indicative of a desire to use the user interface device to operate a device on a network, and responsive to detection of the first predetermined user interaction, generate by the user interface device a first user interface, wherein the first user interface is generated at a location relative to the user interface device based on the location of the detected first predetermined user interaction with the user interface device.

A representative method of displaying a UI on at least one UI device includes receiving a first UI transfer request, determining one or more candidate UI devices to display a UI corresponding to the UI transfer request, and transferring the UI to the one or more candidate UI devices.

A representative method of a terminal transferring a user interface (UI) to a UI device includes determining whether an event triggering a UI transfer has occurred, transmitting a UI transfer request if the event has occurred, determining one or more candidate UI devices to display a UI corresponding to the UI transfer request, and transmitting the UI to any of the one or more candidate UI devices.

A representative method of transferring a user interface (UI) to a UI device includes determining whether a UI transfer request has been received, determining whether to accept the UI transfer request, and responsive to a determination to accept the UI transfer request, displaying a UI corresponding to the UI transfer request.

A representative apparatus includes a smart space management server including a memory configured to store instructions, and a processor, by executing the instructions, configured to receive, from a no-User Interface (no-UI) device, user information for display to a user, determine a first User Interface (UI) device in proximity to the no-UI device and having sufficient UI capabilities for displaying the user information to the user, and send a first portion of the user information to the first UI device.

A representative method performed by a smart space management server includes receiving a battery status and information regarding user activity associated with a user device, and responsive to at least the battery status associated with the user device being below a pre-defined level: determining a display device, associated with the user device, capable of providing a user interface for the user activity associated with the user device, and initiating a user interface transfer from the user device to the display device.

A representative apparatus including a smart space management server includes a memory configured to store instructions, and a processor, by executing the instructions, configured to: receive a battery status and information regarding user activity associated with a user device, and responsive to at least the battery status associated with the user device being below a pre-defined level, determine a display device, associated with the user device, capable of providing a user interface for the user activity associated with the user device, and initiate a user interface transfer from the user device to the display device.

A representative method of transferring a user interface (UI) to a UI device includes receiving a device registration notification message including device UI capabilities from a UI device included in a smart space, storing the device UI capabilities in a database, receiving a UI transfer request including application description information, wherein the application description information comprises at least one UI capability criterion corresponding to the UI transfer request, determining one or more candidate UI devices to display a UI corresponding to the UI transfer request based on the stored device capabilities and the application description information, and transferring the UI to the one or more candidate low-capability embedded UI devices.

A representative apparatus includes a smart space management device configured to transfer a user interface from a source smart space device and a destination smart space device including a receiver configured to receive from the originating smart space device a UI transfer request including application description information, wherein the application description information comprises at least one UI capability criterion corresponding to the UI transfer request, a processor configured to determine one or more destination smart space devices as candidates UI devices to display a UI corresponding to the UI transfer request, and a transmitter configured to transmit the UI to the one or more candidate UI devices.

A representative apparatus including a UI device configured to display a UI includes a receiver configured to receive a UI transfer request including application description information, wherein the application description information comprises at least one UI capability criterion corresponding to the UI transfer request, a processor configured to determine whether device capabilities of the UI device correspond to the application description information, and a transmitter configured to transmit a UI transfer acceptance message based on one or more of a user input and the determination that the device capabilities correspond to the application description information.

### BRIEF DESCRIPTION OF THE DRAWINGS

A more detailed understanding may be had from the Detailed Description below, given by way of example in conjunction with drawings appended hereto. Figures in such drawings, like the detailed description, are examples. As such, the Figures and the detailed description are not to be considered limiting, and other equally effective examples are possible and likely.

Furthermore, like reference numerals in the Figures indicate like elements, wherein:

FIG. 1 is a diagram illustrating an example communications system according to embodiments;

FIG. 2 is a system diagram illustrating an example WTRU according to embodiments;

FIG. 3 is a system diagram illustrating a RAN and a core network according to embodiments;

FIG. 4 is a system diagram illustrating a RAN and a core network according to embodiments;

FIG. 5 is a system diagram illustrating a RAN and a core network according to embodiments;

FIG. 6 is an architecture diagram illustrating a smart space architecture including components of a system according to embodiments;

FIG. 7 illustrates a block diagram of a controlling device of FIG. 6 according to embodiments;

FIG. 8 illustrates a physical structure of an exemplary combined touchscreen and audio input/output unit according to embodiments;

FIG. 9 is a diagram illustrating user actions in according to embodiments;

FIG. 10 is a signal flow diagram illustrating operations in a smart space according to embodiments;

FIG. 11 illustrates an input unit of a LCEUID according to embodiments;

FIG. 12 illustrates an output unit of a LCEUID according to embodiments;

FIG. 13 illustrates visual symbols displayed by an output unit according to embodiments;

FIG. 14 illustrates use cases for low-capability embedded UIs according to embodiments;

FIG. 15 is a signal flow diagram illustrating a method of registering a LCEUID to a smart space according to embodiments;

FIG. 16 illustrates exemplary contents of a device registration notification message according to embodiments;

FIG. 17 illustrates mapping between activities and UI capabilities according to embodiments;

FIG. 18 illustrates an activity description for an open message action according to embodiments;

FIG. 19 illustrates XML specifying an activity notification message according to embodiments;

FIG. 20 illustrates application descriptions for different alternative UIs according to embodiments;

FIG. 21 illustrates UI property descriptions for different kinds of view types according to embodiments;

FIG. 22 is a signal flow diagram illustrating determining of alternative UIs for an activity notification according to embodiments;

FIG. 23 illustrates content adaptation from an advanced capability device UI to a low capability device UI according to embodiments;

FIG. 24 illustrates a UI transfer process from a user's primary device to a LCEUID, according to embodiments;

FIG. 25 is a flowchart of a UI transfer according to embodiment;

FIG. 26 illustrates an example smart space environment according to embodiments;

FIG. 27 illustrates example visual representations and multimodal interaction controls that can be generated according to embodiments;

FIG. 28 illustrates examples of proximity control of UI devices according to an embodiment;

FIG. 29 illustrates example objects in which UI devices may be embedded according to embodiments;

FIG. 30 illustrates example reusable low-capability UI devices according to embodiments;

FIG. 31 illustrates an example primary application description associated with a primary application module of a no-UI device according to embodiments;

FIG. 32 illustrates an example application description associated with an application provided by a UI device according to embodiments;

FIG. 33 is an example illustrating UI provisioning via a LCEUID for a no-UI device according to embodiments;

FIG. 34 illustrates an example UI provisioning via an embedded low capability UI device for a no-UI device according to embodiments;

FIG. 35 illustrates further examples of UI provisioning via a low capability UI device for a no-UI device according to embodiments;

FIG. 36 illustrates an example flow diagram according to embodiments;

FIG. 37 illustrates an example process according to embodiments;

FIG. 38 illustrates an example smart space environment according to embodiments;

FIG. 39 illustrates an example flow diagram according to embodiments;

FIG. 40 illustrates an example process according to embodiments; and

FIG. 41 illustrates an example process according to embodiments.

### DETAILED DESCRIPTION

A detailed description of illustrative embodiments may now be described with reference to the figures. However, while the present invention may be described in connection with representative embodiments, it is not limited thereto and it is to be understood that other embodiments may be used or modifications and additions may be made to the described embodiments for performing the same function of the present invention without deviating therefrom.

Although the representative embodiments are generally shown hereafter using wireless network architectures, any number of different network architectures may be used including networks with wired components and/or wireless components, for example

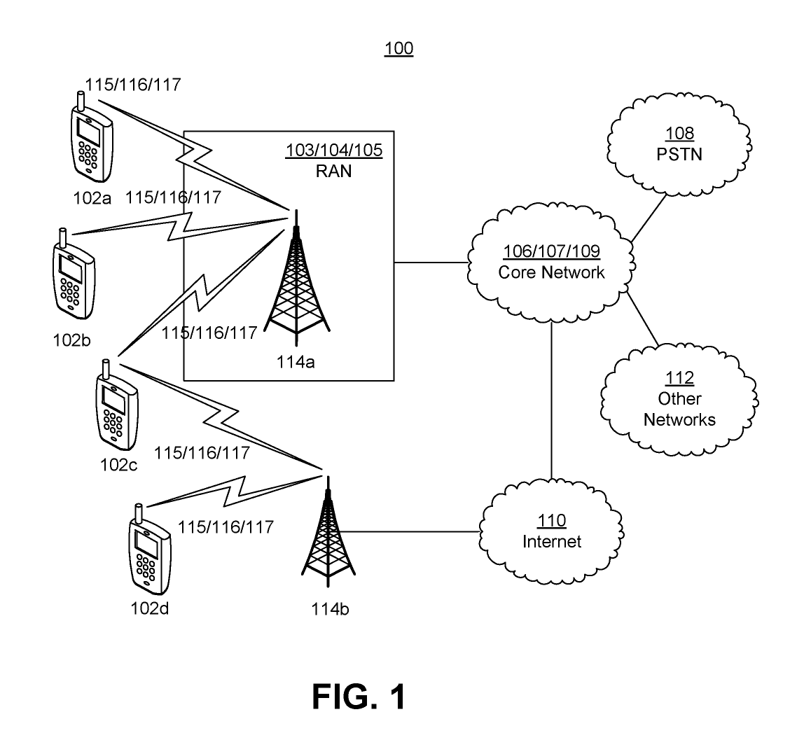

FIG. 1 is a diagram illustrating an example communications system according to embodiments.

Referring to FIG. 1, communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1, the communications system 100 may include electronic devices such as wireless transmit/receive units (WTRUs) 102a, 102b, 102c, 102d, a radio access network (RAN) 104, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, which may be referred to as a “station” and/or a “STA”, may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like. The WTRU 102a, 102b, 102c and 102d is interchangeably referred to as a UE.

The communications systems 100 may also include electronic devices such as a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the other networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. A

Although not shown in FIG. 1, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM, UMTS, CDMA 2000, WiMAX, or WiFi radio technology.

The core network 106/107/109 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1 may be configured to communicate with the base station 114a, which may employ a cellular-based radio technology, and with the base station 114b, which may employ an IEEE 802 radio technology.

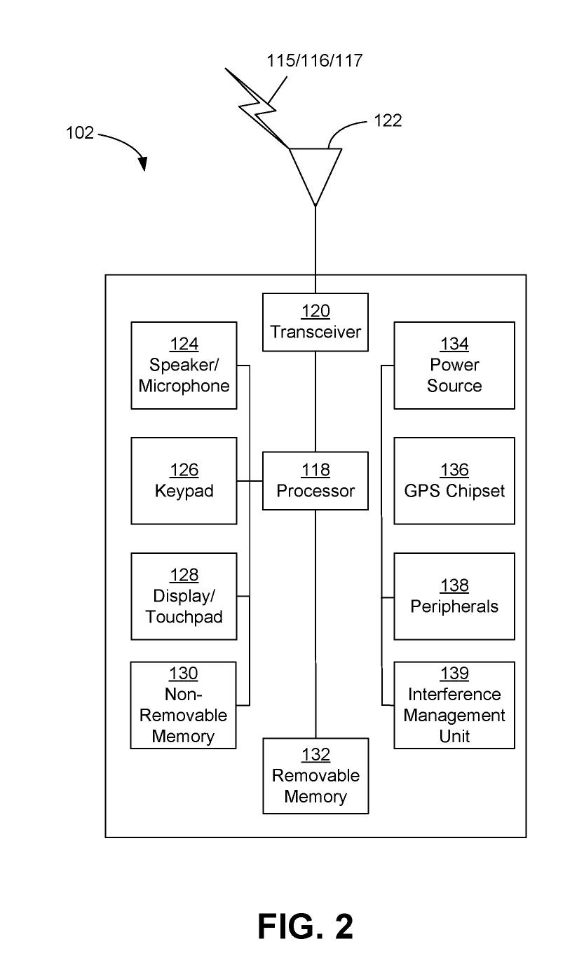

FIG. 2 is a system diagram illustrating an example WTRU according to embodiments.

Referring to FIG. 2, a WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 2 depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 2 as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (g), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, and the like. In a case where the peripherals 138 includes one or more sensors, the sensors may be one or more of a gyroscope, an accelerometer; an orientation sensor, a proximity sensor, a temperature sensor, a time sensor; a geolocation sensor; an altimeter, a light sensor, a touch sensor, a magnetometer, a barometer, a gesture sensor, and/or a humidity sensor.

The WTRU 102 may include a full duplex radio for which transmission and reception of some or all of the signals (e.g., associated with particular subframes for both the UL (e.g., for transmission) and downlink (e.g. for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118).

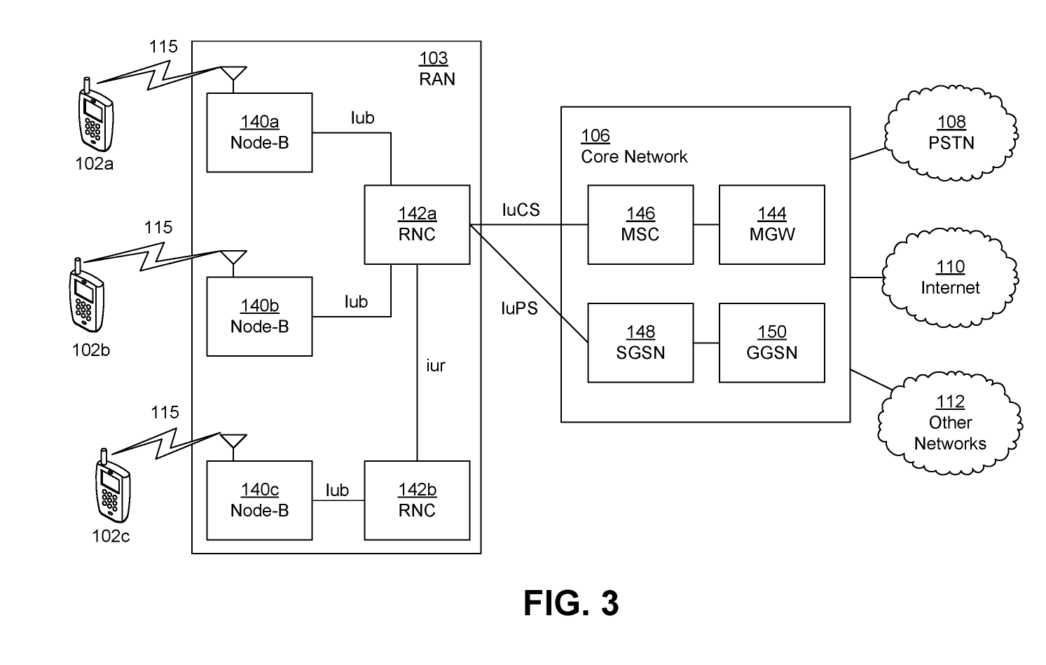

FIG. 3 is a system diagram illustrating a RAN and a core network according to embodiments.

Referring to FIGS. 1 and 3, the RAN 103 may employ a UTRA radio technology to communicate with the WTRUs 102a, 102b, 102c over the air interface 115. The RAN 103 may also be in communication with the core network 106. As shown in FIG. 3, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 3, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 3 may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an f interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the other networks 112, which may include other wired and/or wireless networks that are owned and/or operated by other service providers.

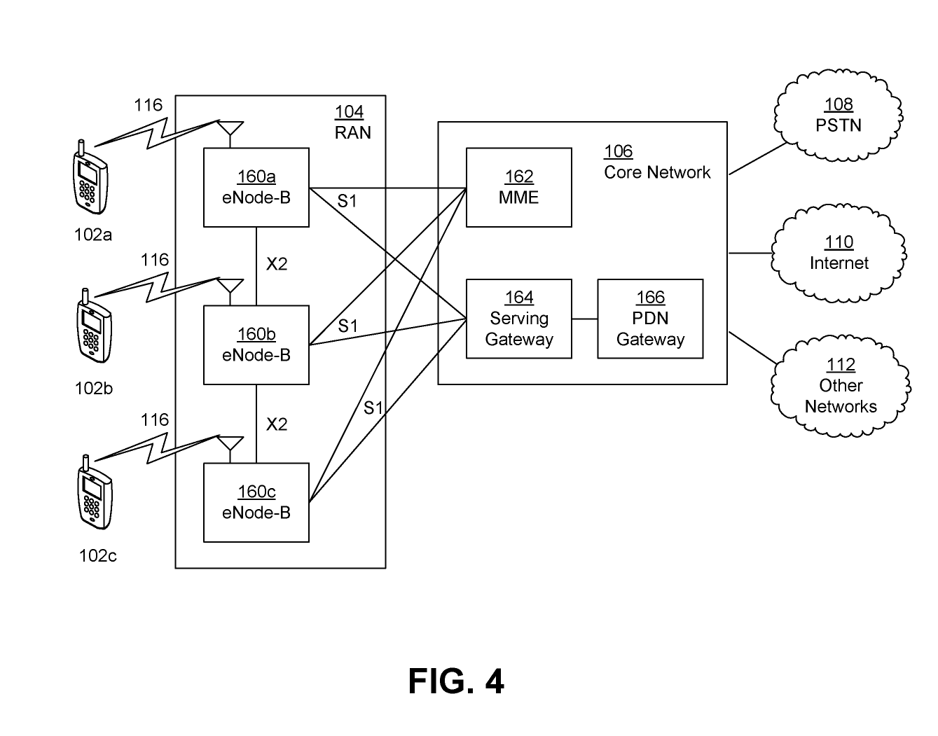

FIG. 4 is a system diagram illustrating a RAN and a core network according to embodiments.

Referring to FIG. 4, as noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 4, the eNode-Bs 160a, 160b, 160c may communicate with one another over an X2 interface.

The core network 107 shown in FIG. 4 may include a mobility management entity (MME) 162, a serving gateway (SGW) 164, and a packet data network (PDN) gateway (or PGW) 166. While each of the foregoing elements are depicted as part of the core network 107, it will be appreciated that any of these elements may be owned and/or operated by an entity other than the core network operator.

The MME 162 may be connected to each of the eNode-Bs 162a, 162b, 162c in the RAN 104 via an Si interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The serving gateway 164 may be connected to each of the eNode Bs 160a, 160b, 160c in the RAN 104 via the Si interface. The serving gateway 164 may generally route and forward user data packets to/from the WTRUs 102a, 102b, 102c. The serving gateway 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The serving gateway 164 may be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the other networks 112, which may include other wired and/or wireless networks that are owned and/or operated by other service providers.

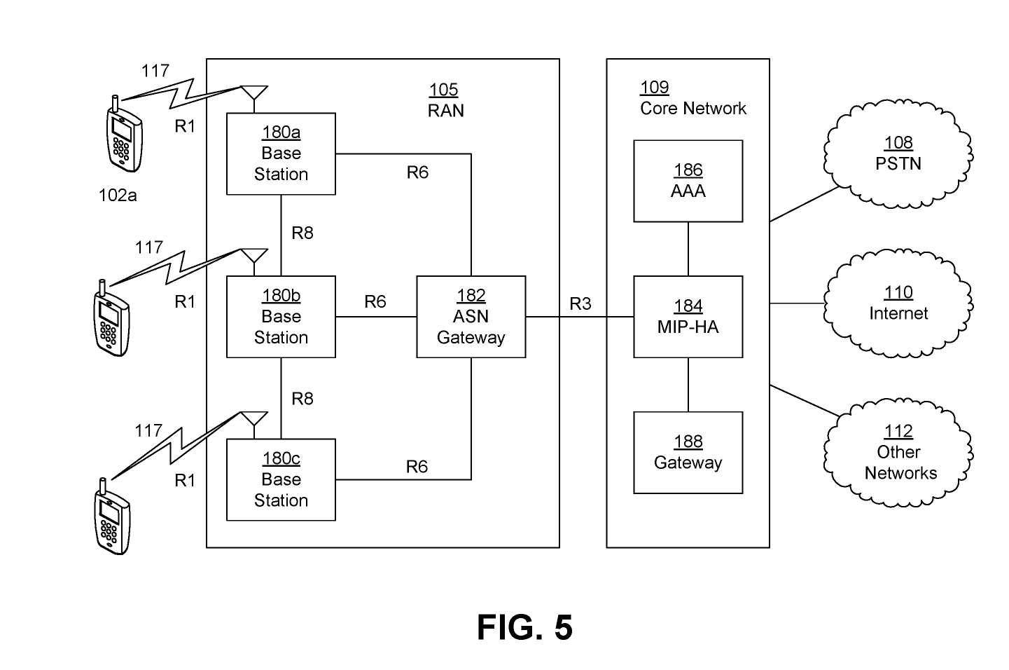

FIG. 5 is a system diagram illustrating a RAN and a core network according to embodiments.

Referring to FIGS. 1 and 5, the RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 5, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. The base station 180a, for example, may use multiple antennas to transmit wireless signals to, and/or receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 100c.

As shown in FIG. 5, the RAN 105 may be connected to the core network 109. The communication link between the RAN 105 and the core network 109 may be defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. The gateway 188 may provide the WTRUs 102a, 102b, 102c with access to the other networks 112, which may include other wired and/or wireless networks that are owned and/or operated by other service providers.

Although not shown in FIG. 5, it will be appreciated that the RAN 105 may be connected to other ASNs, other RANS (e.g., RANs 103 and/or 104) and/or the core network 109 may be connected to other core networks (e.g., core network 106 and/or 107. The communication link between the RAN 105 and the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although the WTRU is described in FIGS. 1-5 as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent 20 MHz channel to form a 40 MHz wide contiguous channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by the particular STA, from among all STAs operating in a BSS, that supports the smallest bandwidth operating mode. In the example of 802.11ah, the primary channel may be 1 MHz wide to accommodate STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available set of frequency bands may be considered busy even though a majority of the frequency bands remains idle and may be available.

In the United States, the available frequency bands that may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

Spectral efficiency of a WLAN that is an 802.11ac system may be improved by performing downlink Multi-User Multi-Input Multi-Output (MU-MIMO) transmission to more than one STA during a same symbol time, for example, during a same downlink OFDM symbol and/or during a guard interval about the same symbol time. Downlink MU-MIMO, as implemented by an 802.11ac system, may use the same symbol time to perform downlink transmissions, or, in other words, simultaneously transmit symbols, to multiple STAs such that interference of a waveform of the downlink transmissions to multiple STAs is not an issue. However, all STAs involved in MU-MIMO transmission with an AP must use a same channel or band, and thus, an operating bandwidth of the MU-MIMO downlink transmissions may be limited to a smallest one of the channel bandwidths that is supported by the STAs which are included in the MU-MIMO transmission with the AP.

A WLAN may be an 802.11ad system, wherein the Media Access Control (MAC) layer and Physical (PHY) layer support VHT STAs in the 60 GHz band. An 802.11ad system may support data rates up to 7 Gbits/s and may support three different modulation modes, including a spread spectrum mode, a single carrier mode, and an OFDM mode. Furthermore, an 802.11ad system may use a 60 GHz unlicensed band, which is available globally. At 60 GHz, a wavelength is 5 mm, and an 802.11ad system may have a compact antenna and/or a compact antenna array. Such an antenna and/or antenna array can transmit and/or receive narrow RF beams, which effectively increases the coverage range and reduces interference in the 802.11ad system. Additionally, a frame structure for an 802.11ad system allows for beamforming training, including discovery and tracking operations associated with beamforming.

A smart space may be referred to as a personal smart space, a smart connected space, a smart space network, a smart space communication network herein below. However, the present disclosure is not limited thereto, and a smart space may be referred to using a variety of other terms describing one or more devices, apparatuses, items, objects, or any other similar and suitable elements, that may perform wired and/or wireless communication while including and/or providing a user interface (UI). For example, a smart space may include one or more electronic devices such as a user equipment (UE), a mobile station, a fixed or mobile subscriber unit, a pager, a cellular telephone, a personal digital assistant (PDA), a smartphone, a laptop, a netbook, a personal computer, a wireless sensor, a display screen, wearable devices, consumer electronics, a home appliance, such as a refrigerator, a television (TV), a dishwasher, a garage opener, a laundry machine, furniture. As a further example, a smart space may include low-capability embedded interaction devices, or, in other words, low-capability embedded UI devices (LCEUIDs), which may have limited processing capabilities, and which may be embedded into any one or more of the electronic devices and/or furniture (e.g. tabletops, sofas, mirrors, carpets, and walls) discussed above.

The smart space may be deployed, provided, provisioned, and/or executed, in and/or by a variety of spaces, including physical spaces and/or non-physical spaces. According to one or more embodiments, a smart space may be and/or include any one or more networks, any one or more parts, and/or any one or more devices included in systems illustrated in FIGS. 1-5.

According to an embodiment, a UI may be transferred from a user's primary device (e.g., a cell phone) to one or more other devices included in a smart space. For example, a smart space, which may be referred to as a home smart space, may include the user's refrigerator, television, home media server, table, chair, mirror, and garage door opener, as the one or more other devices in the user's home smart space management module. The home smart space may be operated by a smart space management module, which may be a server or any other computing device that communicates with the devices in the home smart space via a communication network. In such a case, the smart space management module manages LCEUIDs respectively included in the one or more other devices in the user's home smart space. In such a home smart space, a UI may be transferred from the user's primary device, e.g., a smartphone, a tablet, etc., to the one or more other devices in the home smart space.

In order to receive and/or display the UI being transferred from the user's primary device to the one or more other devices in the home smart, the respective LCEUIDs need to display the UI and may need to allow the user to interact with the UI. For example, in a case where a user has received an email while in the home smart space, an email notification for the user may be generated by the user's cell phone while the user is closing her garage door upon returning home, and while the user's cell phone is disposed in the user's pocket or briefcase. In such a case, the user's cell phone may transmit a UI transfer request to the smart space management module in order to display a UI corresponding to the email notification on an LCEUID in the home smart space, which provides the user more convenient access to the information displayed by the UI. Accordingly, the UI that would be displayed on the user's cell phone may transferred to the LCEUID included in a mirror disposed in a room connecting the garage to the user's home, thus allowing the user to view and interact with the UI more conveniently.

According to an embodiment, a UI transfer request may be based on information displayed on a source UI, wherein the source UI may correspond to a source smart space device. The information is adapted to be displayed on a target UI, which may be referred to as a destination UI, and may correspond to a destination smart space device. The target UI may be a certain type of UI, or may have certain characteristics and/or features needed, desired, selected, and/or determined to be used. According to an embodiment, the target UI may be generated when transferring the source UI from a high-capability device, which may be a high-capability dedicated device, e.g., mobile devices having larger display screens, laptops, smartphones, tablets, wrist held devices, etc., to a low-capability embedded interaction device. The low-capability embedded interaction device may be a device that executes a low-capability embedded UI, e.g., furniture, appliances, household fixtures, tools, etc., that respectively include LCEUIDs.

The related art does not address adaption of a UI for a low-capability embedded UI. Rather, the related art focuses on connecting external high-capability dedicated display devices, e.g. a screen, a monitor, a projector, to a primary device via a wired or wireless connection and sharing display with devices (see Smarttech©, http://smarttech.com). However, in such a case, UI control of a shared display remains with a primary device. The related art addresses transferring user interaction with a UI, i.e., a user input to a UI, between capable and/or dedicated digital devices, e.g., a laptop, a tablet, smartphone, a wearable device, etc., and transferring and sharing of files between them, e.g. the Apple continuity feature, the Pushbullet application, etc. Additionally, the related art also focuses on smart phones and their accessories, e.g., headsets, which may be connected to a high-capability device via a wired or wireless connection by using, e.g. a Bluetooth (BL)-profile, i.e., a headset-profile, while the interaction, e.g., commands such as button presses, gestures, and/or voice commands, from an accessory may be transmitted and/or provided directly to a device's interaction manager. As such, the related art is not focused on adapting a UI for personal smart spaces between a high-capability dedicated device and a low-capability embedded device, which may have limited processing capabilities, which may be embedded into tabletops, furniture, walls, etc.

According to an embodiment, a smart space may include devices forming an ecosystem, such as one or more of the systems illustrated in FIGS. 1-5, in which the devices may operate together via a smart space information system, which may provide interaction channels and may assist a user intelligently. Related art solutions, as described above, may allow a user share a UI between devices having similar or the same properties and capabilities, or share a UI between a first device and a second device that has greater capabilities than the first device, and wherein the second device may not be suitable for including a LCEUID. Moreover, related art solutions are focused on user initiated controlled sharing of UIs, and to direct sharing of sessions and/or connections via a device to device interface. However, the related-art does not describe or provide a solution for sharing, transferring, or adapting UIs in smart spaces that include LCEUIDs or in smart spaces that provide environment integrated interaction.

According to embodiments, methods, apparatus and systems for provisioning and executing embedded UIs in applications of UEs that may communicate via a wireless communication network may be a system-initiated process of adapting a UI for a low-capability embedded device. The system-initiated process of adapting a UI when transferring the UI between a user's primary device UI and a low-capability embedded UI within a personal smart space may be referred to as an adaptive UI transfer process, which may be based on four kinds of modules discussed below, wherein any of the four kinds of modules may be any of the devices, items, apparatuses and/or devices illustrated in FIGS. 1-5.

In addition to devices (e.g., smart appliances and the like) that have interfaces that can be used to control, not only the smart appliance on which the interface is disposed, but also other smart appliances in a smart space network, there may also be devices the sole or primary purpose of which is to provide a user interface for other devices in the smart space. An example of such a device is a remote control. In addition, users may use any of their typical telecommunication devices, such as their computers and smart phones, as a remote control in a smart space. Even further, user interface devices, such as touchscreens, can be incorporated into the surfaces of household items that are otherwise dumb. For instance, a touchscreen could be embedded in the armrest of a couch, the surface of a coffee table, or a wall.

Note that the terms asset and smart space device may be used herein and are intended to refer to not only those devices that are traditionally thought of as smart space devices, such as smart appliances and smart televisions that can be controlled form other nodes of the network, but also to include other devices, such as smart phones, remote controls, and other devices whose primary function in the smart space may be to control other devices. This is particularly logical since many such devices do serve both roles in any event. For instance, smart phone, computers and the like are commonly used to store data and provide services, such as music, photo, and video playback, i.e., serve as controlled devices in the smart space, as well as being used to control other smart devices in a smart space.

In the following discussion, the devices or assets that are being used to control another device might sometimes be referred to as a user device/asset or control or controlling device/asset, while the devices that are being controlled may be referred to as the controlled or controllable device/asset or smart space device/asset, for convenience. However, this is not intended to imply that there is necessarily any difference between such devices other than their immediate role in the context of the discussion at that point. The controlling device and the controlled device could be two identical devices. For example, one smart phone could be used to access photos or music on another smart phone in a smart space.

In a broad sense, the principles of this disclosure pertain to methods, apparatus, and systems for allowing a first telecommunication device to operate or control a second telecommunication device in a network.

Additionally, in the course of this disclosure it will be useful to distinguish between the logical concept of a user interface or UI (e.g., a display of volume control up and down buttons for a smart radio) and the physical device through which a user interface is presented (such as a touchscreen, touchpad, or microphone). Therefore, in this disclosure, the term user interface or UI typically will be used to refer to the logical concept of the user interface and the term user interface device or UID will be used to refer to the physical structure through which a UI is presented.

Commonly, in a smart space or any other network, the smart space devices or nodes of the network each have a receiver and a transmitter configured to communicate over the network. The network may be a wireless network. The devices on the network may not (and often do not) communicate with each other directly. Rather, there may be a management node, such as a smart space gateway that manages the communications between two smart space devices that wish to communicate with each other. For instance, in the example above in which the user interface on a smart refrigerator is used to control a radio, the refrigerator may communicate directly with the gateway, such as by sending a message to the gateway indicating that it wishes to control the volume of the radio. The gateway may then send a message back to the refrigerator forwarding to it data defining a user interface that can be displayed on the refrigerator's touchscreen to control the radio. When the user interacts with that user interface to, for example, increase the volume of the radio, the user's actions are transmitted back to the gateway, which translates it into a signal that the radio will understand as an instruction to increase the volume and will send that instruction over the network to the radio.

Typically, the UID of a smart space device is a dedicated device located in a particular portion of the smart space device and having a particular size. Typically the size of the display will be adequate to allow a person to ergonomically operate the smart space device through that interface device. However, other smart space devices that a person may wish to operate using the user interface device on that smart space device may have much more complicated controls, such that a larger interface is desirable and it is not particularly ergonomic or convenient to use the UID on that particular smart space device to display or otherwise present the a interface for another device.

In accordance with some of the principles discussed herein, a user is provided an easy and convenient way to call up a customized user interface for a particular smart space device at a UID, interact with that user interface, and then switch to the user interface for another smart space device or close the user interface.

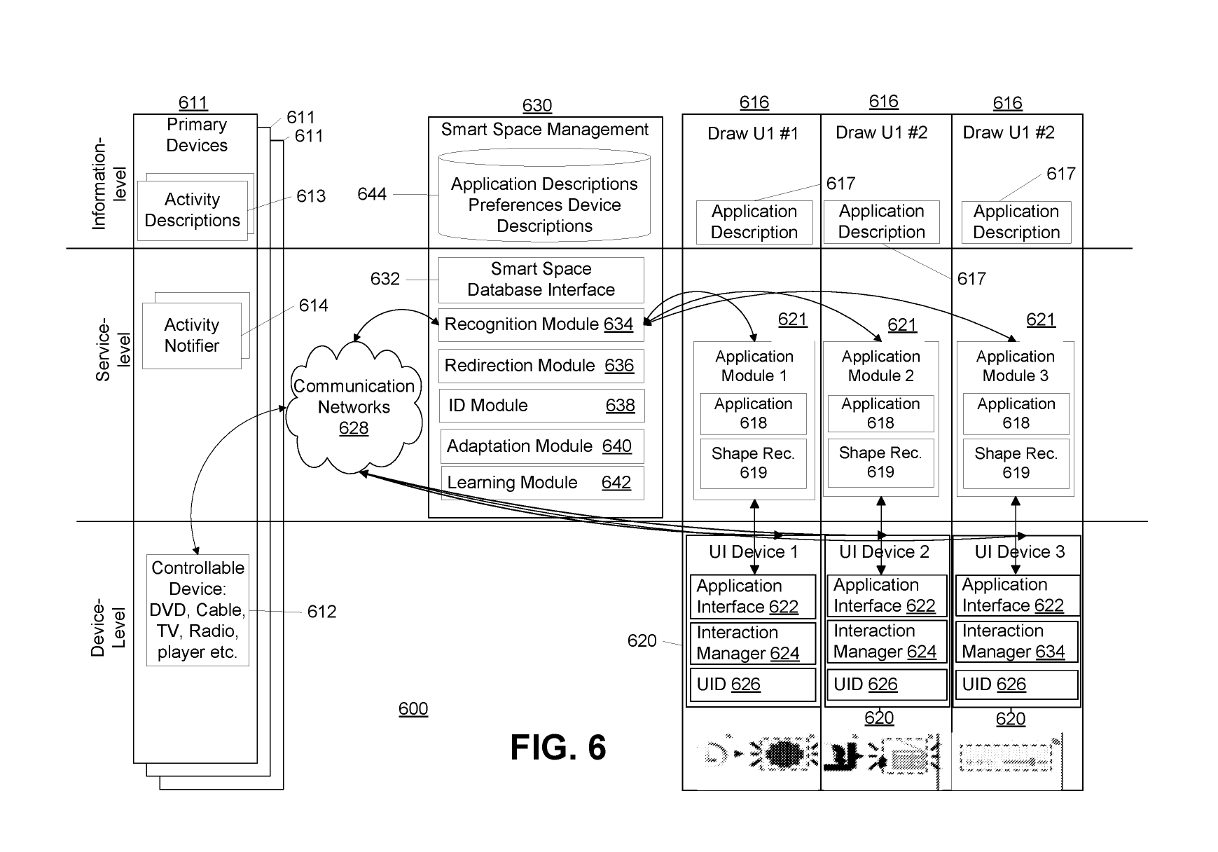

FIG. 6 is an architecture diagram illustrating a smart space architecture including components of a system according to embodiments.

Referring to FIG. 6, a smart space 600 may be and/or include a database (e.g., a semantic database) that contains information about the users of the smart space, their preferences, and applications and devices in the smart space 600. The smart space 600 may include application descriptions 617 that specify UI capabilities provided by the application modules (e.g. information representations and control of representations). According to embodiments, entities in the smart space 600 may be modules that produce information, consume information, and/or monitor how information changes in the smart space 600. The entities in the smart space 600 may be considered to include four different types of smart space entity types. These four entity types are logical entity types and it should be understood that a physical entity in a smart space (e.g., the smart space 600) may have the capability of being more than one type of logical entity (e.g., smart space entity) based on its role (e.g., its particular role) in an interaction (e.g. a particular interaction) in the smart space.

A first entity type is a primary device (e.g., a primary device 611), which may be referred to as a controllable device (e.g., a controllable device 612). At the physical device level, controllable devices 612 may be devices that are or may be controlled to perform a function in the physical world. For example, a controllable device may include such devices as smart appliances, televisions, radios, thermostats, and any other similar and/or suitable device. According to embodiments, at the information level, controllable devices may include one or more activity descriptions 613. The activity descriptions 613 may be information related to operations, activities, functions, capabilities, actions, and other similar things that the device is capable of doing. For example, a radio may be capable of tuning to a radio station, playing a CD, adjusting volume, adjusting bass, treble and midrange, being turned on and off, etc.

The below described features, operations, and apparatuses provide an easy, efficient, user-friendly, and ergonomic way to interact with smart space devices in a smart space. The use of the terms smart space and smart space devices herein is merely exemplary and it will be understood by those of skill in the related arts that the principles disclosed herein are applicable to any series of networked devices wherein one device can be controlled from the UID of another device through the network. Furthermore, in the embodiments discussed herein, the UID may be a touch screen. Again, a touch screen is merely exemplary and other user interface devices can be used in accordance with the principles disclosed herein.

According to embodiments, at a service level, controllable devices 612 may include an activity notifier service 614, which may deliver activity notifications between a controllable device's 612 internal device/application/service actions (e.g., replay last 30 seconds) and the smart space 600. An activity notification may specify a name for an activity (e.g., initialize cable set top box UI), the UI capabilities that are required and/or needed from the smart space (e.g., render a UI) to handle the processing of the activity, and UI parameters (and content, if necessary and/or needed) to be used in the deployment of the smart space device on which a user interface will be rendered.

A second type of entity is a controlling entity 616. At a device level, entities of the second type (e.g., controlling entities) may include the devices 620 that have UI display devices (UIDDs) 626 that can be used to interface with a user to allow the user to control other devices in the smart space. Entities of the second type, such as the devices 620 including the UIDDs 626, may be referred to as Low-Capability Embedded UI Devices (LCEUIDs). The UIDDs 626 may include and/or may be the physical input and output unit, e.g., a touchscreen or a microphone and speaker combination. Controlling entities 616 may include such devices as remote controls, smartphones, computers, and dedicated control UID devices, such as LCEUIDs including small flat display devices embedded in or on physical objects, such as walls, and chair armrests. According to certain embodiments, the controlling entities 616 may be devices on which UIs for controlling a controllable device 612 are rendered and operated by a user. According to certain embodiments, controlling devices may be any smart space device that has a capability to have their UIDDs 626 used to control other smart space devices within a smart space. For example, a single smart appliance may be both a controlled device type 11 as well as a controlling device type 16.

According to embodiments, at the information level, controlling entities 616 may include an application description 617 including information that describes the device's capabilities in terms of its ability to be used to control other devices. Such information may include, for instance, pixel resolution, screen size, screen properties (such as whether a display device includes a touchscreen or not), keyboard properties, color and/or black and white display capabilities, speaker properties (such as bandwidth), microphone properties, or any other similar and/or suitable information on a device's capabilities.

According to embodiments, at the service level, a controlling entity 616 may contain an application component 621 including an application module 618 that provides UI capabilities for creating a UI, information representations, and control representations. According to certain embodiments, the application component 621 also may include a shape recognition module 619 for detecting the shapes that a user draws (or other input actions, such as a non-touch input gesture, a sound/voice input gesture, that a user inputs) using the UIDD 626 of the controlling device 620. For example, according to certain embodiments, the controlling device 620 relays (e.g., only relays) the shape (e.g., as raw point data, Bezier curve, vector list, etc.) as an input event to the application module 621 for recognition by the shape recognition module 619. In such a case, the shape recognition module 619 may include and/or have access to a memory for storing a table correlating particular user interactions (e.g., drawn shapes) to particular commands (e.g., open a user interface, call up the user interface for a particular networked device, close the user interface). Such a memory may be provisioned with the table via the network from a network/smart space management entity, such as management node 630 discussed below, and/or from any suitable and/or similar device, location, and/or entity.

According to certain embodiments, at the device level, the controlling device 20 also may include an application interface 622 that enables the application module 621 to use the controlling device 620 to render a representation of an application's information and controllers. A controlling device 620 may also include an interaction management module 624 that may implement the application interface 622 and controls the UIDD's input/output units (touchscreen or speaker/microphone pair) 626.

The aforementioned components and modules 618, 619, 621, 622, 624, and 626 may include software, hardware, processors, state machines, application specific integrated circuits, digital circuits, logic circuits, analog circuits, digital memories, and/or any combinations of the aforementioned.

According to embodiments, a third kind of entity is a node that manages the smart space 600, such as smart space management node 630, which may also be referred to as a module, an entity, a server, a device, etc. The smart space management node 630 may be also referred to as a smart space gateway and may contain a number of service level components. The service level components may include, for instance, a database (e.g., a semantic database, a smart space database, etc.) interface 632. The database interface 632 may enable other smart space entities to publish information to the smart space 600 and to monitor changes in information in the smart space. The primary information types related to the information in the smart space are (1) application descriptions, (2) user preferences, and (3) device descriptions. According to certain embodiments, an identification (ID) module 638 may maintain the identifications of the users in the smart space 600. According to certain embodiments, a recognition module 634 may recognize (e.g., determine, sense, calculate, etc.) user situations in the smart space 600, e.g., may recognize the location of the user in the smart space 600 or the location of smart space entities in the smart space 600. According to certain embodiments, a redirection module 636 may direct (e.g., may provision, transfer, generate, etc.) UIs to controlling devices for rendering on their UIDs.

According to certain embodiments, the smart space management node 630 may include an adaptation module 640 to adapt and/or reconfigure UIs as needed for a particular UID on which the UI will be displayed. For example, there may be a case where the standard UI for a particular smart space device may not render well on the UID of another smart space device. In such case, it may be desirable to reconfigure that UI to make it more ergonomic for display on the other smart space device's UID.

Further, according to certain embodiments, the smart space management node 630 may include a learning module 642 to learn user preferences over time. The user preferences may be learned from the user's UI usage patterns over time, may be determined based on information related to the user's UI usage patterns, may be received from another smart space device, and/or via any other similar and/or suitable method. For example, according to certain embodiments, the learning module 642 may learn that a particular user tends to use a particular portion of a particular wall UID to control a particular smart space device and may use that information to call up that particular UI first when interaction with that wall UID is initiated.

According to embodiments any of the first, second, and third type of entities may be connected through a communication network 628, which may be the fourth type of entity in a smart space. According to certain embodiments, the communication network 628 may enable communications between other smart space entities in a smart space as well as external communications with other networks.

According to embodiments, a user may define a portion of a UID of a controlling smart space device for rendering a UI of another (e.g., controlled) smart space device by performing a particular user interaction in connection with that UID. For example, there may be a case where the interaction may be drawing (e.g., with one's finger) a particular shape on a touchscreen. In such a case, the shape may be a closed geometric shape, such as a circle, rectangle, or triangle. In response to recognizing the drawings of the closed shape on the touchscreen, the logic may render a UI on the touchscreen in the portion on which the closed space was drawn. According to certain embodiments, the area within the closed geometric shape that was drawn may be the area defining the UI. According to certain embodiments, the shape of the UI may be predefined, e.g., a rectangle, regardless of the shape drawn by the user. Furthermore, the size and position of the UI may be a function of the size and position on the UID of the closed shape drawn by the user. In other embodiments, the shape, size, and position of the UI may be rendered as a function of the shape, size, and position of the closed geometric shape drawn by the user, for instance, it will be the exact shape, size, and position of the closed geometric shape drawn by the user.

According to certain embodiments that may be implemented separately from the embodiment described above or combined with it, the particular shape drawn by the user may dictate the particular UI that is to be rendered. For example, in a case where the user draws a shape, such as the letter R, the system may render the UI for the radio in the position where the R was drawn and, optionally, sized as a function of the size of the letter R that was drawn. On the other hand, in a case where the user draws a T, the system may render the UI for the thermostat, instead of the UI for the radio. However, the present disclosure is not limited to the above shapes, and the shapes that may correspond to the calling up of a UI for a particular device may be any shape, including letters, numbers, and other characters in any language.

According to embodiments, gestures (e.g., gestures other than for drawing the shapes discussed above) or shapes drawn by the user may have different functions in the UI and may be dependent on the UI that is being displayed when the gesture is made. For example, in a case where the UID is rendering the UI for a particular smart space device, sweeping one's finger right to left within the rendered UI may cause the UI to scroll to a different UI of another smart space device in the smart space. In such a case, a user may scroll through the UIs of different smart space devices in an ordered fashion, and sweeping from left to right may have the same effect except scrolling through the UI options in the opposite direction. According to certain embodiments, drawing another shape, such as an X in a rendered UI may be interpreted as an instruction to close the user interface on the UID.

According to embodiments, in a case where the desired UI is rendered, the user may interface with that particular UI to control whatever device it is that the particular UI controls. According to certain embodiments, in a case where a particular UI for a particular device is displayed, other particular gestures that may not have anything to do directly with what is displayed in that UI may be used to perform certain functions relative to that device. For example, in a case where the UI for the radio is displayed, swiping upwardly (for example, regardless of what is displayed in the UI) may be interpreted as an instruction to increase the volume, whereas swiping downwardly may be interpreted as an instruction to decrease the volume.

According to embodiments, the UI initially generated in response to the initiation gesture (e.g., the drawing of a closed geometric shape), may be a list of the devices that may be controlled through the UID and/or a grid showing icons representing the devices that may be controlled through the UID. In such a case, the user may select any of elements and/or items displayed on the UI by touching the corresponding icon or item in the list. According to embodiments, particular gestures and their functions may be programmable by the user and/or predefined by the system.

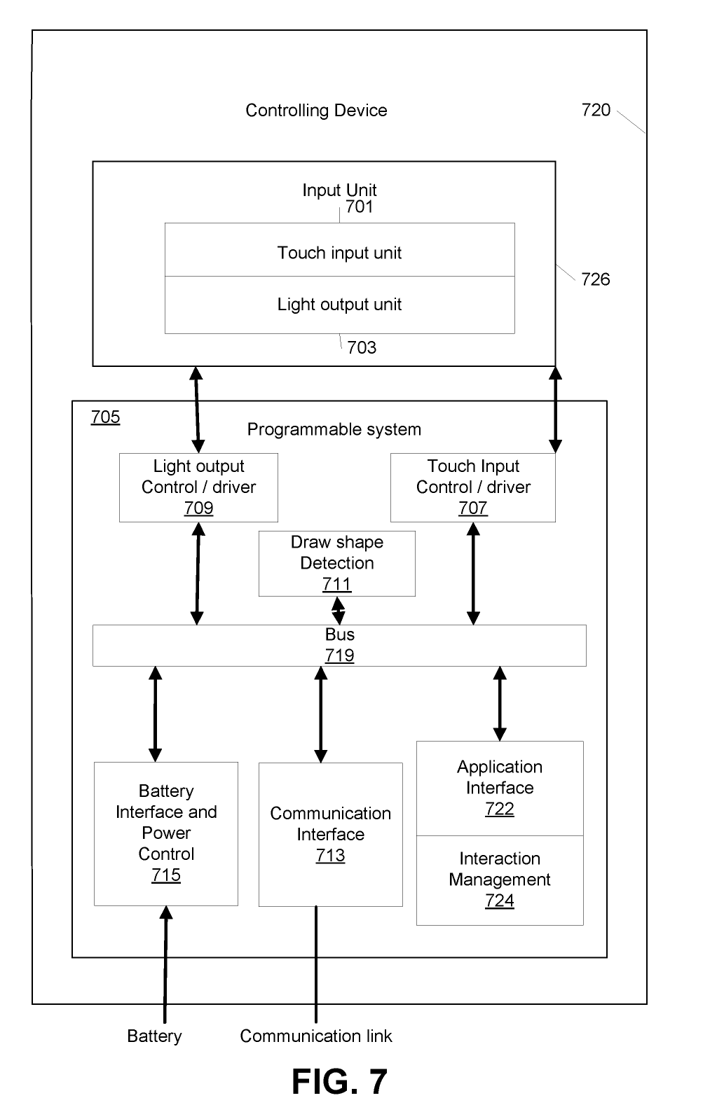

FIG. 7 illustrates a block diagram of a controlling device of FIG. 6 according to embodiments.

Referring to FIG. 7, any controlling device (e.g., any of the controlling devices 620) may be an embeddable display device, including, for example, a set of connected devices (e.g., a planar device, and/or a device including a touch sensing layer, a LED layer for visuals, an acoustic layer for audio feedback, etc.) having any of the following properties: low power consumption, low display resolution, a limited amount of display colors available, restricted processing and memory capabilities, limited and simple input/output capabilities (such as immediate visual feedback, touch sensitivity, visual output, audible input/output). A mechanical structure of an embeddable display device may be any of flexible, bendable, formable, etc., so that it may be mounted to structures that may have curve or irregular surfaces. According to certain embodiments, an embeddable display device may be embedded in physical structures, such as walls, chair armrests, and tabletops and be very thin so as to be unobtrusive both visually and physically when not in use. Controlling devices 720 (which may be referred to as a UI device 720 or a LCEUID 720) may be controlled themselves by application modules that communicate with it via the smart space network.

According to embodiments (e.g., as discussed above) a controlling device 720 may include a UI unit 726. The UI unit 726 may be a structure with which a user physically interacts in order to input information into the controlling device 720 and/or receive information from the controlling device 720. For example, there may be a case where the UI unit 726 is a touchscreen and/or a speaker (output) and microphone (input) combination. In the case where the UI unit 726 is a touchscreen, it may include a touch input unit 701 and/or a display output unit 703.

According to embodiments, the controlling device 720 may further include a programmable system 705. The programmable system 705 may include controllers/drivers 707 and 709 for the input and output units 701 and 703, respectively. It also may include a drawing detection module 711, which analyzes the user's touch interactions with the touchscreen and determines whether a user interaction with the touchscreen was a draw shape event (as opposed to a random touching of the touchscreen). According to certain embodiments, some touchscreens and/or other UIDs may be prone to accidental user interactions that are not intended to be shape inputs. For example, in a case where a touchscreen is embedded in an armrest of a chair, it might often be touched by a user without intent to actually enter an input into the device. The controlling device 720 also may include a communication interface 713 for communicating with other smart space devices via the network, and also may include a power supply 715 such as a battery interface and power control. The controlling device 720 also may include an interaction management module 724, which interfaces with any of the application interface 722 and the application module 618 of the controlling device 620 (see FIG. 6). The interaction management module 724 controls the interface unit 726 while the application module 618 interacts with the interaction management module 724. According to embodiments any of the modules/components in the programmable system may be coupled to a common bus 719 for communicating with each other. According to certain embodiments, the interface unit 726 may include both a touchscreen input/output unit and either or both of an audio input unit and an audio output unit. However, the present disclosure is not limited thereto, and the interface unit 726 may be any suitable and/or similar type of interface.

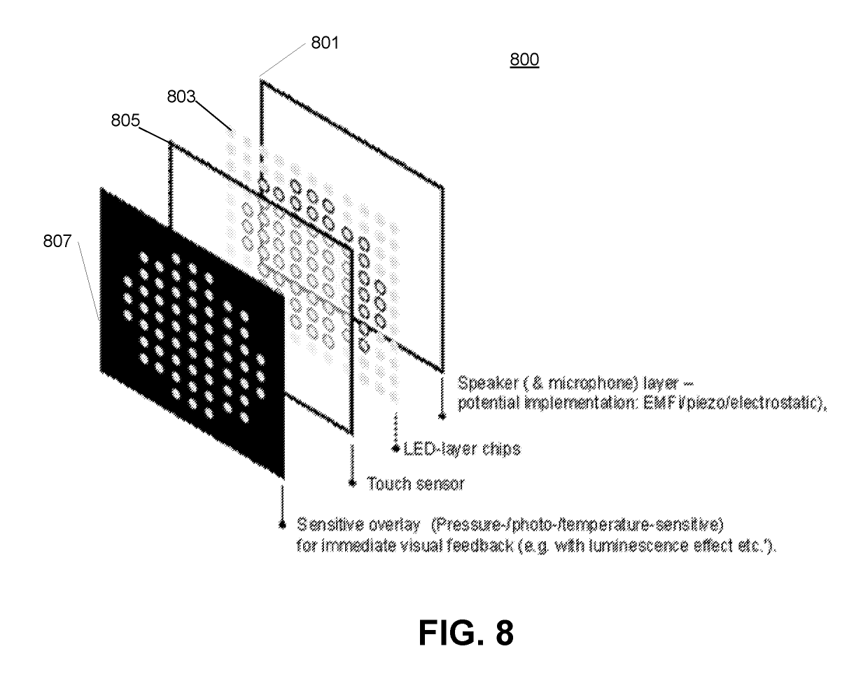

FIG. 8 illustrates a physical structure of an exemplary combined touchscreen and audio input/output unit according to embodiments.

Referring to FIG. 8, the illustrated physical structure may include a combination of a touchscreen and audio input/output unit 300, which may be used as the interface unit 624 in FIGS. 6 and 7. According to embodiments, the layered structure may include four layers, namely, a touch sensor layer 805, an LED layer 803 for generating a display, a speaker and microphone layer 801, and a sensitive overlay layer 807 that protects the other layers.

According to certain embodiments, the sensitive overlay layer 807 may be temperature sensitive to provide, for example, a luminescence affect when touched with a finger (or other device) in order to provide an immediate visual feedback to the user upon the user executing an input gesture (e.g., a drawing). According to certain embodiments, the sensitive overlay layer 807 may be pressure sensitive and/or photosensitive for providing feedback to the user. The sensitive overlay layer 807 may be coated with a suitable paint or dye. According to certain embodiments, the touch sensor layer 805 may be implemented as a grid or cell structure of resistive or capacitive devices, as is known in the art. According to certain embodiments, the visual output layer 803 may include a series of interconnected LED chips, for instance, using a bonding glue, with a plastic film thereupon.

According to certain embodiments, the audio layer 801 may be constructed using any thin form-factor loudspeaker and microphone. The audio layer 801 may be, for example, formed by a piezo-electric material that transforms electric tone signal into mechanical vibrations such that the whole layer acts as a speaker diaphragm. According to certain embodiments, systems that use attraction and repulsion of two foils by electrostatic forces are another technology that may be used to form a thin form-factor loudspeaker. Since the audio layer 801 may need to vibrate in order to function as a speaker and/or microphone, the mechanical assembly of the audio layer 801 should be mounted at its edges so that the speaker's active area is freestanding and may vibrate freely in order to produce reasonable quality sound reproduction. According to certain embodiments, electromechanical film (EMFi), which converts mechanical energy into an electrical signal and vice versa, may be used to form layer 801.

According to embodiments, there may be a case where a home smart space includes a radio as a controlled device and an embedded controlling device that is embedded in the armrest of a chair. The controlling device may be configured to wake up when a user sits in the chair. For example, the controlling device may be configured to wake up based upon a user input, a command signal received from another smart space device, sensor information, and/or any other similar and/or suitable method and/or information for waking up and/or powering on a device. For example, the chair may have a pressure sensor in the seat of the chair or the touch sensitive surface of the controlling device may detect the arm of the person on the device. Upon waking up, the controlling device may show a login display on the UI, which the user may use to input a PIN code, tick mark, and/or other predefined gesture. For instance, upon wake up, the controlling device may render a keypad on which the user can enter a PIN code.

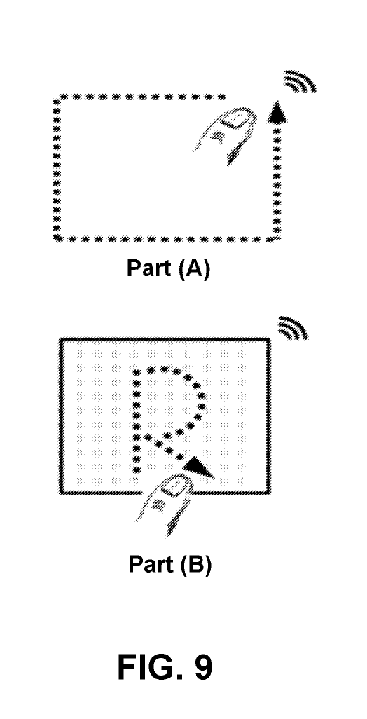

FIG. 9 is a diagram illustrating user actions in according to embodiments.

According to embodiments, in a case where the user desires to interact with a smart space device, such as a radio, the user may draw a rectangle on the UID of the controlling device's UID, as illustrated in part (A) of FIG. 9. In such a case, in response to the user drawing the rectangle, the controlling device displays a UI on the UID within the rectangular space defined by the user's drawing. However, the present disclosure is not limited thereto, and the UI rendered based on the user's drawing may take and/or be generated according to any suitable and/or similar shape, form, template, etc. According to certain embodiments, the controlling device may display a UI that is a list of controlled devices that the user may select from. According to other embodiments, the UI may be a grid of icons, each icon representing one of the controllable devices that the user can control. According to certain embodiments, the UI may be the UI of one particular smart space device, such as the last device that was controlled in the smart space, or the UI of a default smart space device (e.g., the device that has been determined to be the device that is most commonly controlled remotely in the smart space), etc.

According to certain embodiments, a user may interact with the UI displayed on the UID to select a smart space device to operate. As previously mentioned this interaction may be a touch input (and/or any other similar and/or suitable input gesture) related to an icon or list item that corresponds to the device with which the user wishes to interface. According to certain embodiments, the touch input may be a finger swipe to the left or right to scroll in one or the other direction through UIs for specific smart space devices. According to other embodiments, the user may draw another shape, such as a letter, each such letter or shape corresponding to a particular controllable device in the smart space. For example, the case of a user drawing an R, such as illustrated in part (B) of FIG. 9, may correspond to selecting the radio, whereas drawing a T may correspond to selecting the thermostat.

According to certain embodiments, in a case where the user selects a device to interact with, the interaction manager 624 renders the UI corresponding to that smart space device. In such a case, the user may interact with the selected smart space devices through that UI. According to certain embodiments, in a case where the user is finished interacting with the device and wishes to close the UI, the user may draw another shape or gesture on the UID that corresponds to an instruction to close the UI. For example, the shape may be an X or a circle.

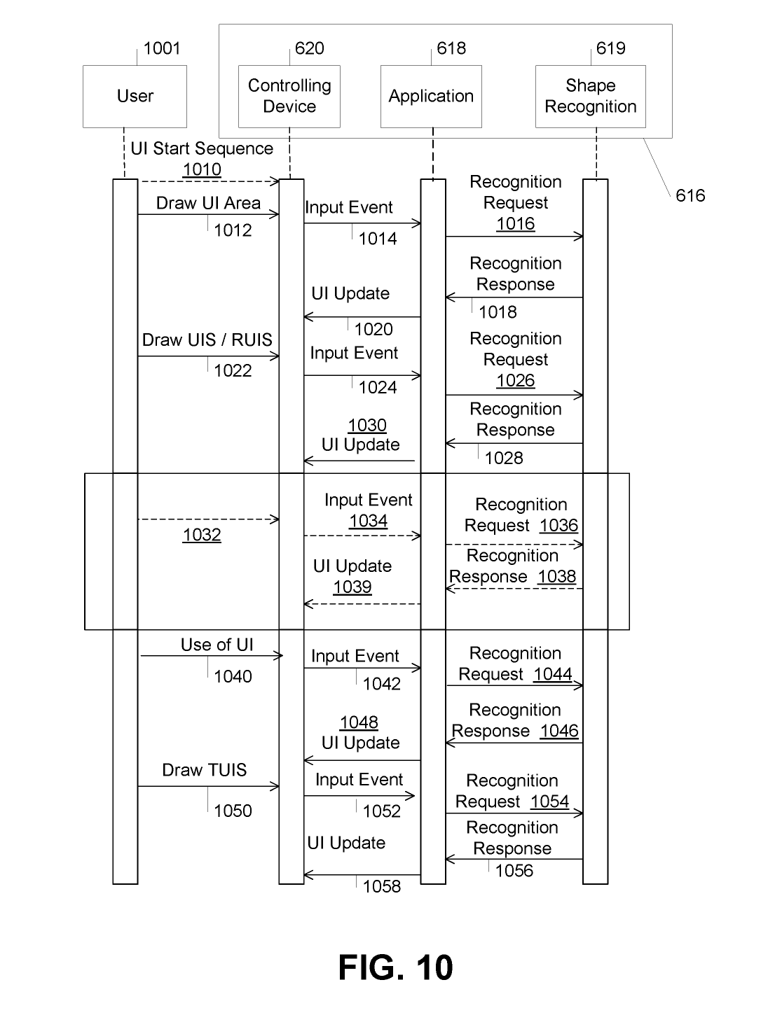

FIG. 10 is a signal flow diagram illustrating operations in a smart space according to embodiments.

According to embodiments, in a case where a user 1001 commences a process of a smart space, e.g., initiates operations of and/or interactions with the smart space 600, a user may perform an act at operation 1010 in association with a controlling device, e.g., the controlling device 616. As previously noted, the act may be touching the controlling device and/or inputting a PIN code. However, the present disclosure is not limited thereto, and the user may perform any act to commence a process of the smart space, such as, for example, a gesture, a motion, a sound transmission, etc.

According to embodiments, a user 1001 may interact with the controlling device 616, such as by drawing a rectangle at operation 1012 to indicate (e.g., command) that the controlling device 16 should render a UI. The controlling device 616 may generate and send an input event at operation 1014 to the application interface module 620. According to embodiments, the application interface module 620 may send a recognition request at operation 1016 to the shape recognition module 619. According to certain embodiments, the shape recognition module 619 may consult a database (e.g., may read, call, reference, etc., information stored in a memory) to determine a process (e.g., an instruction, a command, an operation, a request, etc.) to which the shape (e.g., the rectangle of operation 1012) corresponds. At operation 1018, the shape recognition module 619 may send a recognition response to the application interface module 620. According to certain embodiments, the recognition response may include information identifying the process to which the shape corresponds, such as, for example, information associated with generating a UI from which the user may select a smart space device with which to interact. At operation 1020, the application interface module 620 may send a UI update to the controlling device 620, the UI update may include information indicating a UI to be rendered.

At operation 1022, the user 1001 may interact with the UID of the controlling device 620 to select a smart space device. According to certain embodiments, the act may be swiping across the UI from left to right, or any other similar and/or suitable input gesture and/or input action. According to certain embodiments, the act may correspond to, and/or be an instruction or command for, any of (1) selecting a smart space device; (2) rendering a UI for a smart space device on the UID of the controlling device 620; (3) rendering a UI for a next smart space device in an ordered list of smart space devices; (4) scroll to the next smart space device in the ordered list; (5) a shape of an area in which a UI is to be displayed; (6) and/or any other similar and/or suitable action and/or operation related to selecting a smart space.

According to embodiments, the controlling unit 620, at operation 1024, may send another input event, e.g., a selection input event, to the application interface module 620. According to certain embodiments, the selection input event may include information related to the act to select the smart space device, such as, for example, information defining a shape that was drawn to define an area. At operation 1026, the application interface module 620 may send another recognition request, e.g., a selection recognition request, to the shape recognition module 619. According to certain embodiments, the shape recognition module 619 may determine the command that corresponds to that shape. At operation 1028, the shape recognition module 619 may send a recognition response, e.g., a shape recognition response, including information associated with the determined command. The application interface module 620 may send a UI update message to the controlling device 616 at operation 1030. The UI update message may include information associated with the selection input event (e.g., information causing the controlling device 620 to render a display in response to the command, namely, the user interface for the next device in the ordered list of smart space devices).

Referring to FIG. 10, operations 1032 through 1039 illustrate certain embodiments in which the device selection instruction may be a user generated shape (e.g., the user draws a particular shape) that constitutes an instruction (e.g., a direct instruction) to render the UI for a particular device. At operation 1032, for example, in a case where the user draws an R shape to call up the UI for the radio, the user interfaces with the controlling device 616 by drawing the letter. At operation 1034, in such a case, the controlling device 616 may send an input event to the application module 618. The application module 618, at operation 1036, may send a recognition request to the shape recognition module 619. At operation 1038, the shape recognition module 619 may send a recognition response for informing the application module 618 of the command corresponding to the recognized shape. The application module 618 may send a UI update to the controlling device 616 at operation 1039, and the UI update, may, for example, cause the controlling device to render the UI for the radio.

At operation 1040, a user may interacts with the UID of the controlling device 616 to operate the radio (e.g., to increase the volume by pressing a volume up button portion of the radio UI). According to embodiments, at operation 1042, the controlling device 616 may generate a corresponding input event and sends it to the application module 618. The application module 618 may send a recognition request to the shape recognition module 619 at operation 1044. At operation 1046, the shape recognition model 619 may recognize the shape, and may determine a corresponding command. At operation 1046, the shape recognition module 619 may send a recognition response to the application module 618 indicating that the command is a volume up command. The application module 618 may send a UI update message to the controlling device 616 at operation 1048. According to certain embodiments, the UI update message may cause the controlling device 616 to render an appropriate UI update, such as, for example, increasing the length of a volume bar displayed in the UI.

In a case where the user is satisfied with the volume of the radio, at operation 1050, the user may draw a shape, e.g., X, in the UI indicative of a desire to close the interface. At operation 1052, the controlling device 616 may generate and send an input event (e.g., corresponding to the shape drawn by the user) to the application module 618. The application module 618 may send a recognition request to the shape recognition module 619 at operation 1054. According to certain embodiments, the shape recognition module 619 may recognize that the shape is an X and may determine that the X corresponds to an instruction to close the UI. At operation 1056, in such a case, the shape recognition module 619 may send a recognition response (e.g., including information associated with closing the UI) to the application module 618. The application module 618 may send a UI update to the controlling device 620 at operation 1058. According to certain embodiments, the controlling device 20 may act, e.g., perform an operation, according to the UI update (e.g., closing the UI).

It will be recognized, of course, that, in addition to the operations and interactions disclosed in FIG. 10 and representing the activities occurring in a controlling device, many additional activities that are not represented in FIG. 10 may occur in the smart space. According to embodiments, these additional activities may include, for example, sending (e.g., also sending) the command to a smart space gateway when a shape is recognized so that the smart space gateway may send that command to the radio such that the radio may increase its volume in accordance with the command. Furthermore, for example, the radio may send a command execution confirmation message back to the gateway, and the gateway may forward the confirmation to the controlling device. According to certain embodiments, the controlling device should not normally change the UI at the controlling device to indicate that the volume has been increased until it has confirmed that the radio has, in fact, increased its volume (e.g., until the radio has determined and/or received information indicating that the radio has increased its volume).

Referring to FIG. 6, according to an embodiment, an information ecosystem that performs a system-initiated adaptive UI transfer process may include any one or more of the smart space 600, a smart space entity, such as a smart space management module 630, one or more UIDD 626, and a communications network 628.

According to embodiment, as discussed above, the smart space 600 may be and/or may include a database (not shown), such as a semantic database, and which may be referred to as a smart space database. The smart space database may contain information about a user, a user's preferences, applications, devices in the smart space, and any other information related to the smart space. The smart space 600 may contain, transmit, and/or receive application descriptions that specify UI capabilities, such as information representation capabilities (e.g., capabilities relating to displaying information for the user) and controller representation capabilities (e.g., capabilities relating to user interactions and/or user inputs for a UI) provided by application modules.

According to embodiment, smart space entities may be modules that produce information for and/or transmit information to a smart space, and may also receive and/or process information in a smart space. Additionally, smart space entities may monitor changes, updates, modifications, etc., to information related to a smart space, and may also monitor how information changes in the smart space. Among a variety of different smart space entities, such as those discussed above and/or shown in FIGS. 1-5, three kinds of smart space entities are: (1) a user's primary device, e.g., a UE, a computer, etc., an activity notification device, which may be referred to as an activity notifier, (2) an alternative UI adaption module, which may also be referred to as a UI adaption module, and (3) modules participating in smart space management.

According to embodiments, an activity notifier may deliver, transmit, and/or provide activity notifications and/or information about a device, an application, a service, a feature, etc., of a user's primary device, and information about actions of the user's primary device. According to certain embodiments, for example, the activity notifier may provide a notification, e.g., an activity notification, on a voice and/or video call, a text message, a service notification, a status message, etc. As another example, the activity notifier may provide information, e.g., an information notification, on peripherals connected to the user's primary device, and other similar and/or suitable types of information to the smart space. According to certain embodiments, an activity notification may refer to and/or specify a name for an activity, e.g., “Incoming Message”, may refer to and/or specify UI capabilities that are needed from the smart space to handle the processing of the activity, and/or may refer to and/or specify UI parameters and content to be used in the deployment of a low capability embedded UI, which may be deployed in a low capability embedded UI device (LCEUID). The LCEUID may be referred to as a UI device herein below.

According to embodiments, the alternative UI adaption module may include application modules that provide UI capabilities for information representations and/or controller representations, and may include UI device(s) that provide an application interface and/or an interaction management module. The application interface may enable an application module to use a UI device to provide a representation of one or more applications' information and controllers. The interaction management module may implement the application interface and may control a UI device's inputs/outputs, input/output interfaces, input/output operations and functions, and other similar and/or suitable features of a UI device.

According to embodiments, a smart space may include and/or be provisioned via a communication network and/or system, such as the communication systems illustrated in FIGS. 1-5, to transfer data, information, and/or messages between external communication devices, external communication networks, and smart space entities. For example, the communication network of a smart space may allow for smart space management modules to communicate with other devices, items, apparatuses, and/or elements of the smart space.

According to embodiments, a smart space management module 630 may be a part or an entirety of any one or more of: (1) a smart space database interface that enables other smart space entities to publish information to a smart space and to monitor changes in information in the smart space (e.g., smart space entities may monitor changes in main information types, such as application descriptions, user preferences, and/or device descriptions); (2) an ID module that provides an identification of a user in a smart space; (3) a recognition module that may provide recognition of use-situations in a smart space; a redirection module that may provide redirection of UIs to alternative UI devices in a smart space; (4) an adaptation module that may provide adaption of content suitable for alternative UI devices; and (5) a learning module that may learn user preferences from alternative UI usage patterns.

According to embodiments, a system-initiated process of adapting a UI when transferring the UI between a user's primary device UI and a low-capability embedded UI of a smart space may provide the following benefits, features, and/or operations. According to certain embodiments, home furniture, fixtures, appliances, and/or decorative items may be part of a smart space (e.g., which may be referred to as a home smart space, a personal smart space, and/or an interactive smart connected space), without needing to be programmed to operate in the smart space. For example, according to certain embodiments, a UI may be displayed, e.g., via a LCEUID, at one or more locations where a person may be located, without configuring parameters of the device. In other words, according to embodiments, a smart space may provide ecosystems of devices that each include a LCEUID (e.g., a table, a mirror, a refrigerator, etc.), that may display a UI adapted to be displayed on a respective device via its LCEUID without having to configure parameters used to operate a display device included in the LCEUID. According to certain embodiments, system-initiated provisioning of alternative UIs may be provided such that an initialization of a UI for a LCEUID may not require an input, a command, and/or an action from the user. However, according to embodiments, the user may decide to accept or reject the activation of the UI.

According to embodiments, a need for embedded code for displaying a UI (e.g., an amount of embedded code used for displaying the UI), included in a LCEUID may be minimized because application logic may be maintained, stored, and/or executed at the service-level and may be managed outside the LCEUID. In such a case, a life-cycle of devices including LCEUIDs may be increased (e.g., the same UI devices may be used for new purposes based on service level management of the UI displayed via a LCEUID).

According to embodiments, a UI device may provide, include, and/or execute an interaction manager that enables the use, execution and/or control of UI capabilities over network connections.

According to certain embodiments, LCEUIDs may be reused for different kinds of applications in a case where application logic of the different kinds of applications is not integrated into the LCEUIDs. For example, in a case where application logic is maintained, stored and/or executed at the service level, LCEUIDs may be reused for different kinds of applications based on service level operations, functions, commands, and/or applications.

According to certain embodiments, 3^{rd} party developers may be able to develop applications for existing UI devices in a smart space. For example, 3^{rd} party developers may deploy, update, install, and/or execute applications based on service level operations, functions, commands, and/or applications and/or based on an interaction manager.

According to embodiments, a system-initiated process of a smart space (e.g., the smart space 600) adapting a UI transferred between a user's primary device and a LCEUID may provide greater (e.g., more rigorous or clear) separation between operations, functions, commands, and/or applications of different operating levels (e.g., an information-level, a service-level, a device-level, and/or any other similar and/or suitable operating level) of the UI transfer process. For example, the information used in the UI transfer process may be available in a shared database and may be clearly separated from the smart space management modules. In such a case, it may be easier to provision the information for different purposes of different operating levels in the future.

According to embodiments, a system-initiated process of adapting a User Interface (UI) when transferring the UI between a user's primary device UI and a low-capability embedded UI of a smart space may allow for development of new businesses, commercial services, public services, and/or commercial markets offering new services and/or applications for one or more devices and/or one or more groups of devices. For example, entities (e.g., public and/or private institutions, organizations, companies, businesses, vendors, etc.) providing devices, services, and/or applications for smart space networks may gather information (e.g., customer experience information) related to the customer based on a device of the smart space (e.g., a LCEUID, a smart space server, and/or any other device included in a smart space that may, for example, use and/or execute application modules, such as machine learning modules and/or modules related to user preferences).

### Low-Capability Embedded UI Device

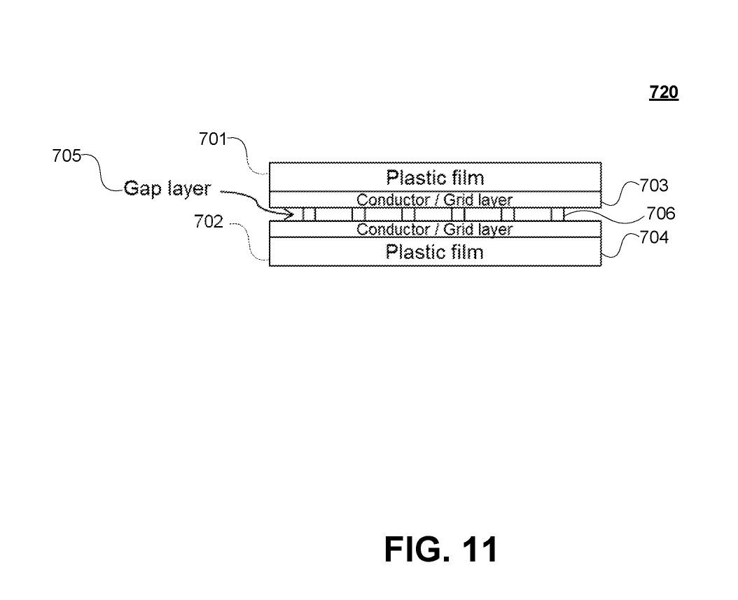

FIG. 11 illustrates an input unit of a LCEUID according to embodiments.

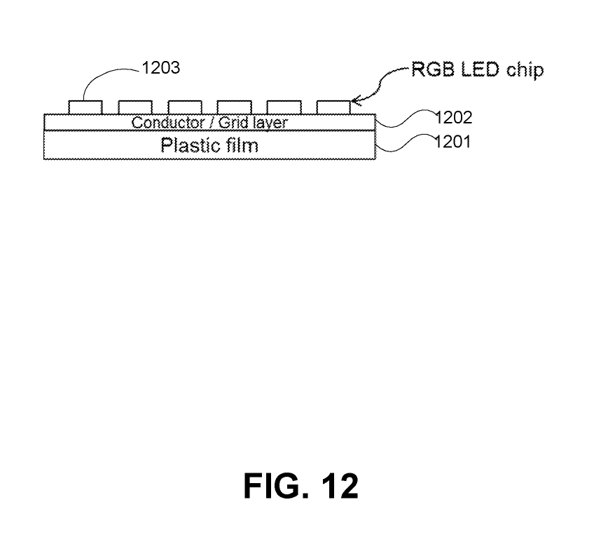

FIG. 12 illustrates an output unit of a LCEUID according to embodiments.

Referring to FIGS. 7 and 11, according to embodiments, the input unit 701, which may be referred to as a touch input unit 701, may use analog resistive touch sensing technology with a digital interface, and may include an upper substrate 1101, a lower substrate 1102, a first resistive conductor substrate 1103 disposed on the upper substrate 1101, a second resistive conductor substrate 1104 disposed on the lower substrate 1102, an air-gap layer 1105, and one or more dielectric units 1106 disposed in the air-gap layer 1105, as illustrated in FIG. 11. However, the present disclosure is not limited thereto, and the touch input unit 701 may include any suitable and/or similar technology, such as capacitive type touch sensing technology, for sensing and/or determining a user's touch input, and/or a user's non-touch input (e.g. an input based on a user's proximity).

According to embodiments, in a case of an analog touch sensor, which may be the analog resistive touch sensor included in the touch input unit 701, when a touch to the upper substrate 1101, and/or a pushing on the upper substrate 1101 occurs (e.g., with a finger or stylus), the first resistive conductor substrate 1102 may be connected to (e.g., may directly or indirectly contact) the second resistive conductor substrate 1103. In such a case, an electrical current may go (e.g., may conduct) through a point of the contact between the first and second resistive conductor substrates 1101 and 1102. According to certain embodiments, in such a case, a touch position may be detected and calculated by a controller, e.g., an integrated circuit, such as the input control unit 707, as an analog signal (e.g., an analog input), corresponding to the user's touch input, and the analog input may be converted to digital information.

According to certain embodiments, the upper and lower substrates 1101 and 1102 may be formed of a plastic material, such as polyester, and the first and second resistive conductor substrates 1103 and 1104 may be formed at a first phase so as to be disposed respectively on the upper and lower substrates 1101 and 1102. The air-gap layer 1105 may be formed by the deposition of a dielectric material as a dot matrix (e.g., by the deposition of one or more of the dielectric unit 1106 between the first and second resistive conductor substrates 1103 and 1104).

Referring to FIGS. 11 and 12, an output unit 703, which, according to certain embodiments, may be referred to as a light output unit 703 and may include one or more light emitting devices. According to certain embodiments, the one or more light emitting devices may be a light emitting diode (LED) 1203 (e.g., a Red Green Blue (RGB) LED circuit) disposed and/or formed on a conductor 1202 which may be disposed and/or formed on a base substrate 1201. The base substrate 1201 may be formed of plastic materials (e.g., polyester) and/or any other similar and/or suitable substrate material. According to certain embodiments, the conductor 1202 may electrically connect one or more of the LEDs 1203 and a light output control and driver unit (e.g., the output control unit 709). One or more of the LEDs 1203 may be formed (e.g. via glue bonding and/or any suitable and/or similar forming process) on the conductor 902, so as to generate and/or emit RGB colors.

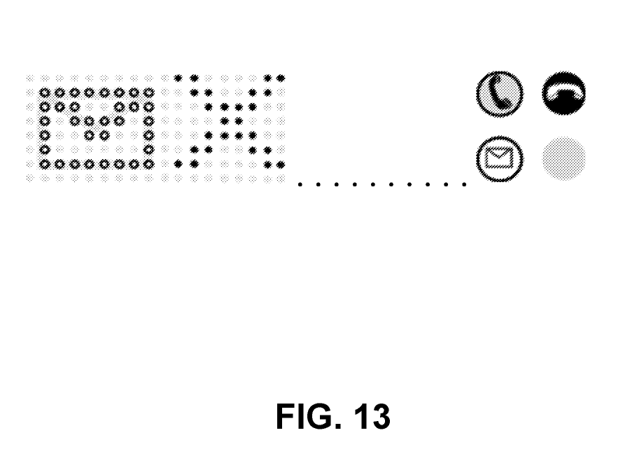

FIG. 13 illustrates visual symbols displayed by an output unit according to embodiments.

Referring to FIG. 13, according to embodiments, one or more visual symbols (e.g., an email symbol, a phone call symbol, a text message symbol, etc.) may be displayed using the LEDs 1203. According to certain embodiments, the LEDs 1203 may be formed as a LED matrix and/or as an LED backlight included in a device (e.g., a LCEUID). In a case of an LED matrix, light output from and a color state of the LED 3003 may be driven and/or controlled by the light output unit 703. According to certain embodiments, the LED 1203 may operate as a backlight behind the visual symbols (e.g., to illuminate the visual symbols), and the visual representation of the visual symbols may be controlled by a light input control/driver (not shown). According to certain embodiments, FIG. 13 illustrates visual symbols that may be controlled to be displayed on an LCEUID based on information related to a target UI received by the LCEUID during the UI transfer process.

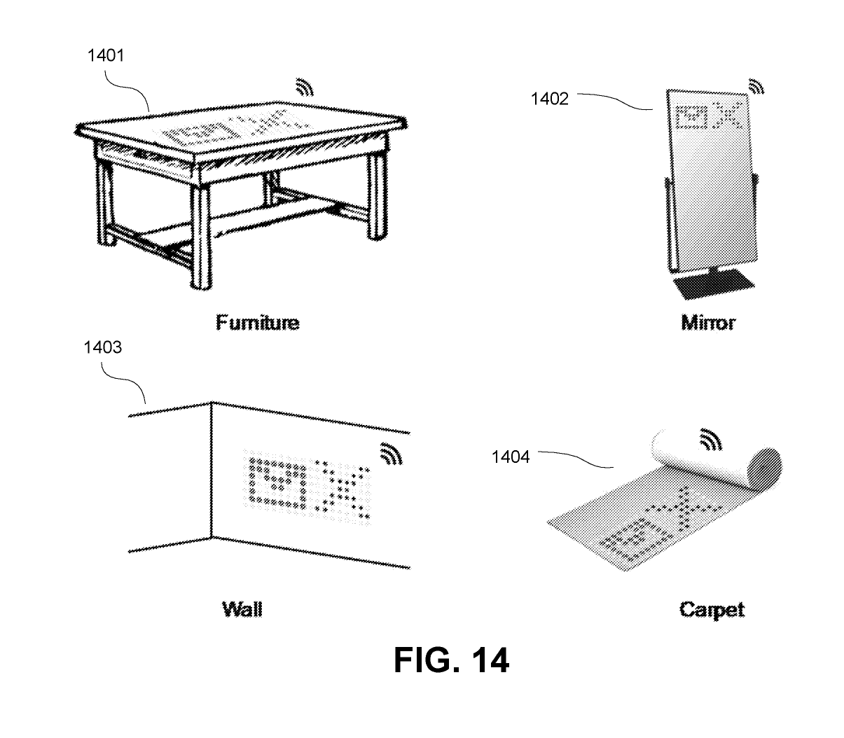

FIG. 14 illustrates use cases for low-capability embedded UIs according to embodiments.

Referring to FIG. 14, according to embodiments, one or more LCEUID 720 may be included in any one or more of a furniture 1401, a mirror 1402, a wall 1403, a carpet 1404, and/or any other similar and/or suitable item and/or location for the LCEUID 720. According to certain embodiments, a user of a smart space may be alerted by any one or more of the LCEUIDs 720 to present information to the user (e.g., an alert, a type of action needed, or any other similar and/or suitable information that may be presented by the LCEUID 720). In a case where an email and/or another type of message is received, the user may be alerted with a blinking envelope symbol, and/or any other similar and/or suitable visual cue.

According to certain embodiments, a UI (e.g., an input/output (I/O) UI, an output-only UI, an input-only UI) may be provided to a user as a projected image in a smart space (e.g., the smart space 600). For example, the UI may be displayed via a projector (e.g., a smart projector) on walls, floors, and tabletops, etc. According to certain embodiments, the UI displayed via the projector may be an output-only UI for displaying (e.g., for only displaying) an image, and may be controlled based on recognition of user interactions with an I/O UI and/or an input-only UI. For example, the input-only UI may be a touch input UI using buttons on a remote controller of the projector for controlling a location of the UI displayed via the projector. However, the present disclosure is not limited thereto, and the input-only UI may be associated with and/or provisioned via any input unit and/or input device that may receive an input command, such as, for example a microphone, a camera, a sensor, etc. According to certain embodiments, the smart space may identify and register the projector the remote controller as UI devices, and may use the projector and the remote controller as connected UI devices through an application interface and an interaction manager, such as the application interface 722 and the interaction manager 724, according to an embodiment.

### Registration of a Low-Capability Embedded UI Device in a Smart Space

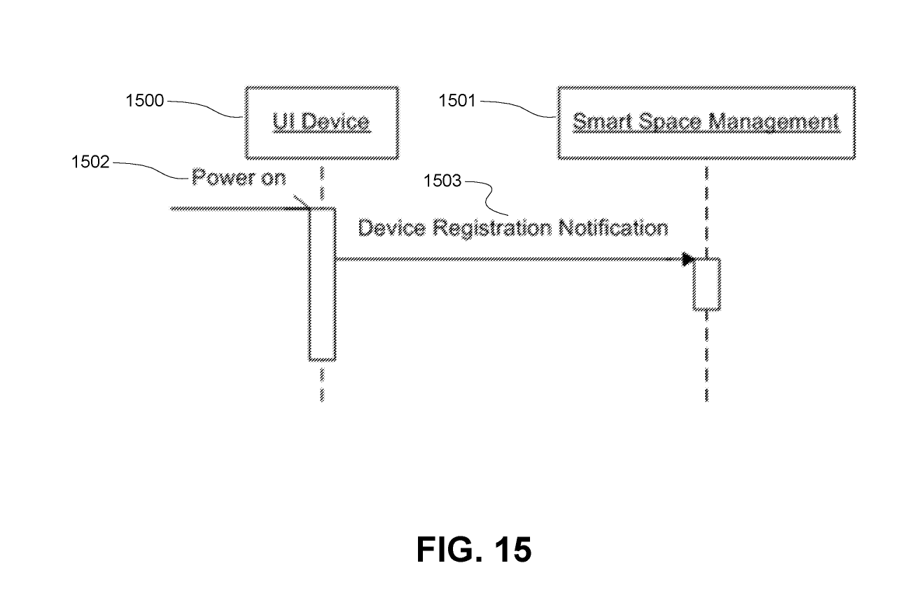

FIG. 15 is a signal flow diagram illustrating a method of registering a LCEUID to a smart space according to embodiments.

Referring to FIG. 15, according to embodiments, a LCEUID 1500 may be turned on (e.g., powered on and/or activated from a low-power mode), at operation 1502. At operation 1503, the LCEUID 1500 may transmit a message to a smart space management device 1501 to register with a smart space. According to an embodiment, the message transmitted to the smart space management device 1501 may be referred to as a device registration notification message, and may include information related to the LCEUID 1500. According to certain embodiments, the device registration notification message may include information on a type of device that includes a LCEUID (e.g., a chair, wall, appliance, etc., that includes the LCEUID 1501), capabilities of a LCEUID, and other suitable and/or similar types of information regarding and/or related to a LCEUID.

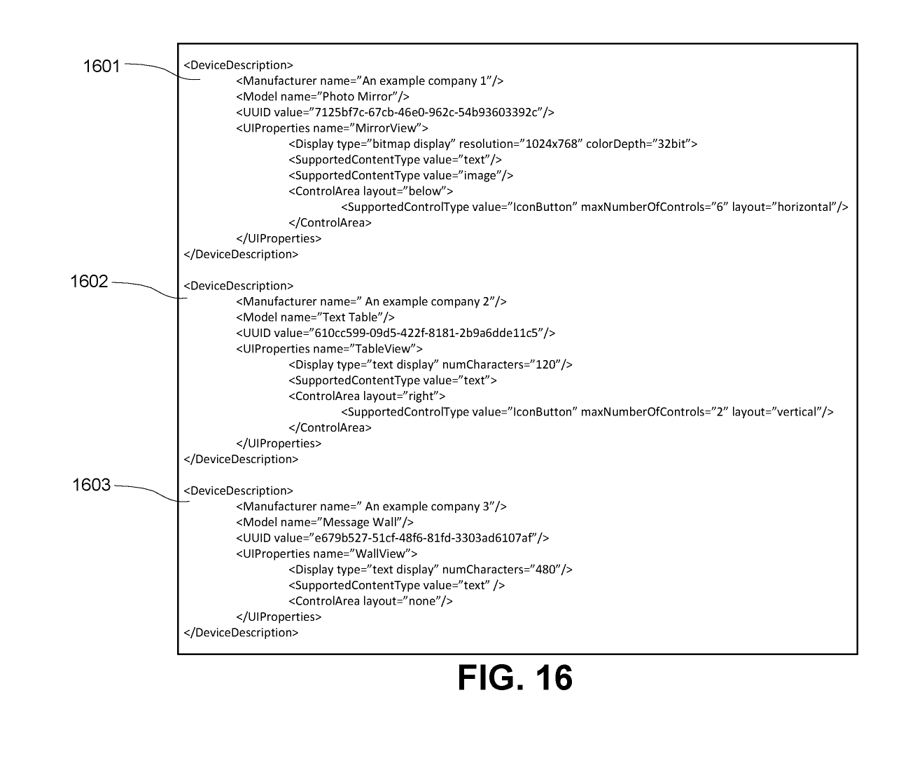

FIG. 16 illustrates exemplary contents of a device registration notification message according to embodiments.

Referring to FIGS. 14 and 16, according to embodiments, in a case where a LCEUID is included in the mirror 1402, a device registration message 1601 may include information related to the mirror, such as, for example, information that the mirror displays text and images up to a resolution of 1024×768, with a 32-bit color depth, and that the mirror supports receiving inputs for up to six different icon buttons. In a case where a LCEUID is included in a tabletop display included in the furniture 1401, a device registration message 1602 may include information related to the tabletop display, such as, for example, information that the table displays text and up to two different icon buttons. In a case where a LCEUID is included in a wall, a device registration message 1603 may include information related to the wall, such as, for example, information that the wall displays up to 480 characters of text and has no controllable inputs. According to certain embodiments, in a case where the device registration message 1603 includes information that the wall has no controllable inputs, the smart space may determine a time to stop displaying text to a user based on any of: (1) a timeout (e.g., a display time threshold); (2) a proximity of a user to the wall; (3) and/or based on any other similar and/or suitable event triggering a stopping of displaying of information on the wall.

### Mapping Between Activities and UI Capabilities

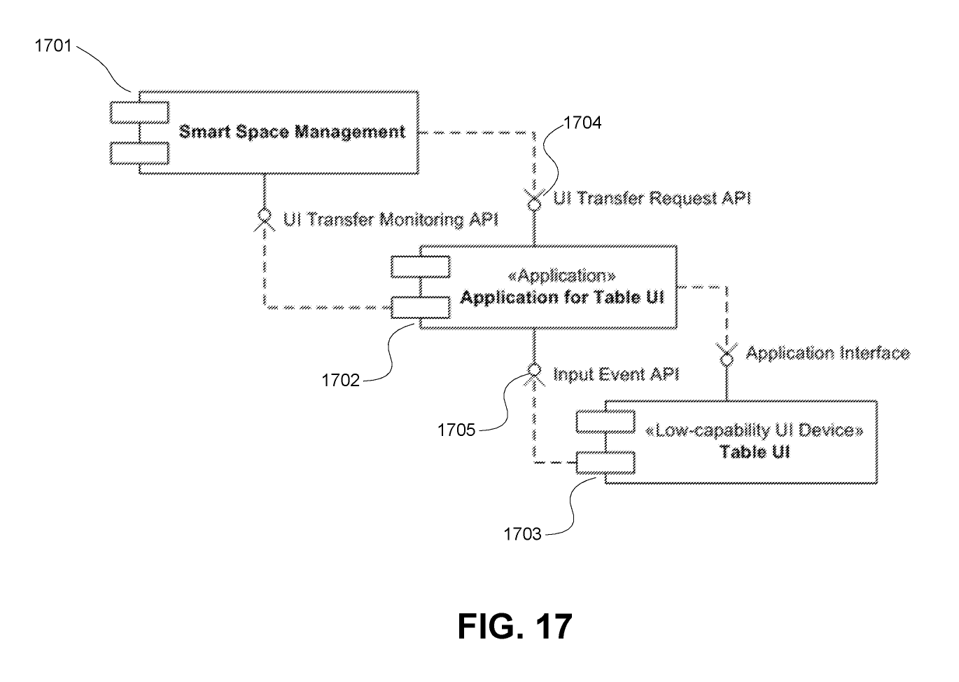

FIG. 17 illustrates mapping between activities and UI capabilities according to embodiments.

Referring to FIG. 17, according to embodiments, mapping between activities and UI capabilities may be performed using a smart space management module 1701, an application module 1702 (e.g., an application for Table UI), and a table UI module 1703 (which may be referred to as a table UI device). According to certain embodiments, there may be a case where mapping between activities and UI capabilities includes determining a suitable representation of a target UI, while considering UI display properties of a LCEUID, and further includes transmitting the suitable representation of the target UI to the LCEUID via an application interface. In such a case, the LCEUID may display the information as is, i.e., as the transmitted suitable representation of the target UI. According to certain embodiments, the LCEUID may transmit all detected user input events to an application corresponding to the target UI, wherein the LCEUID does not contain any application-specific logic (e.g., the LCEUID is not able to process the user input events).

According to embodiments, displaying of various types of information and presenting different types of controls by a UI device via a smart space may be based on the application module 1702. For example, according to certain embodiments, the application module 1702 may register, or, in other words inform and/or notify, its capabilities to the smart space management module 1701, as a part of a device description, so that the device description is stored in the smart space database (see FIG. 6) so that the device description may be accessed at a later time. According to other embodiments, the application module 1702 may monitor UI transfer requests. For example, the application module 1702 may monitor UI transfer request notifications, e.g., an open message activity notification, received via a UI transfer request application program interface (API) 1704, and may deliver the content provided in the transfer request notification to a UI device.

According to embodiments, the application module 1702 may implement capabilities for the execution of activities, e.g., an open message activity. For example, the application module 1702 may represent content and UI controls in the UI device by using the UI device's application interface and may receive input events produced by the UI device via an input event API 1705. In such a case, the application module 1702 may process and/or perform operations based on the input events. For example, according to certain embodiments, the application module 1702 may control a representation of content (e.g., may scroll and/or zoom the content if the user has inputted a scrolling and/or a zooming command into a UI). As another example of the application module 1702 processing the input events, the application module 1702 may control progress of the UI transfer process (e.g., if the user has clicked an open message button or a close message button in the UI), and may deliver UI transfer notifications (e.g., a UI transfer started notification or a UI transfer ended notification, for the smart space management module 1701).

According to embodiments, the functions, features and operations described with respect to FIG. 17 may be executed after a user defines and/or selects an alternate UI to perform an action, operation, and/or function that may not be performed by a UI that the user is currently using.

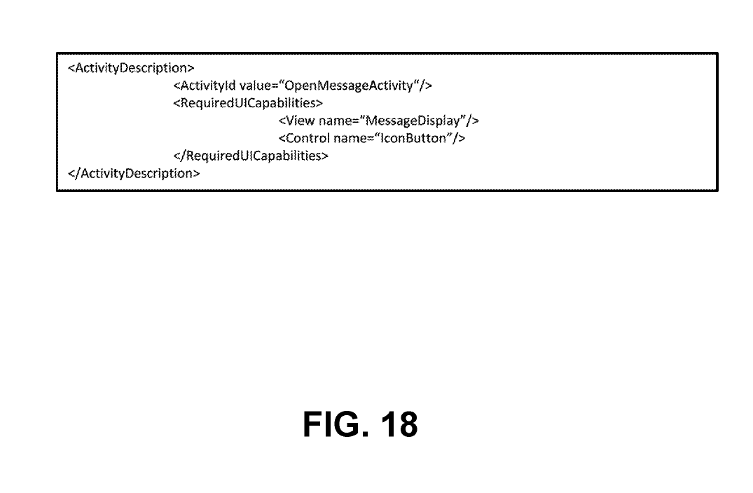

FIG. 18 illustrates an activity description for an open message action according to embodiments.

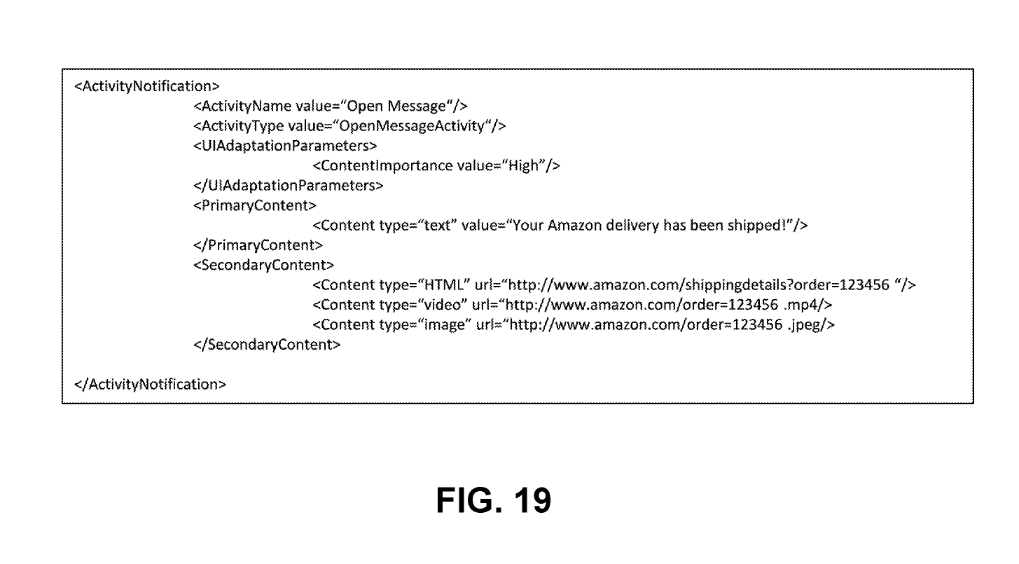

FIG. 19 illustrates XML specifying an activity notification message according to embodiments.

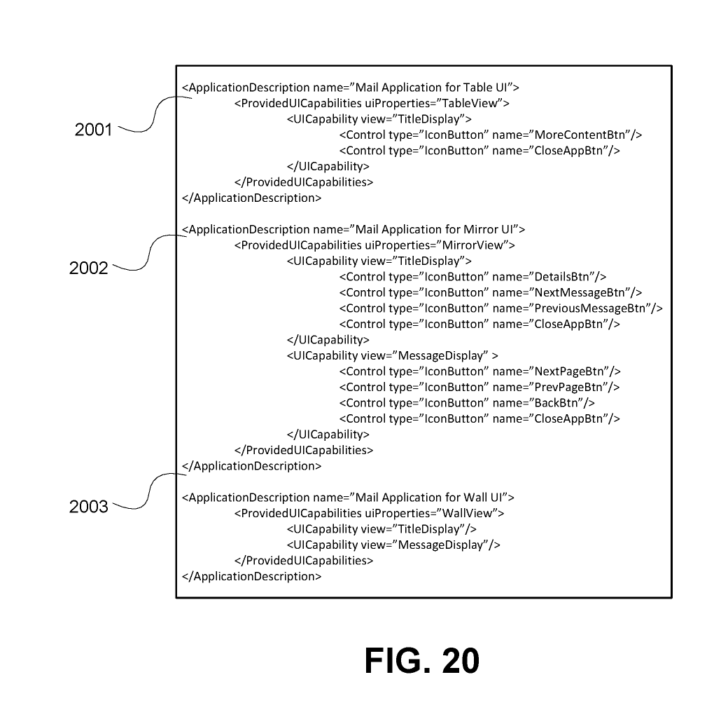

FIG. 20 illustrates application descriptions for different alternative UIs according to embodiments.

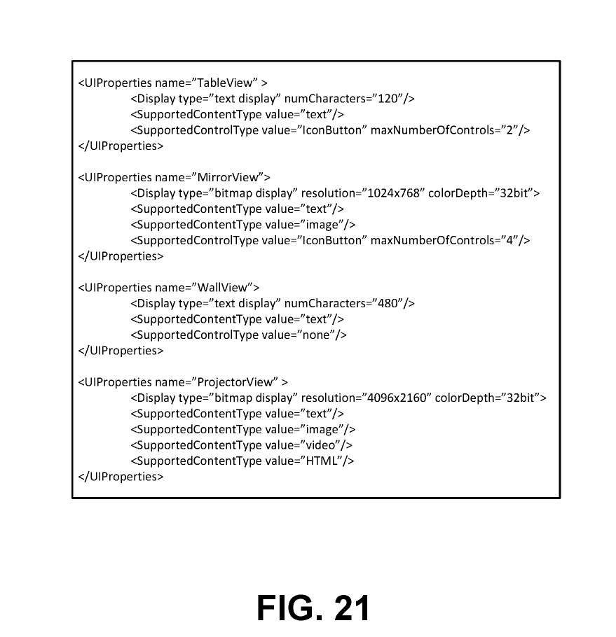

FIG. 21 illustrates UI property descriptions for different kinds of view types according to embodiments.

Referring to FIGS. 18-21, according to embodiments, searching for UI capabilities for activities, e.g., searching a smart space database storing device descriptions, may be based one or more of: 1) activity descriptions, as shown in FIG. 18; 2) activity notification messages, as shown in FIG. 19; 3) application descriptions, as shown in FIG. 20; and 4) UI property descriptions, as shown in FIG. 21. For example, in a case where a smart space management module receives a UI transfer request including information on an activity and/or application, the smart space management module may search device descriptions in the smart space database for candidate LCEUIDs based any of: the activity descriptions, the activity notification messages, the application descriptions, and the property descriptions.

Referring to FIG. 18, an activity description may define UIs that are used and/or needed by a smart space to perform processing of the described activity, according to an embodiment. For example, in a case where a UI transfer request is based on an activity for an email application UI that includes receiving of a user input (e.g., in order to accept or reject a meeting invitation), the activity description may include information that defines a UI that receives a user input. Accordingly, in such a case, the smart space management module may search for candidate LCEUIDs that provide a UI that receives a user input.

Referring to FIGS. 17 and 19, an activity description, according to an embodiment, may specify information on an activity corresponding to the UI to be transferred (e.g., information on how the UI is to be displayed used). For example, the activity description may include information on a type of an activity that enables the smart space management module 1701 to obtain the activity description for the activity notification (e.g., the type of activity may be a user notification type, a system update information type, a broadcast message type, etc.). According to certain embodiments, the activity description may include information on primary content to be shown in the UI (e.g., information on the primary content being a text file, a sound file, a system update file, an image file, etc.), and may also include similar information on secondary content to be shown in the UI.

According to embodiments, the activity description may include information on a content type for any one or more of the primary content and the secondary content (e.g., information that a text file content type is animated text, information that an image file content type is a portable network graphics (PNG) type, information that a system update file is an executable file, etc.), and such information may be used in the selection of application components. According to certain embodiments, there may be a case where primary content must be shown in the UI to be transferred while secondary content is optionally displayed. In such a case, a smart space (e.g., a smart space management module) may determine which application components are capable of displaying the primary content, and which application components are capable of displaying both the primary content and the secondary content. According to certain embodiments, the smart space may rank the one or more application components based on respective capabilities for displaying the primary content versus displaying the primary content and the secondary content.

Referring to FIG. 20, according to embodiments, an application description may specify UI capabilities, such as information representation capabilities (e.g., display an image), and controller representations (e.g., display a scroll bar). The application description may specify UI capabilities based on a respective LCEUID providing the UI capabilities. According to certain embodiments, an application description of a same mail application may be different for a LCEUID disposed in a table as compared to a LCEUID disposed in a mirror, even though the table and mirror LCEUIDs are executing the same mail application.

According to certain embodiments, referring to FIG. 20, a first application description 2001 describes a mail application for a table UI device (e.g., table UI module 1703). According to the first application description 2001, the application executed by the table UI device may only display a title of a message, and may include two controls for scrolling the title of the message in the display and closing the application (e.g., two icon buttons respectively having icon names ‘MoreContentBtn’ and ‘CloseStn’). Similar applications are described for a Mirror UI device and a Wall UI device. According to certain embodiments, the second application description 2002 describes a mirror UI mail application that may display a message title (e.g., a “TitleDisplay” description) and contents of the message (e.g., a “MessageDisplay” description), may display icons for controlling browsing and/or scrolling through message titles, opening message contents, scrolling content (e.g., pages of a message), going back to a message title screen, and closing the application. A third application description 2003 describes a wall UI mail application that may display textual content (e.g., a message title and message content) without any interactive controls. According to certain embodiments, closing of the wall UI mail application may be done without a user input (e.g., may be based on a timeout value that corresponds to a displayed message length and/or by sensing that the user has moved away from the wall displaying the wall UI mail application).

Referring to FIG. 21, according to embodiments, UI property descriptions may provide additional information related to UI capabilities. For example, UI property descriptions may specify supported content types (e.g., an animated png file), and control types (e.g., zoom control for a png file) for different views provided by one or more applications.

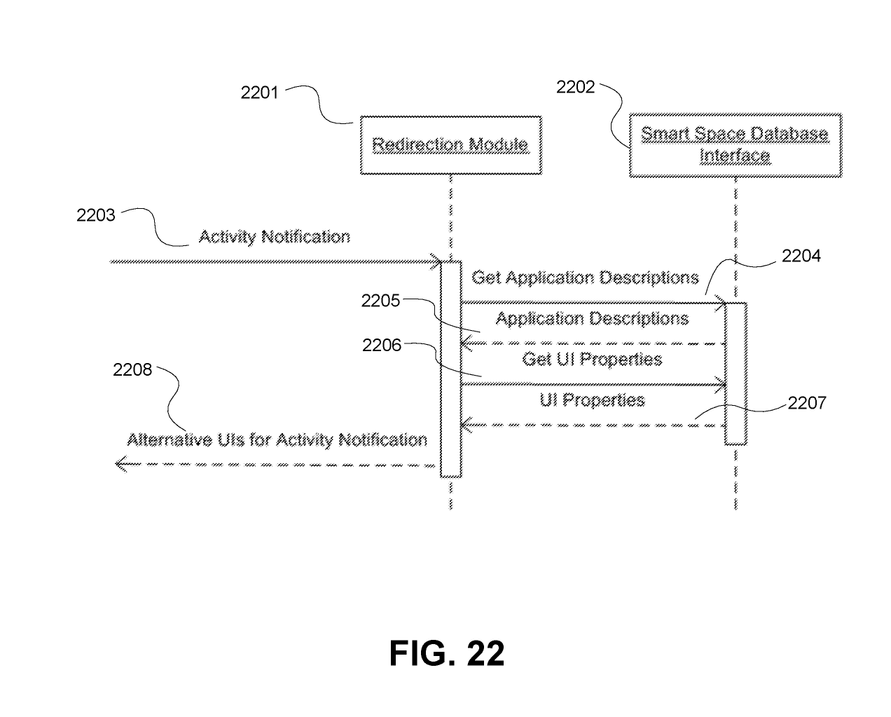

FIG. 22 is a signal flow diagram illustrating determining of alternative UIs for an activity notification according to embodiments.

Referring to FIG. 22, according to embodiments, a redirection module 2201 may select an application module for an activity notification according to the information illustrated in FIGS. 18-21 and discussed above. The redirection module 2201 may select an application module based on any of needed UI capabilities and types of primary content. According to certain embodiments, needed UI capabilities may be capabilities that the UI needs in order to provide certain views and controls for the activity. According to certain embodiments, the types of primary content may relate to (e.g., indicate) views that are capable of representing (e.g., displaying) the primary content delivered in the activity notification for the user and/or any primary content related to the activity.

According to embodiments, the redirection module 2201 may select an application module based on information received from a smart space database interface 2202. According to certain embodiments, at operation 2203, the redirection module 2201 may receive an activity notification from another device in the smart space. At operation 2204, the redirection module 2201 may request the smart space database interface 2202 to deliver application descriptions for the application available in the smart space. At operation 2205, the smart space database interface 2202 transmits the application descriptions to the redirection module 2201, and the redirection module 2201 may select application descriptions that provide the needed views and controls for the activity. According to certain embodiments, at operation 2206, the redirection module 2201 may request the smart space database interface 2202 to deliver UI properties for the selected application descriptions. At operation 2207, the redirection module 2201 receives, from the smart space database interface 2202, UI properties for the selected application descriptions. At operation 2208, according to certain embodiments, the redirection module 2201 determines and/or performs a matching of the UI properties of the selected application descriptions and application modules of other devices, and may transmit the selected application descriptions to the application modules. According to certain embodiments, the application modules may provide alternative UIs for the activity notification that are capable of representing the primary content delivered in the activity notification corresponding to user.

### Adapting an Advanced Capability Device UI to a Low Capability Device UI

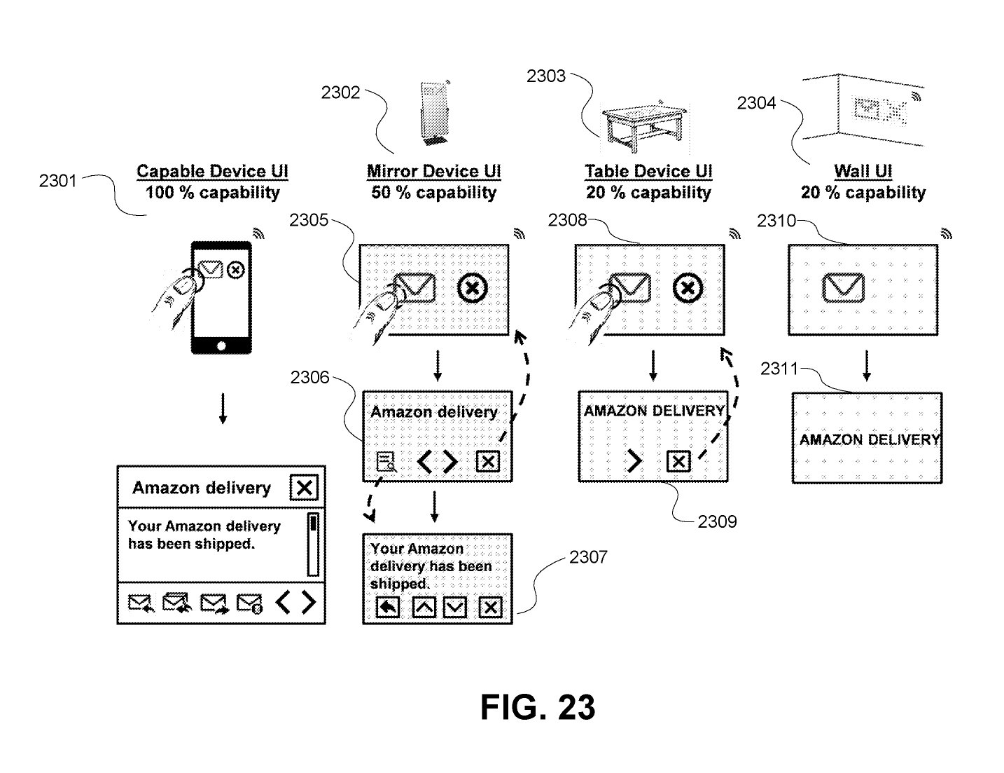

FIG. 23 illustrates content adaptation from an advanced capability device UI to a low capability device UI according to embodiments.

Referring to FIG. 23, according to embodiments, a smart space may include any of an advanced capability device UI 2301 (e.g., a user's primary UI device, such as a mobile phone), a mirror device UI 2302, a table device UI 2303, and a wall UI 2304. According to certain embodiments, a mail message may be adapted from being displayed by the advanced capability device UI 2301 to being displayed on one of the other UIs included in the smart space. According to embodiments, an advanced capability device UI may have, for example, any one or more of twice a screen resolution, twice a processing power, twice as much memory, a faster wireless communication capability, etc., as compared to a LCEUID. According to certain embodiments, in a first case of adapting the advanced capability device UI 2301, the mirror device UI 2302 may use a dot matrix display 2305 that can render rich text with a reasonable amount of content and may display a few controls, and has half the resolution of a display used by the advanced capability device UI 2302. The mail application for the mirror device UI 2302 may display a title of the message while providing controls for browsing through mail messages, as shown in screen 2306, and may display a mail message body as well as the controls for browsing through content of the mail message, as shown in screen 2307.

According to certain embodiments, in a second case of adapting the advanced capability device UI 2301, the table device UI 2303 may use a tabletop display 2308 that has one-fifth the resolution of the display used by the advanced capability device UI 2301, such that the tabletop display 2308 may be capable of only displaying text, and thus, may only show email message titles and two control buttons, enabling the scrolling of title text and exiting the application, as shown in screen 2309.

According to certain embodiments, in a third case of adapting the advanced capability device UI 2301, the Wall UI 2304 may have no controls, and may display (e.g., only display) simple graphical images and/or text for a predefined time before exiting to a main symbol UI, as shown in screens 2310 and 2311. In such cases, the adaptation of the advanced capability device UI 2301 may be done by the corresponding application (e.g., the Mirror Device mail application, the Table Device mail application, and the Wall UI mail application).

Process for Transferring UIs from an Advanced Capability UI Device (User's Primary Device) to a Low-Capability Embedded UI Devices in a Smart Space

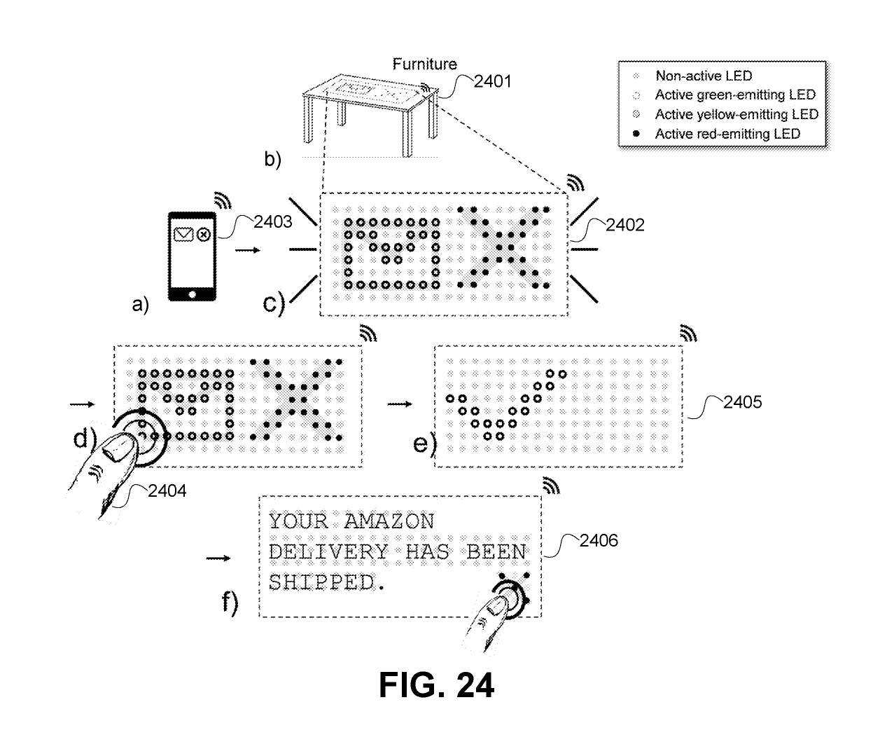

FIG. 24 illustrates a UI transfer process from a user's primary device to a LCEUID, according to embodiments.

Referring to FIG. 24, according to embodiments, a table LCEUID 2401 may display a UI 2402 that has been transferred from a user's primary device 2403. According to certain embodiments, the user may perform an input gesture 2404 to the UI 2402 that may be displayed on the table LCEUID 2401. According to certain embodiments, in a case where the input gesture 2404 indicates accepting of displaying of a mail message, the table LCEUID 2401 may display a screen 2405 showing acceptance of the displaying of the mail message, and may display the mail message as shown in screen 2406.

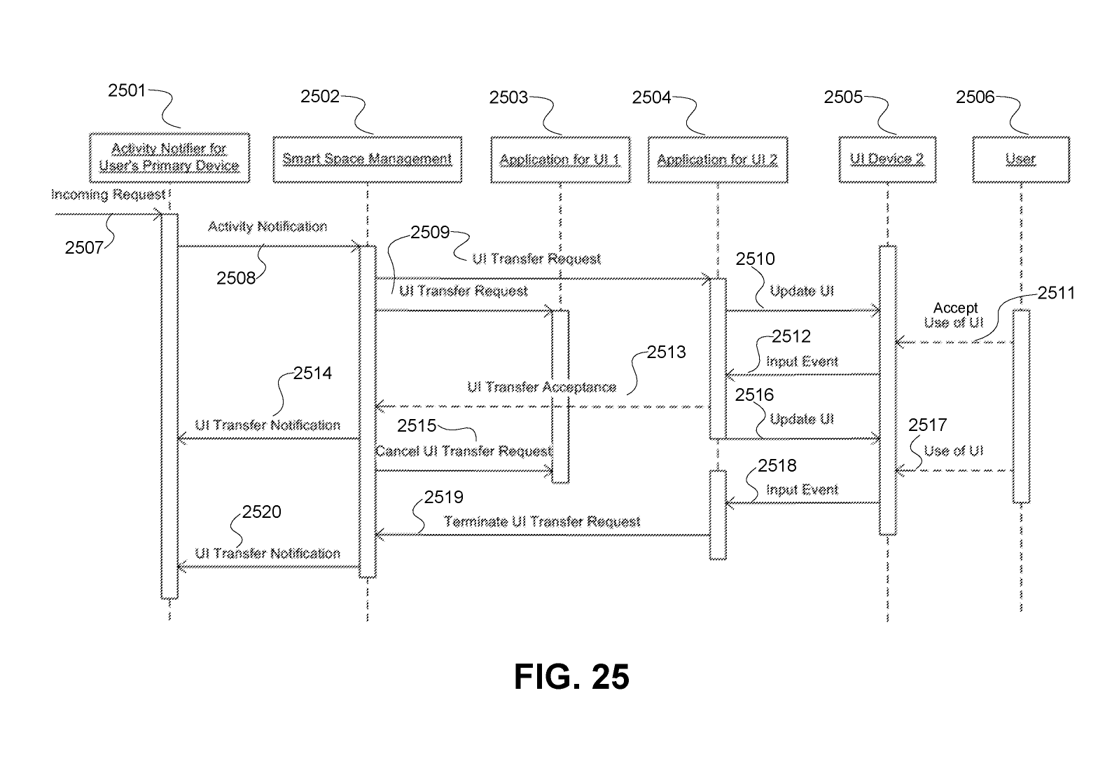

FIG. 25 is a flowchart of a UI transfer according to embodiment.

Referring to FIGS. 23, 24, and 25, according to embodiments, a process of transferring a UI from the user's primary device to a LCEUID may include one or more preconditions. For example, according to certain embodiments, as a precondition, a personal smart space (e.g., a smart space in a user's home, a smart space 600) may need to contain and/or include a smart space management module, UI devices including the user's primary device (e.g., a smart phone), and one or more LCEUIDs (e.g., for displaying UIs on tabletops, wallpapers, smart household appliances, etc.). According to certain embodiments, another precondition may be, for example, that the personal smart space may (or must) contain the applications needed for presenting specific activities on specific LCEUIDs. The applications may be or may have been obtained by the user/owner of the personal smart space from any suitable source (e.g., from an application store, a UI device manufacturer website, a UI device flash memory, a separate media, via a wired and/or wireless network connection, etc.). According to certain embodiments, as another precondition, for example, the smart space management module included in the personal smart space may identify and register UI devices to the smart space and may store application descriptions of each registered UI device in the smart space (e.g., in the smart space database). According to certain embodiments, the negotiation (e.g., messaging) related to any of activity notification, UI adaptation, UI transfer, and termination of UI transfer may performed via the smart space.

Referring to FIG. 25, according to embodiments, a personal smart space may include an activity notifier 2501, a smart space management module 2502, an application module for a first UI 2503, an application module for a second UI 2504, a second UI device 2505, and a user 2506 (e.g., the user possessing and/or operating a user's primary device). According to certain embodiments, at operation 2507, the activity notifier 2501 may receive a request corresponding to any of an internal device, an application, and a service action (e.g., a voice or video call, a text message, a service notification, a status message) of the user's primary device. At operation 2508, the activity notifier 2501 may generate and send an activity notification, based on the request received in operation 2507, to the smart space management module 2502.

According to embodiments, at operation 2509, the smart space management module 2502 receives the activity notification and transmits one or more UI transfer requests. According to certain embodiments, the UI transfer requests may be transmitted after negotiation of UI resources (e.g., after determining candidate UIs in the smart space). According to certain embodiments, the smart space management module 2502 may receive the activation notification as an input and may provide the activity notification to a redirection module (not shown). According to embodiments, the redirection module may be included in the smart space management module 2502 or may be a separate entity and/or a separate device from the smart space management module 2502. The redirection module may determine and/or select candidate UIs of applications, such as the application module for the first UI 2503 and the application module for the second UI 2504. According to embodiments, any of the first UI 2503 and the second US 2504 may execute an activity corresponding to an activity notification based on information included in an activity notification and/or associated with LCEUID capabilities.

According to embodiments, the smart space management module 2502 may transmit one or more UI transfer request for each of the selected candidate UIs of applications. At operation 2510, an application module of the selected candidate UI (e.g., the application module for a second UI) may update its UI by adapting the content delivered in the activity notification and may transmit the updated UI (e.g., to be displayed to the user via an LCEUID). According to certain embodiments, the application module may generate and transmit the updated UI, including the content adapted based on the capabilities of the LCEUID, via an application interface to the LCEUID.

According to embodiments, each of the candidate UIs and their respective application modules may respectively present a UI to the user. Referring to FIG. 24, the application module for the second UI 2504 that received a UI transfer request from the smart space management module 2502 may present a UI to the user. According to certain embodiments, the adapted content, which may be one or more of symbolic and numeric information, may be updated and/or adapted to be displayed by a LCEUID, as noted above. For example, content that was previously displayed as one image may be adapted to be displayed as a series of images. In such a case, the adapted content may include information on a chain of interactions with the user and the adapted content displayed on the LCEUID.

At operation 2511, the user 2506 may accept or reject the updated UI by performing a user input using the controls of the updated UI that was transferred in operation 2510. According to embodiments, the user input may be performed by touching a displayed UI object and/or by performing a input gesture based on proximity of a user′ hand/finger that may be proximate to, but not touching, the displayed UI object, as shown in FIG. 24. At operation 2512, the second UI device 2505 may generate an input event that may be received and processed by the application module for the second UI 2504. At operation 2513, the application module for the second UI 2504 may transmit a UI transfer acceptance message to the smart space management module 2502. According to certain embodiments, referring to operation 2511, in a case where the user 2506 executed the input gesture by touching an “Open Message” icon, the application module for the second UI 2504 may transmit the UI transfer acceptance message the smart space management module 2502. In such a case, the application module for the second UI 2504 may transmit a “show UI” message for the second UI device 2505 that may display the content of the message for the user 2506. At operation 2514, the smart space management module 2502 transmits a UI transfer notification to the activity notifier 2501.

At operation 2515, the smart space management module 2502 may transmit a cancel UI transfer request to the others of the one or more candidate UIs that received the UI transfer request (e.g., at operation 2509) and for which the UI transfer request was not accepted by the user 2506. At operation 2516, the second UI 2504 may provide (e.g., may display) an updated UI to the second UI device 2505. According to embodiments, the updated UI may include an input (e.g., a button) for terminating the transferred UI.

In a case where the user 2506 terminates the UI transfer to a LCEUID, e.g., the second UI device 2505, the user may perform an input gesture to terminate displaying of the adapted UI by the second UI device 2505, at operation 2517. Alternatively, at operation 2517, the user may perform input gestures for scrolling a displayed text, advancing to a next mail message, deleting a voice mail, etc. At operation 2518, the second UI device 2505 generates another input event that is transmitted to the application module for the second UI 2504. At operation 2519, the application module for the second UI 2504 transmits a terminate UI transfer request to the smart space management module 2502. The smart space management module 2502, upon receiving the terminate UI transfer request, transmits a UI transfer notification to the activity notifier 2501 indicating that the UI is to be transferred back to the user's primary device and/or an alternate LCEUID at operation 2520. According to an embodiment, the terminate UI transfer request may indicate that an active UI transfer request is terminated based on a user input or another reason, and a cancel UI transfer request may indicate that a UI transfer request may be cancelled but allows for a user to determine whether to cancel the UI transfer request.

According to embodiments, in a case where transferring of a UI has been accepted by a LCEUID (e.g., one UI transfer request has been accepted), other UI transfer requests may be rejected by transmitting a cancel UI transfer request (e.g., any number of cancel UI transfer requests corresponding to any number of the other UI transfer requests). According to certain embodiments, in a case where a user rejects a UI transfer request to a specific LCEUID (e.g., by interacting with a reject and/or cancel icon displayed by the specific LCEUID), all other UI transfer requests may be rejected by sending a cancel UI transfer request to all LCEUIDs in a smart space including the specific LCEUID. Additionally, in a case where a user rejects a UI transfer based on an input to the user's primary device, information on the rejection of the UI transfer may be sent from the user's primary device to a smart space management module (e.g., in order to terminate the UI transfer), and the smart space management module may send a cancel UI transfer request to all LCEUIDs in a smart space.

According to embodiments, a UI transfer may be terminated based on a condition (e.g., a timeout, a count, a threshold, an amount of time, etc., being exceeded and/or expired). In such a case, all UI transfer requests may be rejected based on the threshold being exceeded. According to certain embodiments, a smart space management module may determine and/or identify a need to terminate UI transfers, and may transmit a cancel UI transfer request. For example, the cancel UI transfer request may be transmitted to a LCEUID and that may be accepted and/or rejected (e.g., by the user via the LCEUID). According to certain embodiments, the smart space management module may send a cancel UI transfer request that automatically terminates a UI transfer without receiving an acceptance of the cancel UI transfer request.

According to embodiments, a smart space management module may determine and/or identify a need to terminate UI transfers and may automatically and/or independently terminate one or more UI transfer requests. According to certain embodiments, a user may terminate a transfer request via control buttons displayed by a LCEUID (e.g., a close button for closing a text message, as illustrated in FIG. 24). A smart space management module may determine that one or more other UIs are available and free to receive new UI transfer requests based on the cancel UI transfer requests. According to embodiments, a user and/or the smart space management module may terminate ongoing UI transfer requests and/or UI transfer activities.

### Message Protocol for UI Transfer in a Smart Space

According to embodiments, an activity notification message may have any of the following properties and elements: 1) an activity name that identifies a name of an activity that may be performed and/or continued by a LCEUID (e.g., displaying an incoming message alert); 2) an activity type that identifies a type of activity that may be performed and/or continued by a LCEUID (e.g., opening a message); 3) UI adaptation parameters that define parameters to be used in a UI adaptation (e.g., use of a big font size, use emphasis for important content, i.e., by blinking icons, etc., in the LCEUID; 4) primary content and/or information to be any of: adapted, represented, and displayed in the LCEUID; and 5) secondary content and/or information to be any of: adapted, represented, and displayed in the LCEUID.

According to embodiments, a UI transfer request message may have any of the following properties and elements: 1) an activity identifier (ID) that uniquely identifies a UI transfer action and/or a UI transfer request that may be associated with the UI transfer action; 2) an activity name that identifies a name of an activity that may be performed and/or continued by a LCEUID (e.g., displaying an incoming message alert); 3) selected UI capabilities that identify capabilities of a LCEUID that are selected to be used in representing and/or displaying the user's primary device's UI; 4) primary content and/or information to be any of: adapted, represented, and displayed in the LCEUID; and 5) secondary content and/or information to be any of: adapted, represented, and displayed in the LCEUID.

According to embodiments, a UI transfer acceptance message may include an activity ID that uniquely identifies any of a UI transfer action and a UI transfer request that may be associated with the UI transfer action.

According to embodiments, a terminate UI transfer request message may include an activity ID that uniquely identifies any of a UI transfer action and a UI transfer request that is to be terminated. According to certain embodiments, a cancel UI transfer request message may include an activity ID that uniquely identifies any of a UI transfer action and a UI transfer request that is to be terminated. According to certain embodiments, the activity ID may be used to determine a UI transfer request. A UI transfer request may correspond to a specific activity ID from among a plurality of activity IDs, and a plurality of activity IDs may correspond to different UI transfer requests for a same LCEUID.

According to embodiments, a UI transfer notification may have any of the following properties and elements: 1) an activity ID that uniquely identifies one or more of an accepted UI transfer request and a terminated UI transfer request; 2) a UI ID that uniquely identifies a LCEUID; 3) a UI name that indicates a name of a LCEUID; and 4) a UI transfer state indicating a state of the LCEUID with respect to a UI transfer (e.g., a result of the UI transfer that indicates whether a user accepted or rejected transferring of a UI to the LCEUID).

According to embodiments, an update UI message may include one or more UI update commands. According to certain embodiments, a UI update command may define commands that need to be executed by an interaction management module to insert UI representations (e.g., to display a UI), on a LCEUID. According to certain embodiments, the content of a command included as a UI update command may be based on rendering and control capabilities of the LCEUID. For example, in a case of an advanced capability UI device, the update UI command may define that “Show Text (Your Amazon delivery has been shipped)” and “Show Icon (Closelcon)” need to be executed (e.g., displayed), in order to update a UI (e.g., for new content). According to certain embodiments, a UI update command may define a pixel by pixel representation (e.g., a representation of an entire display) that may be displayed by a LCEUID.

According to embodiments, an input event message may have any of the following properties and elements: 1) an input name that identifies a source (e.g., an input included in a UI) of the input event (e.g., an input name may identify a specific source and/or input, such as “Open Message Icon”, and/or may identify a generic and/or input, such as “touch screen”); and 2) an event type that identifies a type of the input event (e.g., a specific event like “icon touched event” or a generic event like “touch event”) which may include further information (e.g., coordinates associated with any of the touch and a type of the event, such as “touch start” or “touch end” in a case of a touch and drag user input and/or a multi-touch user input).

According to embodiments, in a case where a projector is used as the UI device, the projector may provide either only output capabilities or both input and output capabilities. In such a case, multiple UI devices and/or multiple Interaction managers may be involved in messaging user interaction events, such as UpdateUI, and InputEvent, between an application module and UI devices.

According to embodiments, a smart space management module (e.g., smart space management module 630) may be provided as a cloud service (e.g., as an element, service, feature, and/or device provided via a cloud service). In such a case, a LCEUID may be assigned an address of the cloud service. For example, the address may be assigned by preprogramming the service address and user credentials into the device (e.g., at a store upon purchasing the LCEUID), and/or during setup via an external device in the same cloud service, the same smart space, and/or the same network. According to certain embodiments, the external device may be any of the user's primary device, a server, a personal computer (PC), and/or any other similar and/or suitable device.

According to embodiments, a smart space management module may reside (e.g., included in) a home gateway device. In such a case, the home gateway device may be any and/or a combination of a dedicated smart space management device and an intelligent router that can run applications. Also, in such a case, discovery and configuration of LCEUIDs may be performed according to universal plug and play (UPnP), and/or any suitable and/or similar protocol, method and/or procedure.

According to certain embodiments, a smart space management module may be included in and/or may be a network component that serves one or more clients. In such a case, the network component may reside on and/or be connected to a cellular base station (e.g., an eNodeB of a long term evolution (LTE) cellular network, a base station of a fifth generation (5 G) cellular network) and/or any other similar and/or suitable network component. Also, in such a case, discovery and configuration of a LCEUID may be done via a network interface (e.g., via air interface protocols and/or wired interface protocols).

According to embodiments, a smart space management module may reside on an electronic device (e.g., a home PC, a media PC, a laptop, a smart phone, a tablet, or any other similar and/or suitable electronic device). In such a case, the electronic device may run (e.g., execute) dedicated smart space management applications. According to certain embodiments, the electronic device may execute dedicated smart space management applications partly through connected gateways. In such a case, discovery and configuration of LCEUIDs may be performed according to Bluetooth (BT) device discovery, universal plug and play (UPnP), and/or any suitable and/or similar protocol, method and/or procedure.

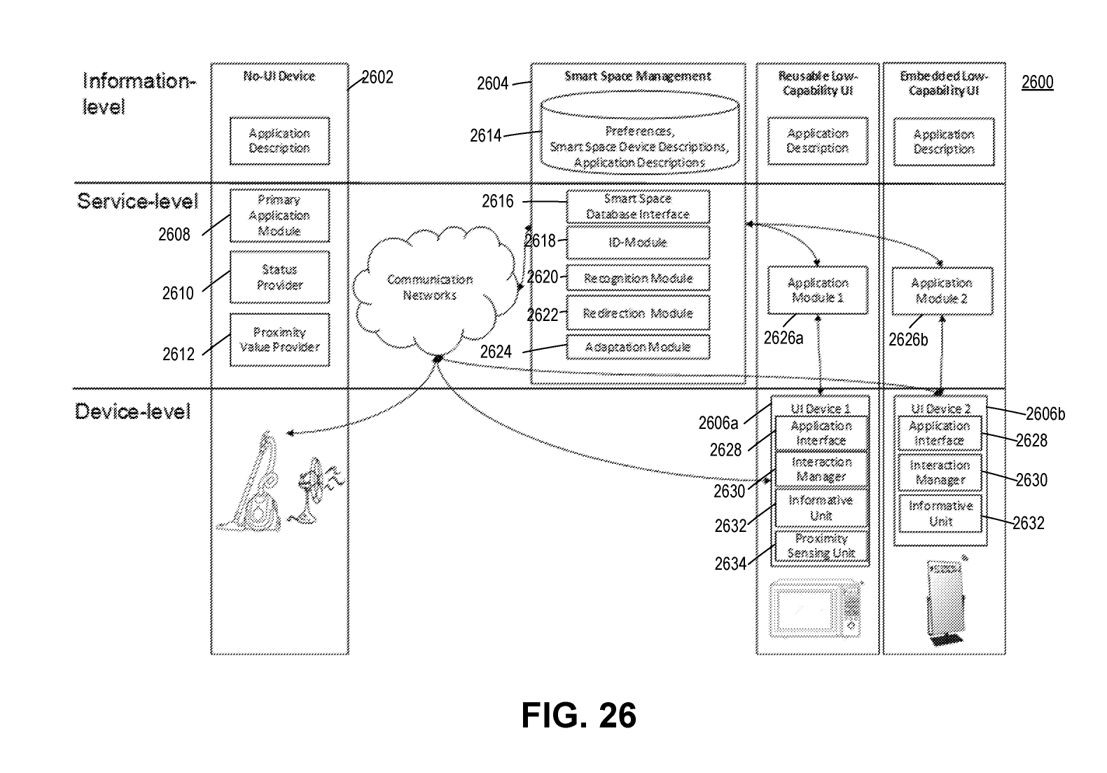

FIG. 26 illustrates an example smart space environment according to embodiments.

Referring to FIG. 26, example environment 2600 may provide a smart space environment in which embodiments can be practiced or implemented. Example environment 2600 is provided for the purpose of illustration only and is not limiting of embodiments of the present disclosure. According to certain embodiments, elements, features, operations, apparatuses, and devices illustrated and/or described with respect to the smart space 600 (see FIG. 6) may be included and/or combined with, in whole or in part, that which is illustrated and/or described with respect to the example environment 2600.

According to embodiments, example environment 2600 may include a no-User Interface (UI) device 2602, a smart space management server 2604, and a plurality of UI devices 2606a and 2606b. As would be understood by a person of skill in the art based on the teachings herein, in other embodiments, example environment 2600 may include more or fewer elements, including more than one no-UI device, more than one smart space management server, and more or fewer UI devices. Entities within example smart space environment 2600 may communicate with each other or with external entities using any known wireless communication technology, via one or more communication networks.

According to embodiments, no-UI device 2602 may include any device that does not have a UI (e.g., a digital UI) for representing device status information and/or for controlling the device state. According to embodiments, the no-UI device 2602 may be similar to and/or the same a WTRU 102 (see FIG. 2). As would be understood by a person of skill in the art, the no-UI device 2602 may include some, but not all, of the elements of the WTRU 102. For example, a WTRU that does not have UI capabilities (e.g., does not include one or more of the speaker/microphone 124, the keypad 126, and the display/touchpad 128). According to certain embodiments, no-UI device 2602 may include a consumer appliance, such as a vacuum cleaner, a fan, a heater, etc. No-UI device 2602 may include wireless communication capability, such as WiFi, Bluetooth®, etc. According to certain embodiments, no-UI device 2602 may be configured to implement a primary application module 2608, a status provider module 2610, and a proximity value provider module 2612.

According to embodiments, primary application module 2608 may be configured to provide an application for no-UI device 2602. According to certain embodiments, for example, no-UI device 2602 may be a fan and primary application module 2608 may provide the application functionality needed to operate, control, and receive information from the fan. According to certain embodiments, primary application module 2608 may be associated with UI capabilities needed for presenting information and/or controls to a user. According to certain embodiments, the UI capabilities associated with primary application module 2608 may be defined by a primary application description associated with primary application module 2608. The primary application description may be stored in a smart space database (e.g., database 2614 of smart space management server 2604, further described below).

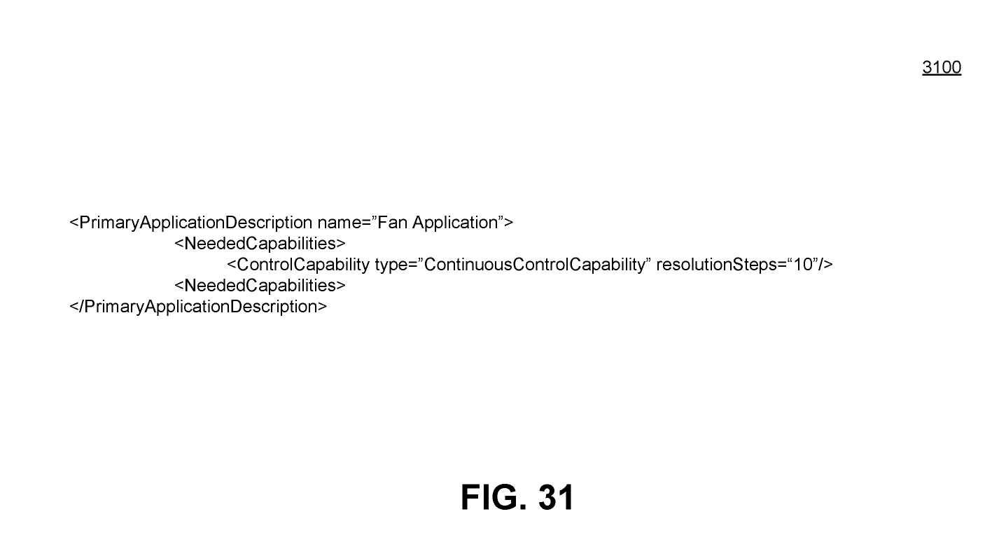

FIG. 31 illustrates an example primary application description associated with a primary application module of a no-UI device according to embodiments.

Referring to FIG. 31, example primary application description 3100 is provided for the purpose of illustration only and is not limiting of embodiments. Example primary application description 3100 may be associated with a fan application module of a no-UI device (e.g., a fan appliance). As shown in FIG. 31, example primary application description 3100 may include a description of needed UI capabilities associated with the fan application module. According to certain embodiments, a description of needed UI capabilities may include a description of minimum control capabilities (e.g., continuous control capability with at least 10 resolution steps) and minimum display capabilities (e.g., display capability of continuous values of at least 10 resolution steps).

Returning to FIG. 26, status provider module 2610 may be configured to maintain various status information regarding no-UI device 2602. According to embodiments, this status information may include device power status, power consumption, etc. According to certain embodiments, status provider module 2610 may be configured to receive and to respond to status information queries from smart space management server 2604.

According to embodiments, proximity value provider module 2612 may be configured to maintain proximity values for no-UI device 2602 with respect to other smart space entities (e.g., smart space management server 2604 and/or UI devices 2606a and 2606b). According to certain embodiments, the proximity values may indicate a measure of proximity of no-UI device 2602 to other smart space entities. According to certain embodiments, the proximity values may include radio frequency (RF)-based proximity values, such as Bluetooth® Low Power (BLE) Proximity Profile (PXP) values, for example.

According to embodiments, smart space management server 2604 may include one or more servers for providing a management service for a smart space. According to certain embodiments, the one or more servers of smart space management server 2604 may each be implemented like a WTRU 102 of FIG. 2. The one or more servers may each include some, but not all, of the elements of the WTRU 102. According to certain embodiments, the one or more servers may be configured to implement any of a smart space database interface 2616, an ID module 2618, a recognition module 2620, a redirection module 2622, and an adaptation module 2624. The one or more servers may be configured to provide application modules (e.g., application modules 2626a and 2626b) to enable provisioning of UIs for no-UI devices (e.g., no-UI device 2602) via UI devices (e.g., UI devices 2606a and 2606b).

According to embodiments, smart space database interface 2616 may be configured to provide an interface between functional modules of smart space management server 2604 and a database 2614 of smart space management server 2604. According to certain embodiments, database 2614 may include any of application descriptions of applications provided in the smart space environment, preferences associated with user devices/entities of the smart space environment, and device descriptions of devices within the smart space environment.

According to embodiments, ID module 2618 may be configured to maintain identities of devices connected to the smart space managed by smart space management server 2604. According to certain embodiments, the ID module 2618 may maintain (e.g., for each device) an identifier that uniquely identifies the device, a description of the device (e.g., description of capabilities of the device), and/or user preferences associated with the device.

According to embodiments, recognition module 2620 may be configured to detect various use-situations within the smart space. For example, recognition module 2620 may be configured to determine when UI provisioning and adaptation is needed and to select one or more UI devices for enabling the UI provisioning. According to certain embodiments, recognition module 2620 may use proximity values (e.g., retrieved from the no-UI device and/or other smart space entities equipped with proximity sensing units, such as proximity sensing unit 2634 in UI device 2606a) and/or UI device categorization information to select the one or more UI devices.

According to embodiments, the proximity values (e.g., as described above) may indicate measures of proximity between smart space entities. According to certain embodiments, the proximity values may include proximity measures between smart space management server 2604 and other entities (e.g., no-UI device 2602, UI device 2606a, etc.) and/or proximity measures amongst the other entities (e.g., between no-UI device 2602 and UI device 2606a). Any type of proximity measures may be used by smart space management server 2604 to infer proximity between no-UI device 2602 and other smart space entities.

According to embodiments, the UI device categorization information may include UI device information that may be relevant in selecting one or more UI devices used for UI provisioning. For example, the UI device categorization information may include whether a UI device is an LCEUID or a reusable LCEUID (which may affect the UI device capabilities' for example). According to certain embodiments, the UI device categorization information may categorize UI devices by their ability to display only or both display and present controls. According to certain embodiments, the UI device categorization information may categorize UI devices by type of installation, e.g., horizontal or vertical. For example, UI devices installed into horizontal surfaces may be more suitable to receive user input for control purposes, and UI devices installed into vertical surfaces may be more suitable for displaying information.

According to embodiments, redirection module 2622 may be configured to redirect user information received from no-UI devices to alternative UI devices and/or to redirect control information received from alternative UI devices to the appropriate no-UI devices. For example, redirection module 2622 may be configured to re-direct messages from no-UI devices, such as no-UI device 2602, to the appropriate UI devices, such as UI devices 2606a and 2606b, and vice versa.

According to certain embodiments, adaptation module 2624 may be configured to generate UI adaptation parameters to enable UI provisioning for a no-UI device. According to certain embodiments, upon selecting one or more UI devices for UI provisioning, recognition module 2620 may request UI adaptation parameters from adaptation module 2624. The UI adaptation parameters may be based on user preferences stored in database 2614. For example, the user preferences may include that the user prefers bigger font size or that sound effects be used to present information. According to certain embodiments, the UI adaptation parameters are forwarded to a selected UI device upon initiating of UI provisioning via the UI device.

According to embodiments, UI provisioning via a UI device may be enabled using an application module associated with the UI device (e.g., application modules 2626a and 2626b). According to certain embodiments, the application module may interact with an interaction manager 2630 (via an application interface 2628) of the UI device and redirection module 2622 of smart space management server 2604 to enable the UI provisioning.

According to embodiments, the application module may reside in a smart space entity (e.g., smart space management server 2604). By providing the application module outside the UI device, the UI device may be implemented with reduced embedded code, allowing for low capability UI devices as further described below. According to certain embodiments, the UI device may be reused for different kinds of applications since the application logic is not integrated into the UI device. Reuse of the UI device may enable third party developers to develop application modules for existing UI devices to support various applications. According to certain embodiments, the application module can be implemented on the UI device.

According to embodiments, the application module may receive user information (e.g., device status information) associated with a no-UI device from smart space management server 2604. According to certain embodiments, the application module may send a message to interaction manager 2630 including commands that need to be executed by interaction manager 2630 to produce a UI representation for the user information in the UI device. According to certain embodiments, interaction manager 2630 may execute the commands to generate control instructions for an informative unit 2632 of the UI device. Informative unit 2632 may process the control instructions to produce the UI representation for the user information in the UI device. According to certain embodiments, the application module may receive from interaction manager 2630 information representative of user input received by the UI device and may forward this received information to smart space management server 2604.

According to embodiments, the application module may augment and/or process the received user information before commanding interaction manager 2630 to render the user information. For example, in a case of an oven application, instead of displaying only a current temperature reported by an oven, the application module may use the reported temperature to estimate the time needed for the oven to reach a set temperature and/or a time needed for cooking an item in the oven, and may further display such time information on the UI device.

According to embodiments, UI provisioning via the UI device may be terminated by the user or smart space management server 2604. However, the present disclosure is not limited thereto, and UI provisioning may be terminated in a smart space by any suitable method and/or smart space device. According to certain embodiments, the user may terminate the UI provisioning using the no-UI device or the UI device. According to certain embodiments, termination by smart space management server 2604 may be in response to detecting an event at the no-UI device or the UI device. For example, smart space management server 2604 may detect that communication with the no-UI device or the UI device has been lost (e.g., due to the no-UI device or the UI device shutting down). According to certain embodiments, smart space management server 2604 may detect that UI provisioning is not (e.g., is no longer) needed. In such a case, smart space management server 2604 may terminate the UI provisioning with or without prompting the user for input.

Returning to FIG. 26, according to certain embodiments, UI device 2606a may be a reusable LCEUID (RLCEUID) and UI device 2606b may be a LCEUID. According to embodiments, a LCEUID may be a device characterized by low power consumption, low display resolution, limited performance display (e.g., limited number of colors), limited processing power, limited memory capacity, and/or limited input/output (I/O) capabilities. A LCEUID may have a flexible, bendable, or formable mechanical structure and may be embedded within a physical object or structure, including a wall, wallpaper, a table surface, a sofa surface, a carpet, a mirror, etc. A reusable low capability UI device is a device with a reusable UI that allows the UI to be re-purposed as desired by the smart space management server (e.g., to serve as a UI for other devices).

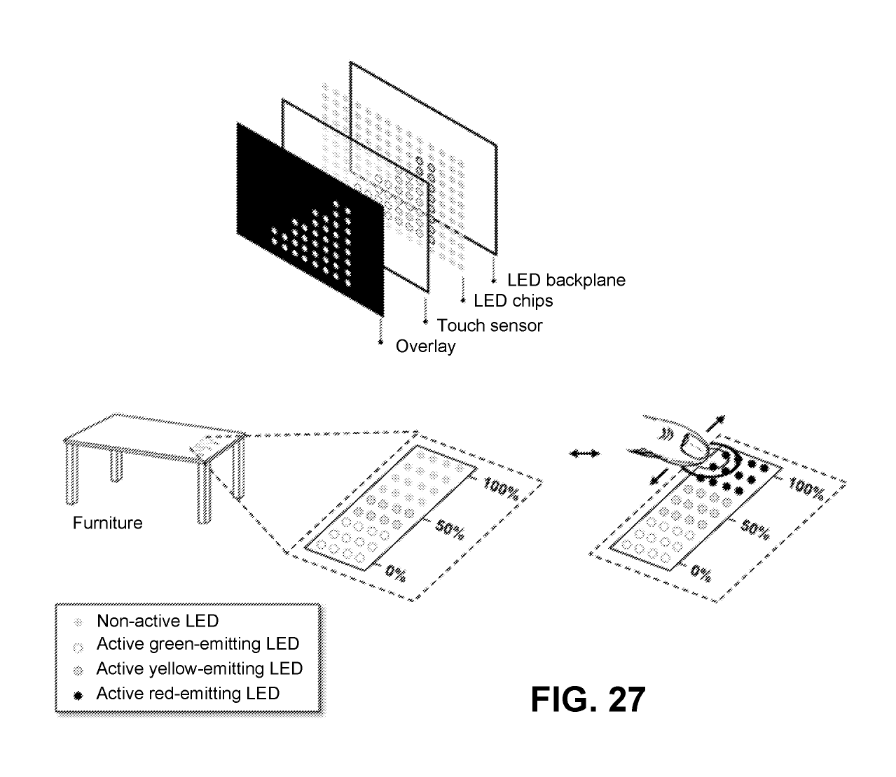

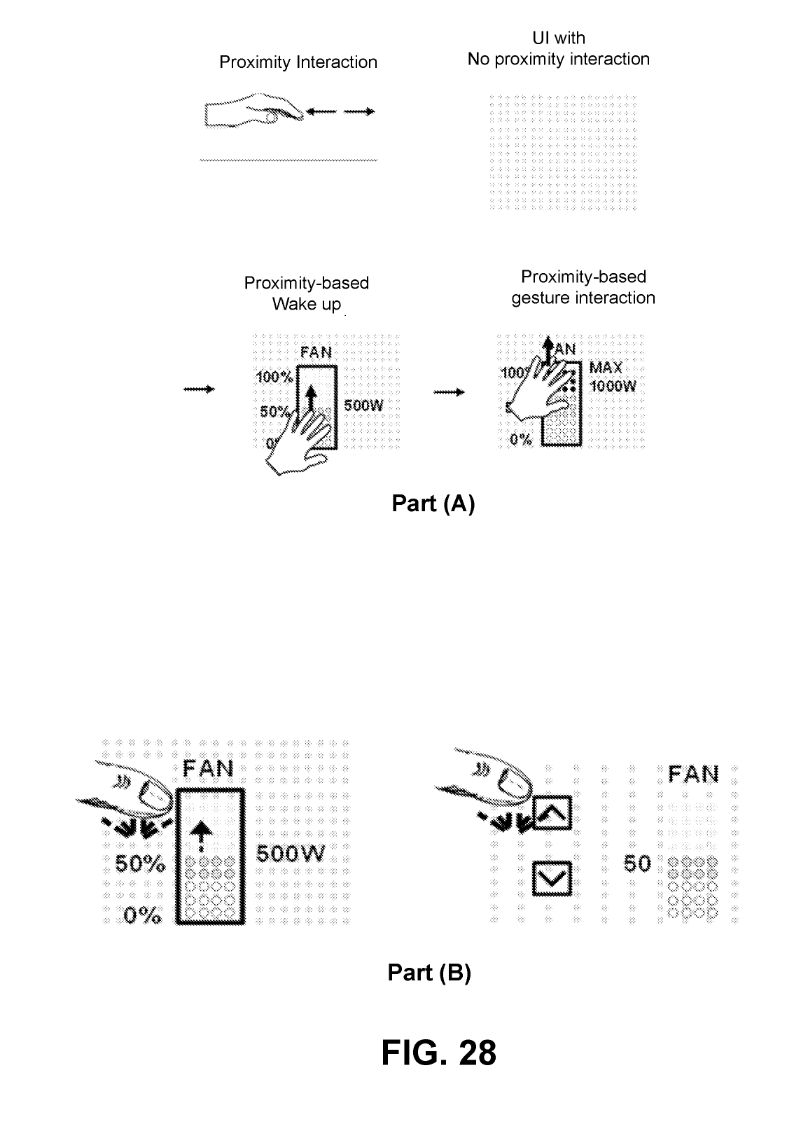

FIG. 27 illustrates example visual representations and multimodal interaction controls that can be generated according to embodiments.

Referring to FIG. 27, these examples are provided for the purpose of illustration only and are not limiting of embodiments. As shown in FIG. 27, in an example, an output unit (e.g., output unit 703) may be controlled to generate a visual image illustrating a duty cycle controller (e.g., for controlling an appliance). According to certain embodiments, the output unit may be associated with a UI device embedded within a table (table UI device), for example. According to certain embodiments, an associated touch input unit (e.g., input unit 701) may provide interaction (e.g., touch or proximity) controls for using the illustrated duty cycle controller.

According to embodiments, layered sensing components for any of haptic feedback, touch control, and/or proximity-based gesture control may be used to implement additional multimodal input/output properties and their combinations for various types of LCEUIDs. For example, touch control and visual feedback may be used for large area UI devices, and proximity sensing and haptic-visual feedback may be used for small area UI devices. According to certain embodiments, different input/output controls may be activated by the user. For example, referring to a table UI device (see FIG. 17), a “press+slide+lift up finger” action may be configured to activate control and visual feedback from the duty cycle controller. However, the present disclosure is not limited thereto, and a “press+slide” action and/or any other similar and/or suitable action may be configured to activate control and haptic-visual feedback from the duty cycle controller.

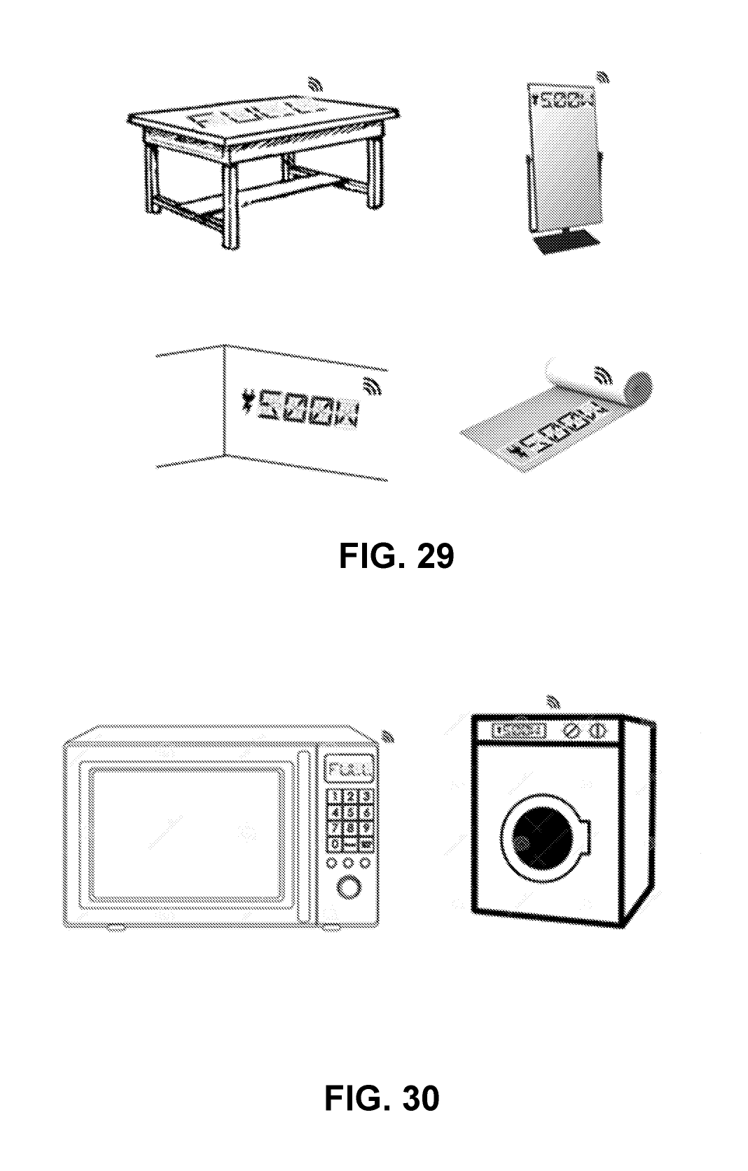

FIG. 29 illustrates examples of proximity control of UI devices according to an embodiment.

Referring to part (A) of FIG. 29, these examples are provided for the purpose of illustration only and are not limiting of embodiments. As shown in part (A) of FIG. 29, according to embodiments, a UI device may be configured for proximity-based control. The UI device may be embedded in a surface, such as a mirror, for example According to certain embodiments, in a case with no proximity interaction detected, the UI device may be in a sleep state and would appear turned off or may be invisible to the user. In such a case, proximity interaction (e.g., by placing or waving the hand above the UI device) may wake the UI device up to present a visual image of a UI (e.g., visual image of a duty cycle controller). According to certain embodiments, control of the UI device may be achieved by specific proximity-based gesture interaction, in response to which visual/haptic feedback may be provided by the UI device. For example, as shown in part (A) of FIG. 29, moving the hand above the presented controller visual image allows the user to increase/decrease the duty cycle of the device (e.g., fan) controlled by the duty cycle controller. The effected change may be displayed visually to the user. According to certain embodiments, when proximity interaction is no longer detected, the UI device may return to the sleep state.

Referring to part (B) of FIG. 29 illustrates examples of haptic output provided by UI devices according to embodiments. These examples are provided for the purpose of illustration only and are not limiting of embodiments. As shown in part (B) of FIG. 29, according to embodiments, in response to touch interaction from a user, the UI device may respond with haptic feedback (e.g., vibration) in the user touch location. According to certain embodiments, the UI device may provide (e.g., visually provide, display, etc.) control buttons with haptic feedback. According to embodiments, control buttons may be in the form of “UP” and “DOWN” arrows that may be used to increase/decrease the duty cycle of the controlled device (e.g., fan). According to certain embodiments, pressing one of the control buttons may cause a change in the duty cycle of the controlled device and the change may be acknowledged with haptic feedback by the UI device (e.g., a vibration which may be sensed by the user's finger). The present disclosure is not limited to examples of controls and/or control buttons described herein, and the controls and/or control buttons may be provided via any similar and/or suitable methods, buttons, icons, alerts, operations (e.g., voice commands, input gestures, circular and/or rotational controls, knob type controls, switch type controls, etc.).

FIG. 30 illustrates example objects in which UI devices may be embedded according to embodiments.

Referring to FIG. 30, as would be understood by a person of skill in the art based on the teachings herein, embodiments are not limited by these example objects and a myriad of other objects may be used to embed UI devices. According to embodiments, as shown in FIG. 30, UI devices may be embedded into furniture items, such as a mirror or a table, walls, carpets, etc. According to certain embodiments, the UI devices may be used to display information to alert the user and/or to accept user control input. For example, a UI device embedded into the kitchen table may alert the user that a dust container of a vacuum cleaner being used is full. According to certain embodiments, the power usage of the vacuum cleaner may be displayed on various embedded UI devices (e.g., mirror embedded UI device, wall embedded UI device, carpet embedded UI device, etc.), as the user uses the vacuum and moves from one area of the house to another.

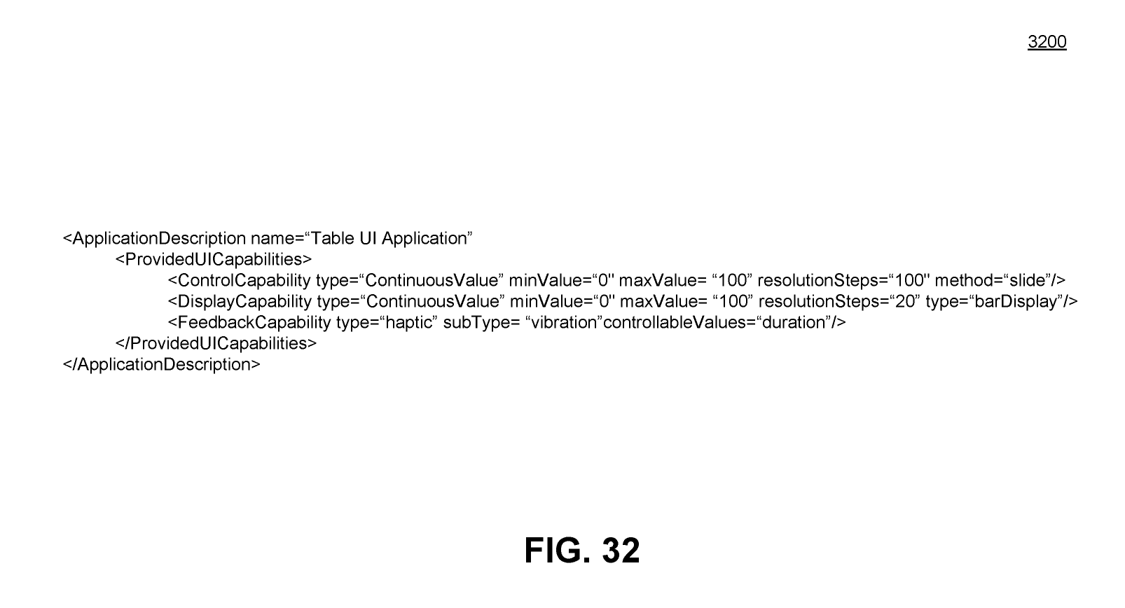

FIG. 32 illustrates example reusable low-capability UI devices according to embodiments.

Referring to FIG. 32, these examples are provided for the purpose of illustration only and are not limiting of embodiments. As described above, a RLCEUID may be a device with a reusable UI that can be re-purposed as desired by the smart space management server (e.g., to serve as a UI for other devices, e.g., no-UI devices). According to certain embodiments, the RLCEUID may be a home appliance (e.g., an oven, a microwave, a clock, a dish washer, a laundry machine, etc.).

According to embodiments, a RLCEUID may include capability to output information to a user. According to certain embodiments, the RLCEUID may have a low resolution display, such as a Liquid Crystal Display (LCD), capable of providing limited color graphical representation of information and/or a speaker capable of providing alarm beeps and/or playing audio information to the user. According to embodiments, a RLCEUID may include capability to interact with a smart space. According to certain embodiments, the RLCEUID may include wireless communication capability (e.g., BLE, WiFi, etc.) that allows the RLCEUID to interact with a smart space management server and/or other smart space entities. According to certain embodiments, the smart space management server may reuse any UI provided by a RLCEUID. For example, as shown in FIG. 32, a reusable UI provided by a microwave oven may be used to display that a dust container of a vacuum cleaner being used is full. In another example, a reusable UI provided by a laundry machine may be used to display the power usage of the vacuum cleaner.

FIG. 32 illustrates an example application description associated with an application provided by a UI device according to embodiments.

Referring to FIG. 32, an example application description 3200 associated with an application provided by a UI device is illustrated for the purpose of illustration. Example application description 3200 describes provided UI capabilities of a Table UI application provided by a table embedded UI device. As shown in FIG. 32, the provided UI capabilities may include a description of control capabilities (e.g., type, resolution), a description of display capabilities (e.g., type, resolution), and a description of feedback capabilities (e.g., haptic, vibration, duration).

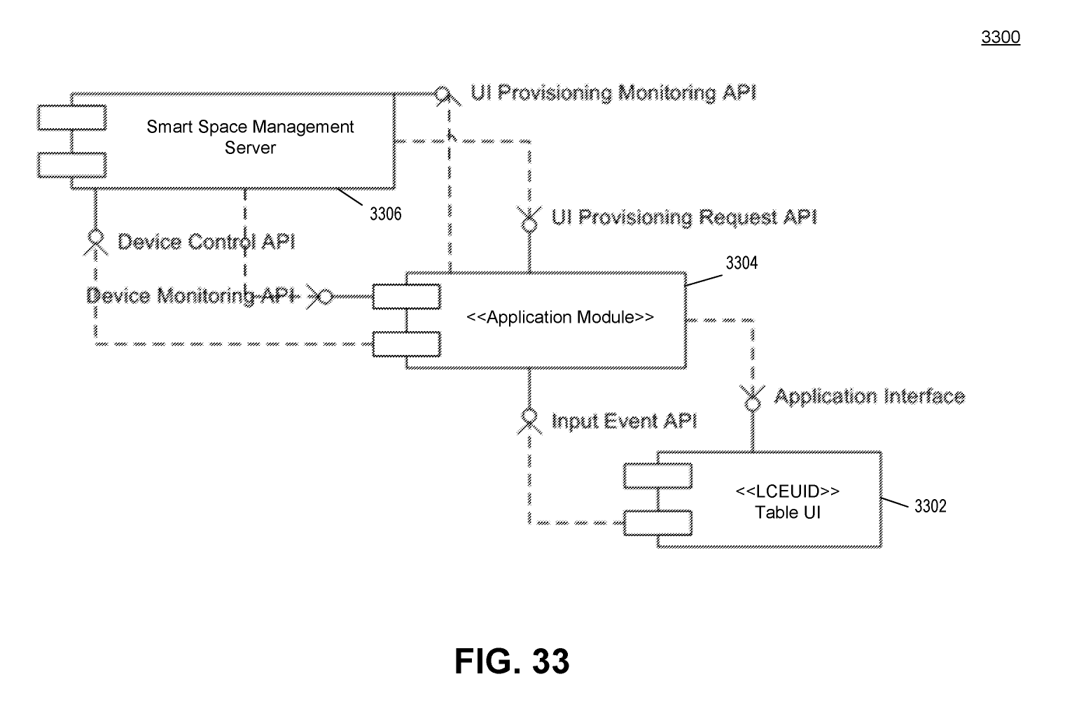

FIG. 33 is an example illustrating UI provisioning via a LCEUID for a no-UI device according to embodiments.

Referring to FIG. 33, example 3300 is provided for the purpose of illustration only and is not limiting of embodiments. As shown in FIG. 33, example 3300 includes a LCEUID 3302, an application module 3304, and a smart space management server 3306. For the purpose of illustration, LCEUID 3302 may be a table embedded UI device that provides a Table UI. In example 3300, UI device 3302 may be used to provide a UI for no-UI device (e.g., fan appliance). According to certain embodiments, prior to or concurrently with the UI provisioning, application descriptions associated with a primary application module of the no-UI device and an application module of UI device 3302 may be provided and stored in smart space management server 3306.

According to embodiments, application module 3304 includes a UI Provisioning Request Application Programming Interface (API) configured to receive a UI provisioning request from smart space management server 3306. For example, the UI provisioning request may include a Fan UI Provisioning Request for provisioning a UI for a fan no-UI device. According to certain embodiments, in response to the UI provisioning request, application module 3304 may activate one or more sub-modules for handling the UI provisioning request. For example, the UI provisioning request may indicate needed UI capabilities such as continuous value control capability and/or continuous value display capability. According to certain embodiments, application module 3304 may activate corresponding sub-modules for providing needed UI capabilities. According to certain embodiments, application module 3304 may forward any content included in a UI provisioning request to activated sub-modules. In a case using the application interface of UI device 3302, application module 3304 may cause the content included in the UI provisioning request and any UI controls (e.g., required UI controls) to be represented by UI device 3302.

According to embodiments, application module 3304 may include an Input Event API for receiving input events produced by UI device 3302. According to certain embodiments, in response to an Input Event, application module 3304 uses a Device Control API of smart space management server 3306 to convey the Input Event to smart space management server 3306. According to certain embodiments, application module 3304 may also use the Input Event API to control the progress of the UI provisioning process. For example, in a case where the user presses a “Close UI” button in UI device 3302, application module 3304 may deliver a “Cancel UI Provisioning Request” to smart space management server 3306.

According to embodiments, application module 3304 may include a Device Monitoring API, for receiving device status events (e.g., of the no-UI device) from smart space management server 3306. According to certain embodiments, in response to a device status event, application module 3304 may control the application interface of UI device 3302 to update the UI (e.g., to display any changed device status). For example, in a case where the user changes the fan's power level via the fan's control buttons, application module 3304 may receive a Device Status Change Event (e.g., indicating the user change) and may cause the change to be shown in UI device 3302 (e.g., via the application interface).

According to embodiments, application module 3304 may implement metadata services by using auxiliary information (e.g., historical data, combination of information from sources beyond the controlled/monitored device) in order to provide more meaningful information of the no-UI device to alternative UIs. An example may include the application monitoring the set and current temperature of an oven (no-UI device), and based on historical data, generating metadata of the estimated time until a set temperature is reached. According to embodiments, metadata may be displayed (e.g., instead of the oven's current and set temperature) on an alternative UI.

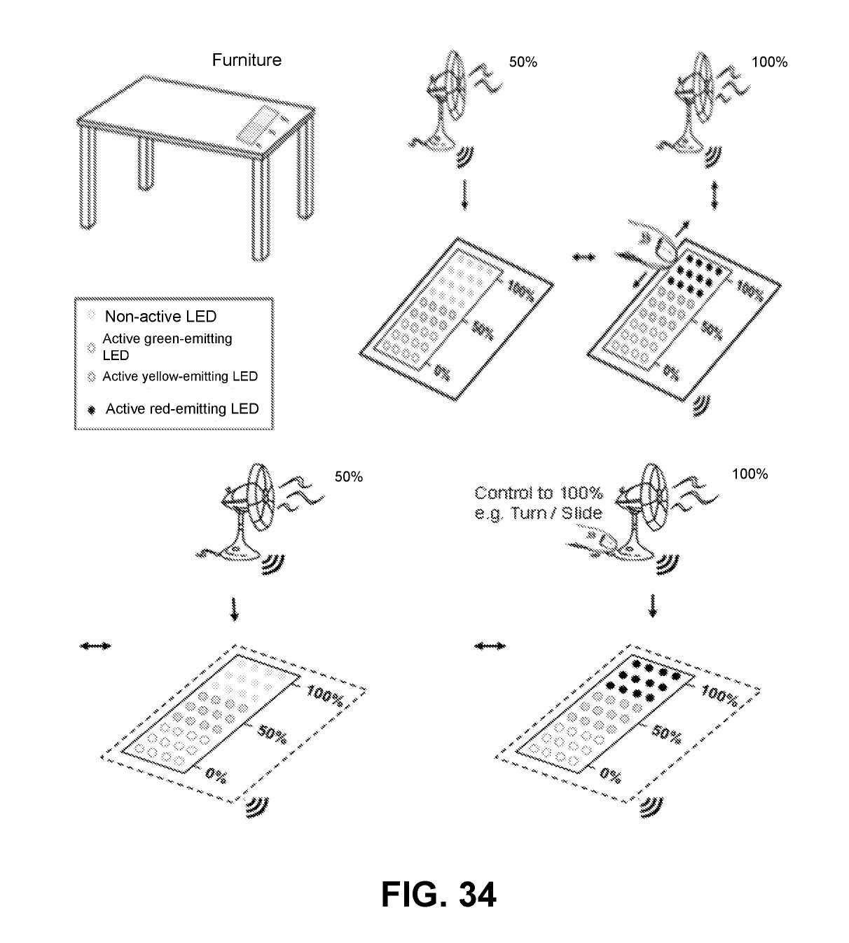

FIG. 34 illustrates an example UI provisioning via an embedded low capability UI device for a no-UI device according to embodiments.

Referring to FIG. 34, the example UI of FIG. 34 is provided for the purpose of illustration only and is not limiting of embodiments. As shown in FIG. 34, the example includes a table embedded UI device providing a UI for a no-UI fan device. According to embodiments, the fan UI may be provisioned and adapted to the representation and control capabilities of the table UI. According to certain embodiments, a UI for the no-UI fan device may be provided on the table embedded UI device. Control of the no-UI fan device may be performed via the table embedded UI device (e.g., by touching and sliding a provided duty cycle controller). According to certain embodiments, the no-UI fan device may be controlled using provided fan control buttons and any status changes are reflected by the table embedded UI.

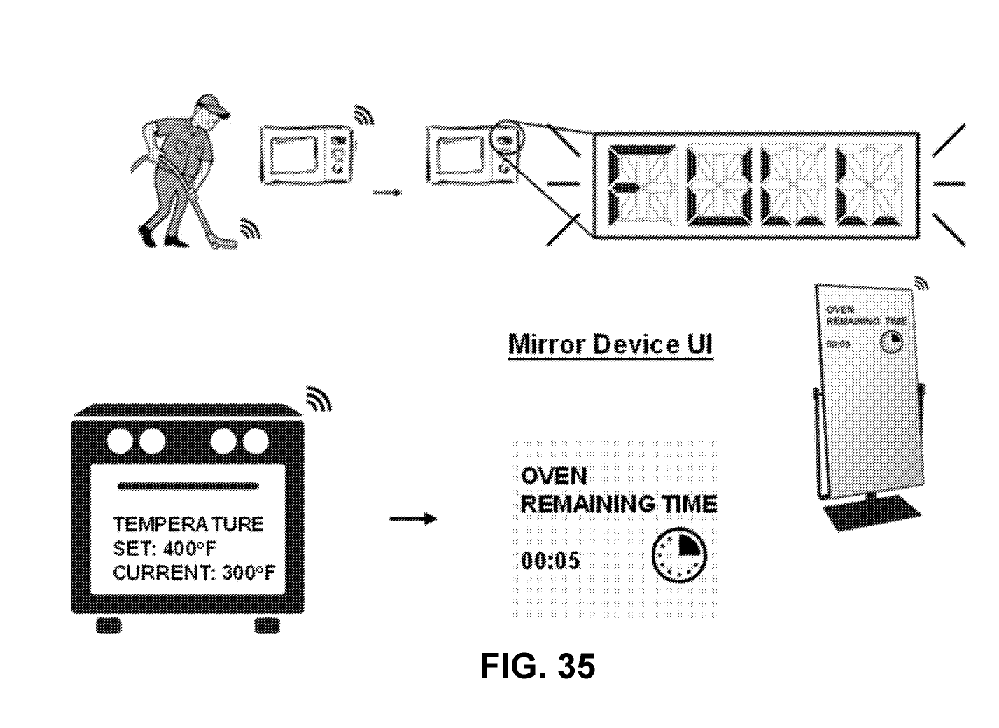

FIG. 35 illustrates further examples of UI provisioning via a low capability UI device for a no-UI device according to embodiments.

Referring to FIG. 35, the examples illustrated are provided for the purpose of illustration only and are not limiting of embodiments. As shown in FIG. 35, in a first example, a UI for a no-UI vacuum cleaner device may be provided via a reusable low capability UI of a microwave oven while the vacuum cleaner is in use. For example, information representing the status of a dust container of the vacuum cleaner may be provisioned to a display of the microwave oven. According to certain embodiments, the provisioning may include adapting the information to the representation capabilities of the microwave oven display. In a second example, a UI for no-UI oven device may be provided via a mirror embedded UI device. According to certain embodiments, the application module enabling the UI provisioning may further augment status information received from the no-UI oven device to provide more meaningful information to the user. For example, in a case where the application module uses the provided current oven temperature and the set temperature to generate an estimate of time needed for the oven to reach the set temperature, the application module may display the time information on the mirror embedded UI device.

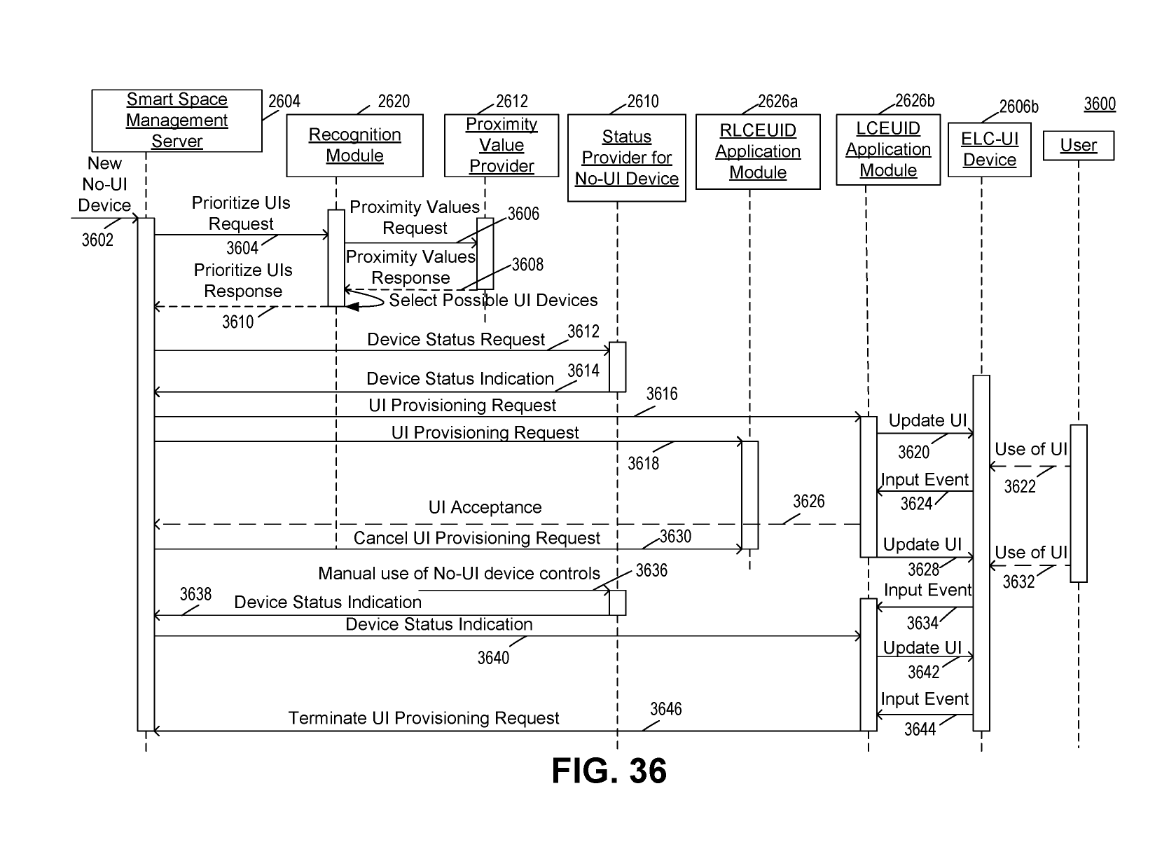

FIG. 36 illustrates an example flow diagram according to embodiments.

Referring to FIG. 36, example flow diagram 3600 is provided for the purpose of illustration only and is not limiting of embodiments. While example flow diagram 3600 is described below with reference to example smart space environment 2600, it is not limited to such a smart space environment. It is also noted that certain modules described herein, which may be located or implemented within particular devices, may be shown separately from their associated devices in FIG. 36 to highlight their respective roles and/or to illustrate internal interactions within the devices. As would be understood by a person of skill in the art, modules enabling the embodiments described herein may be implemented across various entities of the smart space and may be located within different entities than illustrated herein.

According to certain embodiments, prior to execution of flow diagram 3600, LCEUID 2606b and RLCEUID 2606a may connect to smart space management server 2604, which may include smart space management server 2604 identifying and registering UI devices 2606a and 2606b, and receiving and storing their associated capabilities (e.g., application descriptions).

As shown in FIG. 36, flow diagram 3600 may begin at operation 3602, which includes smart space management server 2604 receiving a signal from a new no-UI device (no-UI device 2602). According to certain embodiments, the signal may be generated upon power-up of no-UI device 2602. In response, smart space management server 2604 may identify and register no-UI device 2602. According to embodiments, an application module corresponding to no-UI device 2602 is activated.

At operation 3604, smart space management server 2604 may send a Prioritize UIs Request to recognition module 2620. According to certain embodiments, the Prioritize UIs Request may include a No-UI Application Type field that specifies the type of application that may be used for UI provisioning (e.g., controlling of the no-UI device and/or representation of status information provided by the no-UI device) for no-UI device 2602. According to embodiments, the no-UI Application Type field may include a Uniform Resource Indicator (URI) where the application type information may be located (e.g., http://x.y.z/application#FanControlApplication).

According to embodiments, at operation 3606, in response to the Prioritize UIs Request, recognition module 2620 may send a Proximity Values Request to proximity value provider 2612 of no-UI device 2602. According to embodiments, the Proximity Values Request includes a Proximity Value Count field, which may indicate a maximum number of proximity values to be provided in response to the Proximity Values Request.

According to embodiments, at operation 3608, proximity value provider 2612 may responds by sending a Proximity Values Response to recognition module 2620. According to certain embodiments, the Proximity Values Response may include proximity values of no-UI device 2602 with respect to other entities in the smart space. According to certain embodiments, the proximity values may indicate a measure of proximity of no-UI device 2602 to the other smart space entities. According to embodiments, the proximity values may include RF-based proximity values, such as BLE PXP values.

According to embodiments, upon receiving the Proximity Values Response from proximity value provider 2612, recognition module 2620 may select one or more UI devices that may be used for UI provisioning for no-UI device 2602. According to certain embodiments, recognition module 2620 may use the proximity values to determine one or more closest UI devices to no-UI device 2602. Recognition module 2620 may check application descriptions associated with the determined one or more close (e.g., closest) UI devices to determine which UI devices have sufficient UI capabilities for the UI provisioning for no-UI device 2602. According to certain embodiments, recognition module 2620 may generate a sorted list of UI devices based on suitability for the UI provisioning (e.g., the sorted list may include the best 3 UI devices for the UI provisioning). The sorted list may be based on proximity to the no-UI device and/or available UI capabilities. According to certain embodiments, recognition module 2620 may rely on user preferences to generate the sorted list of UI devices. For example, the user may prefer to use certain UI devices and the system may learn user preferences based on prior user UI selections. According to certain embodiments, there may be preferred no-UI device and UI device pairings. For example, certain types of UI devices may provide optimized UI representations for certain types of no-UI devices. According to certain embodiments, recognition module 2620 may use these preferred pairings in generating the sorted list of UI devices.

According to certain embodiments, at operation 3610, recognition module 2620 sends a Prioritize UIs Response to smart space management server 2604. In an embodiment, the Prioritize UIs Response includes the sorted list of UI devices available for UI provisioning. In the example of FIG. 36, the sorted list of UI devices includes UI devices 2606a and 2606b.

According to embodiments, as changes occur within the smart space environment (e.g., as no-UI device 2602 moves within the smart space environment), operations 3606, 3608, and 3610 may be repeated and may result in a different sorted list of UI devices. Smart space management server 2604 may decide whether to switch an ongoing UI provisioning from one UI device to another UI device more suitable for the UI provisioning (while ensuring that frequent UI device changes do not occur).

According to embodiments, upon receiving the Prioritize UIs response, at operation 3612, smart space management server 2604 sends a Device Status Request to status provider 2610 of no-UI device 2602. According to certain embodiments, the Device Status Request may include a Device Status Type field, which includes a type of device status information (e.g., device power status) being requested. At operation 3614, status provider 2610 may respond with a Device Status Indication to smart space management server 2604. According to certain embodiments, the Device Status Indication may include a textual description of the requested device status information (e.g., “Dust Container 60% full,” “Fan running at 55%, control between 0-100%”).

According to embodiments, at operation 3616 and 3618, smart space management server 2604 may sends UI Provisioning Requests to application modules 2626a and 2626b associated respectively with UI devices 2606a and 2606b. According to certain embodiments, the UI Provisioning Request may include any of a UI provisioning identifier that uniquely identifies the UI provisioning action, a Device Status Description that corresponds to the received Device Status Indication, and UI adaptation parameters. According to certain embodiments, the UI Adaptation Parameters may be based on user preferences stored in database 2614 of smart space management server 2604. For example, the user preferences may include that the user prefers bigger font size or that sound effects be used to present information.

According to embodiments, at operation 3620, in response to the UI provisioning request, application module 2626b may send an Update UI message to UI device 2606b. According to certain embodiments, the Update UI message may cause a UI representation to appear on UI device 2606b. According to certain embodiments, the Update UI message may include commands that need to be executed by interaction manager 2630 of UI device 2606b to produce the UI representation (e.g., “ShowBar50%” or “HapticFeedbackButtonX”).

According to certain embodiments, at operation 3622, the user may interact with UI device 2606b to accept UI provisioning at UI device 2606b, which may cause an Input Event message to be sent from UI device 2606b to application module 2626b at operation 3624. According to certain embodiments, the Input Event message may include an input name that identifies the name of input source of the input event (e.g., “Open Message Icon”) and an event type that indicates the type of the input event (e.g., “Icon Pressed/Released Event,” “Slider SlideHigh Event,” “Slider SlideLow Event,” “Proximity WakeUp,” “GestureSliderUp/Down,” etc.).

According to embodiments, in response to the Input Event message, at operation 3626, application module 2626b may generate and send a UI Acceptance message to smart space management server 2604. According to certain embodiments, there may be a case where the UI Acceptance message includes a unique identifier for the accepted UI provisioning action. In such a case, application module 2626b may send an Update UI message to UI device 2606b at operation 3628, to update the UI in response to the acceptance and to provide control UI representations for controlling no-UI device 2602. In response to the UI acceptance from application module 2626b at operation 3626, smart space management server 2604 may send a Cancel UI Provisioning Request at operation 3630 to application module 2626a. According to certain embodiments, the Cancel UI Provisioning Request may include a unique identifier for the UI provisioning action to be cancelled.

According to embodiments, at operation 3632, the user may interact with UI device 2606b using the provided UI control representations (e.g., a user touches and slides a provided duty cycle controller representation). According to certain embodiments, at operation 3634, UI device 2606b may generate and send an Input Event message to application module 2626b. Application module 2626b may communicate this input event to smart space management server 2604, which in turn communicates the input event to no-UI device 2602 causing the user control to be performed at no-UI device 2602.

According to embodiments, operation 3636 may include manual use of the controls of no-UI device 2602. For example, the user may use provided control buttons of no-UI device 2602 to change the operation mode of no-UI device 2602. According to certain embodiments, at operation 3638, status provider 2610 of no-UI device 2602 may send a Device Status Indication to smart space management server 2604 with updated device status information. At operation 3640, smart space management server 2604 may forward the Device Status Indication to application module 2626b. According to certain embodiments, at operation 3642, application module 2626b may act on the received Device Status Indication by sending a corresponding Update UI message to UI device 2606b. According to embodiments, the Update UI message may update the UI of UI device 2606b to display the updated device status information.

According to embodiments, at operation 3644, UI device 2606b may generate and send an Input Event to application module 2626b to terminate the ongoing UI provisioning. In turn, at operation 3646, application module 2626b may generate and send a Terminate UI Provisioning Request to smart space management server 2604. According to certain embodiments, the Terminate UI Provisioning Request may include a unique identifier that identifies the UI provisioning action to be terminated.

According to certain embodiments (e.g., FIG. 36), UI provisioning termination may be UI device initiated (e.g., due to the UI device starting to be used for its primary usage). For example, a microwave oven providing a UI for a vacuum cleaner may terminate the ongoing UI provisioning (for the vacuum cleaner) in a case where the microwave oven is used for food heating by a user. According to certain embodiments, UI provisioning termination may be initiated by the no-UI device. For example, the no-UI device may be powered off, negating the need for UI provisioning. According to certain embodiments, UI provisioning termination may be user initiated (e.g., by the user requesting termination from the UI device by pressing a reject/cancel button to reject or cancel UI provisioning). According to certain embodiments, user initiated UI provisioning cancellation from one UI device may result in UI provisioning activities being cancelled in all other UI devices (e.g., other UI devices for which UI Provisioning Requests have been sent). According to certain embodiments, UI provisioning termination may be system initiated. For example, smart space management server 2604 may terminate the UI provisioning to a UI device in a case where the UI device is no longer suitable for UI provisioning (e.g., due to the no-UI device no longer being in proximity to the UI device). According to certain embodiments, smart space management server 2604 may terminate the UI provisioning in a case where the UI provisioning is not accepted after a predefined UI provisioning timeout.

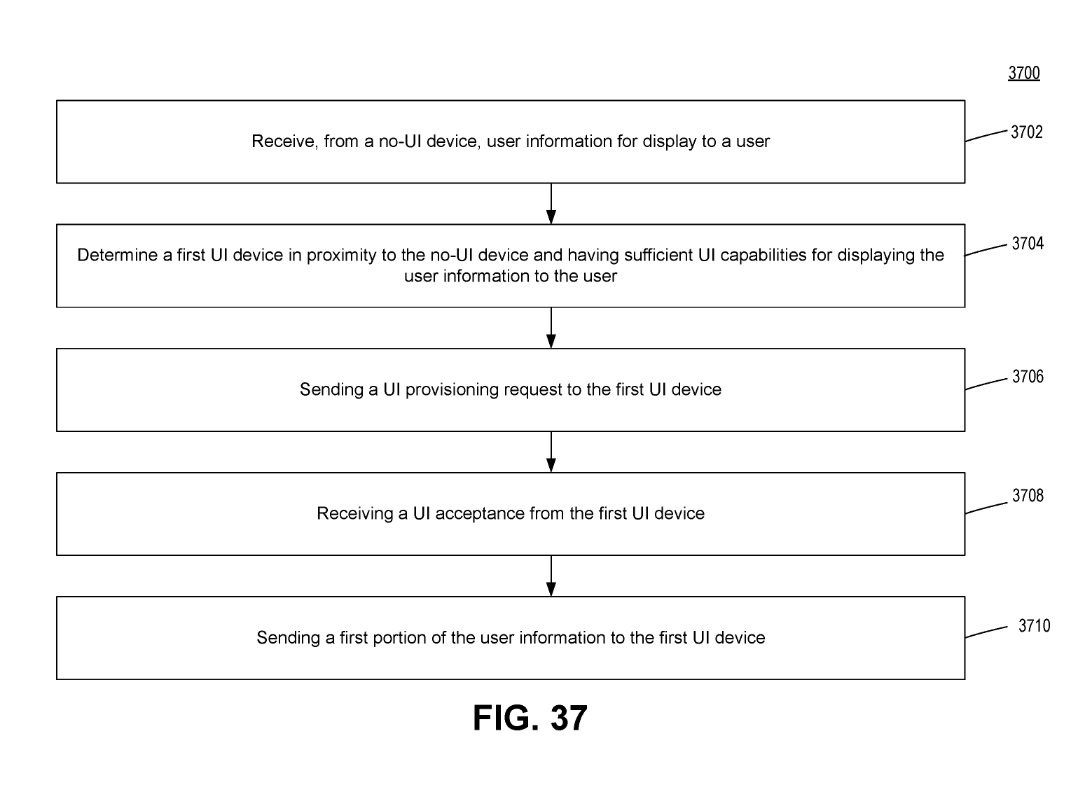

FIG. 37 illustrates an example process according to embodiments.

Referring to FIG. 37, example process 3700 is provided for the purpose of illustration only and is not limiting of embodiments. Example process 3700 may be performed by a smart space management server, such as smart space management server 2604. As shown in FIG. 37, example process 3700 may begin at operation 3702, which may include receiving, from a no-UI device, user information for display to a user. According to certain embodiments, the user information may be received from the no-UI in response to querying the no-UI device for device status information.

According to embodiments, operation 3704 may include determining a first UI device in proximity to the no-UI device and having sufficient UI capabilities for displaying the user information to the user. According to certain embodiments, operation 3704 may include querying the no-UI device for proximity values associated with a plurality of UI devices in proximity to the no-UI device, and may include selecting one or more of the plurality of UI devices based on the proximity values. The proximity values may be based on RF-based proximity sensing of the plurality of UI devices by the no-UI device. According to certain embodiments, operation 3704 may include selecting the one or more of the plurality of UI devices based on minimum UI capabilities associated with an application module associated with the no-UI device. According to certain embodiments, operation 3704 may further include generating a list of UI devices sorted based on proximity to the no-UI device and associated UI capabilities.

According to embodiments, operation 3706 may include sending a UI provisioning request to the first UI device. According to certain embodiments, operation 3706 may further include sending content representative of the user information to an application module associated with the first UI device. According to embodiments, operation 3708 may include receiving a UI acceptance from the first UI device. According to certain embodiments, the UI acceptance may be triggered by user interaction with the first UI device. The user interaction may indicate a user's desire to interact with the no-UI device via the first UI device.

Example process 3700 may terminate at operation 3710, which includes sending a first portion of the user information to the first UI device. According to embodiments, the first portion of the user information may correspond to the entirety of the user information. According to certain embodiments, the first portion may correspond to less than the entirety of the user information. According to embodiments, example process 3700 may include determining a second UI device (e.g., in proximity to the no-UI device and having sufficient UI capabilities for displaying the user information to the user), and may include sending a second portion of the user information to the second UI device. According to certain embodiments, process 3700 may include, instead of operation 3706 and 3708, any of operations for sending a UI provisioning request to each of the first UI device and second UI device, receiving a UI acceptance from the first UI device, and sending a UI provisioning request cancellation to the second UI device.

In the following, example scenarios in which embodiments may be practiced or implemented are provided. As would be understood by a person of skill in the art based on the teachings herein, embodiments are not limited by these examples. In a first example, a user may be using a no-UI device vacuum cleaner in the kitchen and living room area. As the user moves around the area, a kitchen tabletop or living room wall may display the current power consumption of the vacuum cleaner. When the user moves to the hall area, a mirror in the hall area displays the current status of the dust container of the vacuum cleaner. In a second example, a user powers on a no-UI device fan. A nearby table displays a slider bar indicating that the fan is running at 50% power. The user uses the slider bar on the table to increase the power to 80%. The fan responds by increasing its power to 80%. In a third example, a user may be using a cleaning robot to clean the living area floors. As the cleaning robot enters the family sitting area, the living room table displays a power switch for the robot. The user may use the power switch on the table to turn off the robot.

Embodiments of the present disclosure, as further described below, include systems and methods for system-initiated provisioning of alternate display devices based on device power state. In a smart space environment, embodiments may be used to enable a power saving feature that can suggest to a user the use of available alternate display devices instead of the user's primary user device when appropriate. In an embodiment, the power saving feature operates based on predicting battery usage in the user device, e.g., by querying and combining information about the user and the user device (e.g., usage history, future calendar events, travel itineraries, current battery status, etc.). In another embodiment, the alternate display device(s) suggested to a user are determined by considering proximity to the user or the user device and their capabilities. In one embodiment, the alternate display devices may be low-capability embedded user interface (UI) devices.

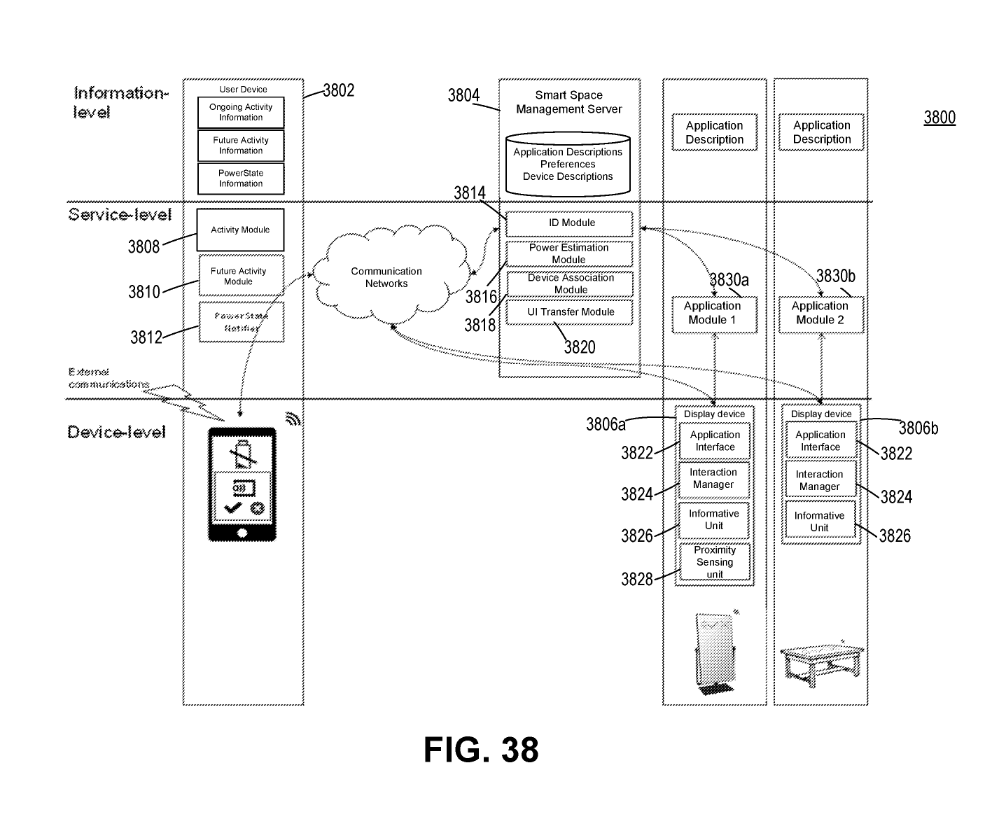

FIG. 38 illustrates an example smart space environment according to embodiments.

Example environment 3800 is provided for the purpose of illustration only and is not limiting of embodiments of the present disclosure. As shown in FIG. 38, example environment 3800 includes a user device 3802, a smart space management server 3804, and a plurality of display devices 3806a and 3806b. As would be understood by a person of skill in the art based on the teachings herein, in other embodiments, example environment 3800 may include more or fewer elements, including more than one user device, more than one smart space management server, and more or fewer display devices. Entities within example smart space environment 3800 may communicate with each other or with external entities using any known wireless communication technology, via one or more communication networks.

According to embodiments, user device 3802 may include any known mobile user device with wireless communication capability. According to certain embodiments, user device 3802 may include a user equipment (UE), a mobile station, a mobile subscriber unit, a pager, a cellular telephone, a personal digital assistant (PDA), a smartphone, a tablet, a laptop, a netbook, a wireless sensor, consumer electronics, and the like. According to certain embodiments, user device 3802 may include multi-mode capabilities, including multiple transceivers for communicating with different wireless networks over different wireless links. For example, user device 3802 may be configured to communicate (e.g., using a cellular-based radio technology and/or using an IEEE 802.11 radio technology) with a base station (not shown in FIG. 38) and/or with smart space management server 3804.

According to embodiments, user device 3802 may be configured to implement an activity module 3808, a future activity module 3810, and a power state notifier module 3812. Activity module 3808 may maintain information regarding ongoing user activity on user device 3802. According to certain embodiments, the information regarding ongoing user activity may include information regarding active application(s) on user device 3802. According to certain embodiments, activity module 3808 maintains information regarding UI capabilities needed to process the ongoing user activity. According to certain embodiments, activity module 3808 may maintain information regarding UI parameters and/or content to be used in transferring the ongoing user activity to an alternate display device. According to certain embodiments, activity module 3808 may provide its maintained information to smart space management server 3804 (e.g., in response to a user activity query from smart space management server 3804 or automatically upon user device 3802 joining the smart space managed by smart space management server 3804).

According to embodiments, future activity module 3810 may maintain information regarding future/anticipated user activity on user device 3802. According to certain embodiments, future activity module 3810 may generate the anticipated user activity based on any of a user's device usage history, calendar events, reminders, travel plans, or any information that can be used to infer future user activity on user device 3802. According to certain embodiments, together with a battery status that indicates the current charge level of a battery of user device 3802, the anticipated user activity may be used to estimate remaining battery life until a next opportunity to recharge and/or to compute a predicted battery usage rate for user device 3802. According to certain embodiments, future activity module 3810 may provide its maintained information to smart space management server 3804 (e.g., in response to a future user activity query from smart space management server 3804 or automatically upon user device 3802 joining the smart space managed by smart space management server 3804).

According to embodiments, power state notifier module 3812 may be configured to monitor charge level changes associated with the battery of user device 3802. According to certain embodiments, power state notifier module 3812 may maintain power state information regarding user device 3802. The power state information may include a battery status that indicates the current charge level of the battery of user device 3802. According to certain embodiments, the battery status may correspond to one of: Very Low, Low, Medium, and High. In addition, the power state information may include a current battery usage rate (e.g., including a per-application current battery usage rate). According to certain embodiments, power state notifier module 3812 may be configured to send a device power state notification to smart server management server 3804. The device power state notification may include the battery status of the battery of user device 3802. According to embodiments, the device power state notification may include the current battery usage rate. According to certain embodiments, power state notifier module 3812 may be configured to send the device power state notification only when the battery status is below a pre-determined level. According to certain embodiments, power state notifier module 3812 may send the device power state notification periodically as long as user device 3802 is connected to the smart space managed by smart space management server 3804. According to certain embodiments, power state notifier module 3812 may send the device power state notification to smart space management server 3804 (e.g., in response to a query from smart space management server 3804).

According to embodiments, a smart space management server 3804 may include one or more servers for providing a management service for a smart space. According to certain embodiments, the one or more servers may be configured to, individually or collectively, implement an identification (ID) module 3814, a power estimation module 3816, a device association module 3818, and a UI transfer module 3820. According to certain embodiments, ID module 3814 may be configured to maintain the identities of user devices connected to the smart space managed by smart space management server 3804. According to embodiments, maintaining identities may include maintaining, for each user device, an identifier that uniquely identifies the user device, a description of the user device (e.g., description of capabilities of the user device), and/or user preferences associated with the user device.

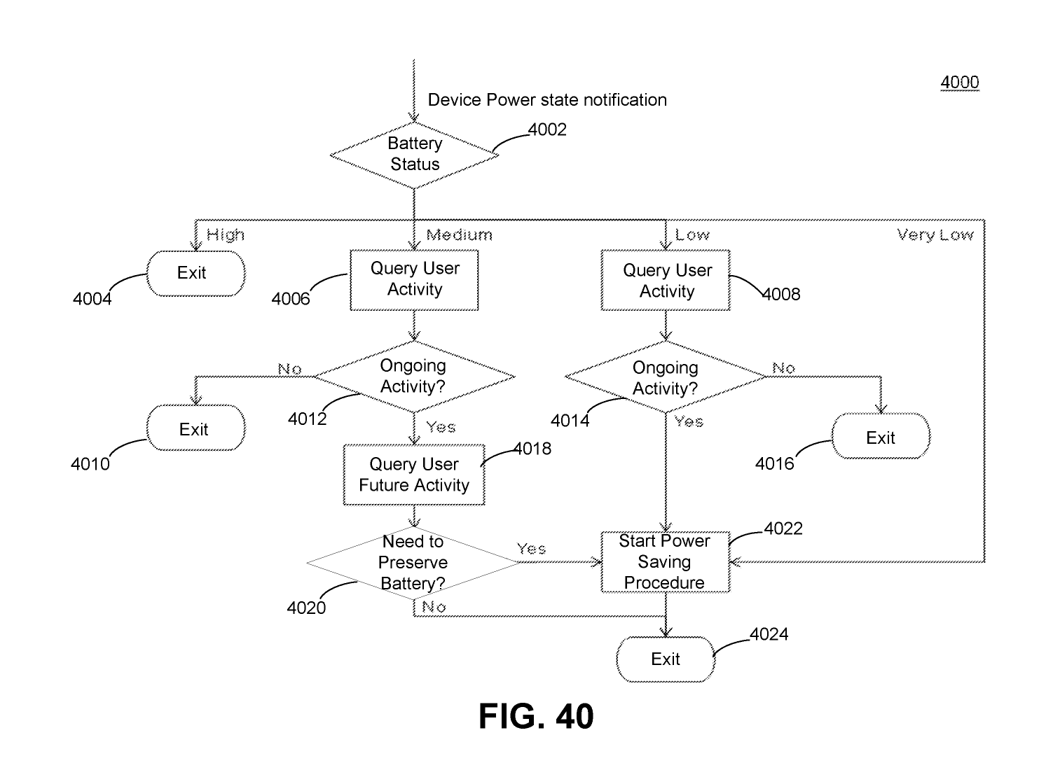

According to embodiments, power estimation module 3816 may be configured to determine whether to propose power saving actions to a user device located in the smart space. According to embodiments, power saving actions may include UI transfer from the user device to an alternate display device. According to certain embodiments, power estimation module 3816 may be triggered by the receipt of a device power state notification (described above) from the user device. According to certain embodiments, power estimation module 3816 may query the user device for information regarding user activity, including ongoing user activity and anticipated user activity on the user device. Additional information (e.g., estimated remaining battery life until next recharge and/or predicted battery usage rate) may be queried from the user device (e.g., when available at the user device). According to certain embodiments, using information contained in the device power state notification, queried information, and/or other information (e.g., user preferences associated with the user device), power estimation module 3816 may determine whether UI transfer from the user device to an alternate display device is appropriate. According to certain embodiments, power estimation module 3816 may make this determination, as further described below with reference to FIG. 40. In a case where UI transfer is determined to be appropriate, power estimation module 3816 may communicate an indication of this determination to UI transfer module 3820.

According to certain embodiments, device association module 3818 may be configured to create, maintain, and update associations between devices located within the smart space (e.g., including associations between user devices, such as user device 3802, and display devices, such as display devices 3806a and 3806b. According to certain embodiments, device association module 3818 may be configured to create, maintain, and update associations based on indications received from devices located within the smart space. For example, a display device (e.g., display device 3806a) may send a proximity indication to device association module 3818 upon detecting user device 3802 within its proximity (e.g., as shown in FIG. 38, display device 3806a may be equipped with a proximity sensing unit 3828 that may detect nearby user devices). According to certain embodiments, device association module 3818 may create an association between display device 3806a and user device 3802. In a case where user device 3802 is not (e.g. no longer) near display device 3806a, display device 3806a may send an indication to device association module 3818 to terminate the association between user device 3802 and display device 3806a. According to certain embodiments, device association module 3818 may terminate the association when it becomes stale (e.g., no interaction detected between user device 3802 and display device 3806a).

According to embodiments, device association module 3818 may be configured to create, maintain, and update associations based on user device initiated actions within the smart space. For example, a user of user device 3802 may interact with a display device (e.g., display device 3806b) and may associate user device 3802 and display device 3806b (e.g., to begin interaction, the user of user device 3802 may first enter a pin code that is associated with user device 3802 into display device 3806b or may pair user device 3802 with display device 3806b). According to certain embodiments, in response to this interaction, user device 3802 and/or display device 3806b may send an indication to device association module 3818 (e.g., to create an association between user device 3802 and display device 3806b). According to certain embodiments, when done interacting with display device 3806b, the user of user device 3802 may send an appropriate indication (e.g., via user device 3802 and/or display device 3806b) to device association module 3818. According to certain embodiments, the indication may terminate the association between user device 3802 and display device 3806b. According to certain embodiments, device association module 3818 may terminate the association in a case where the association is stale (e.g., interaction no longer detected between user device 3802 and display device 3806a).

According to embodiments, proximity indications and/or interaction indications may be sent by the user device instead of display devices. According to certain embodiments, both the user device and display devices may send proximity indications and/or interaction indications.

According to embodiments, UI transfer module 3820 may be configured to enable UI transfer from a user device to a display device (e.g., an alternate display device). According to certain embodiments, UI transfer from a user device to an alternate display device is triggered by a determination by power estimation module 3816 that UI transfer is appropriate for the user device. According to certain embodiments, power estimation module 116 may forwards an indication of its determination to UI transfer module 3820. According to certain embodiments, UI transfer module 3820 may initiate UI transfer from the user device to an alternate display device.

According to certain embodiments, upon receiving the indication from power estimation module 3816, UI transfer module 3820 may make a device association query to device association module 3818 for the user device. Device association module 3818 may return any one or more display devices (e.g., alternate display devices currently associated with the user device). According to certain embodiments, in a case where no display device is available, UI transfer module 3820 may terminate the UI transfer process. In a case where at least one display device (e.g., alternate display device) is associated with the user device, UI transfer module 3820 may determine whether the associated at least one display device is suitable for UI transfer from the user device.

According to embodiments, UI transfer module 3820 may determine whether the associated at least one alternate display device is capable of providing a user interface for user activity associated with the user device. According to certain embodiments, along with an indication, power estimation module 3816 may forward to UI transfer module 3820 the results of any activity queries made to the user device. As described above, activity inquiries may include queries for information regarding ongoing user activity and/or anticipated user activity. Information regarding ongoing user activity may include any of: (1) information regarding active application(s) on the user device; (2) information regarding UI capabilities required to process the ongoing user activity; and (3) information regarding UI parameters and/or content to be used in transferring the ongoing user activity to an alternate display device. According to embodiments, UI transfer module 3820 may use information regarding ongoing user activity to select any of the available associated display devices for the UI transfer from the user device.

According to embodiments, UI transfer module 3820 may send a UI transfer request to any of the display devices (e.g., alternate display devices) determined capable of supporting the UI transfer. According to certain embodiments, UI transfer module 3820 may rank alternate display devices available for the UI transfer, and may send a UI transfer request starting with the highest ranked display device until the UI transfer is accepted or is successful or the list is exhausted without successful UI transfer. According to certain embodiments, UI transfer module 3820 may send a UI transfer request in parallel to each of the identified display devices.

According to embodiments, upon receiving a UI transfer request, a display device may present an audio and/or visual alert to the user of the user device. According to certain embodiments, the user may accept/reject the UI transfer to the display device by using controls provided by the display device or using the user device. For example, the user may accept by selecting (e.g., touching) an accept symbol and reject by selecting (e.g., touching) a reject/cancel symbol provided by the display device. According to certain embodiments, the user may accept/reject via the user device, for example by scrolling through a list of display devices to select/reject a display device for the UI transfer.

According to embodiments, acceptance of the UI transfer to a display device may terminate all pending UI transfer requests to other display devices. According to certain embodiments, rejection of the UI transfer to the display device may be considered as a general rejection of UI transfer by the user, and all pending UI transfer requests to other display devices may be terminated. According to certain embodiments, rejection of UI transfer may terminate (e.g., only terminate) the UI transfer request to the display device and may not affect pending UI transfer requests to other display devices. According to certain embodiments, UI transfer module 3820 may terminates a UI transfer request to a display device by sending a Cancel UI Transfer Request signal to the display device. According to certain embodiments, an alternate display device may terminate a UI transfer request. For example, the alternate display device may implement a time-out period after which it terminates the UI transfer request absent a response from the user.

According to embodiments, in a case where a UI transfer request to a display device is accepted, a UI transfer acceptance signal may be sent to UI transfer module 3820. According to certain embodiments, the UI transfer acceptance may be sent by the user device and/or the display device. According to certain embodiments, UI transfer module 3820 may request that the user device begin delivering information regarding ongoing user activity on the user device (e.g., including content to be used in transferring the ongoing user activity to the display device). As described above, this information may be generated and saved by the user device in an activity module, e.g., activity module 3808.

According to embodiments, UI transfer module 3820 may adapt the content received from the user device based on capabilities of the display device and may send the adapted content to the display device for processing. According to certain embodiments, the adapted content may be provided via an application module for the display device (e.g., application modules 3830a and 3830b for display devices 3806a and 3806b) that interacts with an interaction manager 3824 (e.g., via an application interface 3822) of the display device. According to certain embodiments, an application module (e.g., application modules 3830a and 3830b) may reside in a smart space entity (e.g., smart space management server 3804). In a case of providing the application module outside the display device, the display device may be implemented with reduced embedded code, allowing for LCEUIDs and RLCEUIDs. According to certain embodiments, the application module can be implemented on the display device.

According to embodiments, interaction manager 3824 may receive the adapted content from the application module and may generate control instructions for an informative unit 3826. According to certain embodiments, informative unit 3826 may process the control instructions to produce a UI for presenting the received adapted content. UI transfer from the user device to the display device may be terminated by the user or smart space management server 3804. The user may terminate the UI transfer using the user device or the display device. According to certain embodiments, termination by smart space management server 3804 may be in response to detecting an event at the user device or the display device. For example, smart space management server 3804 may detect that communication with the user device or the display device has been lost (e.g., due to the user device or the display device shutting down). According to certain embodiments, smart space management server 3804 may detect that UI transfer is not (e.g., no longer) needed (e.g., a device power state notification from the user device indicates that the user device has been connected to a power supply). According to certain embodiments, smart space management server 3804 may terminate the UI transfer with or without prompting the user for input.

According to certain embodiments, display device 3806a and/or display device 3806b may be a LCEUID. According to embodiments, a LCEUID may be a device characterized by any of low power consumption, low display resolution, limited performance display (e.g., limited number of colors), limited processing power, limited memory capacity, and limited input/output (I/O) capabilities. According to certain embodiments, a LCEUID may be embedded within a physical object and/or structure, including a wall, wallpaper, a table surface, a sofa surface, a carpet, a mirror, etc.

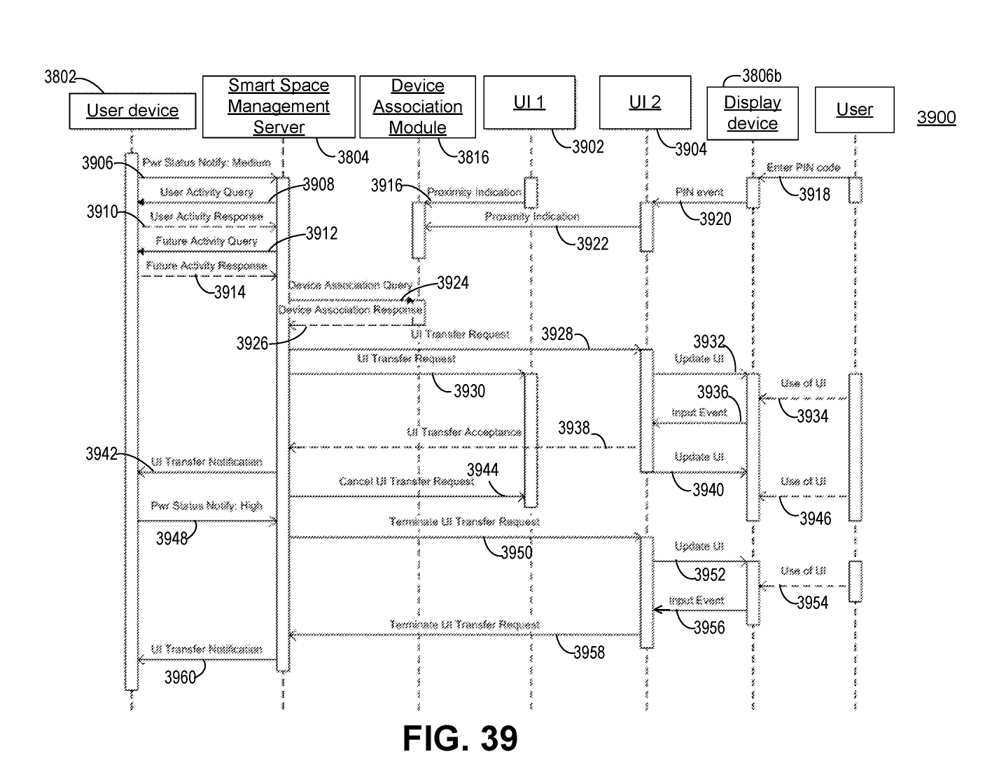

FIG. 39 illustrates an example flow diagram according to embodiments.

Referring to FIG. 39, example flow diagram 3900 is provided for the purpose of illustration only and is not limiting of embodiments. While example flow diagram 3900 is described below with reference to example smart space environment 3800, it is not limited to such a smart space environment. Further, certain modules described herein, which may be located or implemented within particular devices, may be shown separately from their associated devices in FIG. 39 to highlight their respective roles and/or to illustrate internal interactions within the devices. As would be understood by a person of skill in the art, modules enabling the embodiments described herein may be implemented across various entities of the smart space and may be located within different entities than illustrated herein.

As shown in FIG. 39, example flow diagram 3900 may begin at operation 3906, which may include user device 3802 sending a device power state notification to smart space management server 3804. In this example, it is assumed that the device power state notification indicates that the battery status is at a Medium level. For example, the battery status may be at a Medium level when the battery charge is within a pre-defined Medium range.

According to certain embodiments, at operation 3908, smart space management server 3804 may send a user activity query to user device 3802 in response to the device power state notification. At operation 3910, user device 3802 may respond to smart space management server 3804 with a user activity response. According to certain embodiments, the user activity response may include information regarding ongoing user activity on user device 3802. At operation 3912, smart space management server 3804 may send a future activity query to user device 3802. According to certain embodiments, user device 3802 may respond at operation 3914 by sending a future activity response to smart space management server 3804. According to embodiments, the future activity response may include information regarding anticipated user activity (e.g., on user device 3802). According to certain embodiments, the future activity response may include an estimated remaining battery life (e.g., until a next opportunity to recharge, a time until remaining battery charge is empty) and/or a predicted battery usage rate for user device 3802.

According to embodiments, before, after, or concurrently with any of operations 3906, 3908, 3910, 3912, and 3914, any display device (e.g., alternate display devices) in the smart space may send association indications to smart space management server 3804. According to certain embodiments, at operation 3916, a UI 3802 associated with display device 3806a may send a proximity indication to device association module 3818 of smart space management server 3804. The proximity indication may be based on proximity sensing unit 3828 of display device 3806a detecting user device 3802 within proximity.

According to embodiments, at operation 3922, a UI 3904 associated with display device 106b may send a proximity indication to device association module 3818 of smart space management server 3804. In the example of FIG. 39, a proximity indication may be triggered by a user associated with user device 3802 interacting with display device 3806b at operation 3918. According to embodiments, in a case of interacting with display device 3806b by entering an identifying PIN code, a PIN event may being sent to UI 3904 at operation 3920, which may trigger the sending of the proximity indication at operation 3922. As described above, device association module 3818 may use the received indications from display devices 3806a and 3806b to create appropriate associations between display devices 3806a and 3806b and user device 3802.

According to embodiments, the ongoing user activity and/or the anticipated user activity may result in a determination that UI transfer from user device 3802 is appropriate. As described above, this determination may be performed by power estimation module 3816 of smart space management server 3804, and may triggers initiation of UI transfer by UI transfer module 3820. According to embodiments, at operation 3924, smart space management server 3804 may make a device association query to device association module 3818. As described above, this query may be made by UI transfer module 3820 of smart space management server 3804. According to certain embodiments, at operation 3926, device association module 3818 may send a device association response.

According to embodiments, the device association response may identify any of display devices 3806a and 3806b as being associated with user device 3802. According to embodiments, both display devices 3806a and 3806b may be determined capable of providing a UI for ongoing user activity on user device 3802. According to certain embodiments, at operation 3928 and 3930, smart space management server 3804 may send UI transfer requests to each of UIs 3904 and 3902, respectively associated with display devices 3806b and 3806a.

According to certain embodiments, the UI transfer request to UI 3904 may trigger the sending of an update UI event to display device 3806b at operation 3932. According to embodiments, an update UI event may cause an audio and/or visual alert regarding the UI transfer request to be presented to the user. According to certain embodiments, at operation 3934, the user may interact with display device 3906b to accept the UI transfer. According to certain embodiments, at operation 3936, an input event may be forwarded to UI 3904, and a UI transfer acceptance may be sent from UI 3904 to smart space management server 3804 at operation 3938. At operation 3940, UI 3904 may send an Update UI event to display device 3806b. According to certain embodiments, at operation 3946, the user may use (e.g., begin using) display device 3806b.

According to certain embodiments, in response to the UI transfer acceptance at operation 3938, smart space management server 3804 may send a UI Transfer Notification signal to user device 3802 at operation 3939, and a Cancel UI Transfer Request signal to UI 3902 associated with display device 3806a at operation 3944.

According to certain embodiments, at operation 3948, smart space management server 3804 may receive another device power state notification from user device 3802. It is assumed in this example that the device power state notification now indicates that the battery status is at a High level. For example, the battery status may be at a High level when the battery charge is within a pre-defined High range. According to certain embodiments, for example, user device 3802 may have been connected to a power supply between steps 3906 and 3942.

According to certain embodiments, in response to the device power state notification, smart space management server 3804 (e.g., via power estimation module 3816) may determine that UI transfer from user device 3802 is not (e.g., no longer) needed (e.g., for power saving purposes). According to embodiments, at operation 3950, smart space management server 3804 may send a Terminate UI Transfer Request signal to UI 3904 of display device 3806b. According to certain embodiments, a Terminate UI Transfer Request may cause an Update UI event to be sent to display device 3806b at operation 3952 to prompt a user for terminating the UI transfer to display device 3806b.

According to embodiments, at operation 3954, the user may interact with display device 3806b to accept termination of the UI transfer from user device 3802 to display device 3806b. The UI transfer request may cause any of forwarding of an input event to UI 3904 at operation 3956 and sending of a Terminate UI Transfer Request signal from UI 3904 to smart space management server 3804 at operation 3958. According to certain embodiments, upon receiving the Terminate UI Transfer Request signal, smart space management server 3804 may send a UI Transfer Notification signal to user device 3802 at operation 3960 (e.g., for alerting the user that UI transfer has ended).

FIG. 40 illustrates an example process according to embodiments.

Referring to FIG. 40, example process 4000 is provided for the purpose of illustration only and is not limiting of embodiments. Example process 4000 may be performed by a power estimation module (e.g., power estimation module 3816) to determine whether to initiate a UI transfer from a user device. According to certain embodiments, example process 4000 may be performed within the user device itself

As shown in FIG. 40, process 4000 may be triggered by receipt of a device power state notification from the user device and may begin at operation 4002. According to certain embodiments, process 4000 may be triggered according to a result of comparing a battery status contained in the device power state notification to a plurality of power levels. According to certain embodiments, the plurality of power levels may include Very Low, Low, Medium, and High. According to certain embodiments, each of the plurality of power levels may correspond to a respective battery charge range.

In a case where the battery status is determined to be Very Low at operation 4002, process 4000 may proceed to operation 4022 for starting a power saving procedure and for initiating a UI transfer from the user device. Process 4000 terminates at operation 4024.

In a case where the battery status is determined to be Low at operation 4002, process 4000 may proceed to operation 4008, for making a query for ongoing user activity. According to certain embodiments, upon receiving a response to the query made at operation 4008, process 4000 may proceed to operation 4014 for determining whether or not ongoing user activity is present on the user device. According to certain embodiments, in a case where the response to the query indicates no ongoing user activity is present, process 4000 may terminate at operation 4016. According to certain embodiments, process 4000 may transition to operation 4022. For example, in a case where the response to the query indicates the presence of ongoing user activity, process 4000 may transition to operation 4022.

In a case where the battery status is determined to be Medium at operation 4002, process 4000 may proceed to operation 4006, for making a query for ongoing user activity. According to certain embodiments, upon receiving the response to the query, process 4000 may proceed to operation 4012 for determining whether or not ongoing user activity is present on the user device. According to certain embodiments, in a case where the response to the query indicates no ongoing user activity is present, process 4000 may terminate at operation 4010. According to certain embodiments, in a case where the response to the query indicates no ongoing user activity is present, process 4000 may transition to step 918, which includes making a query for future user activity. In such a case, when a response to the future activity query is received, process 4000 may proceed to operation 4020, which includes determining whether or not a need exists to preserve battery at the user device. According to certain embodiments, in a case where a need to preserve battery power at the user device exists, process 4000 may proceed to 4022, described above. According to certain embodiments, in a case where a need to preserve battery power at the user device does not exist, process 4000 may terminate at operation 4024.

In a case where the battery status is determined to be high at operation 4002, process 4000 may immediately terminate at operation 4004.

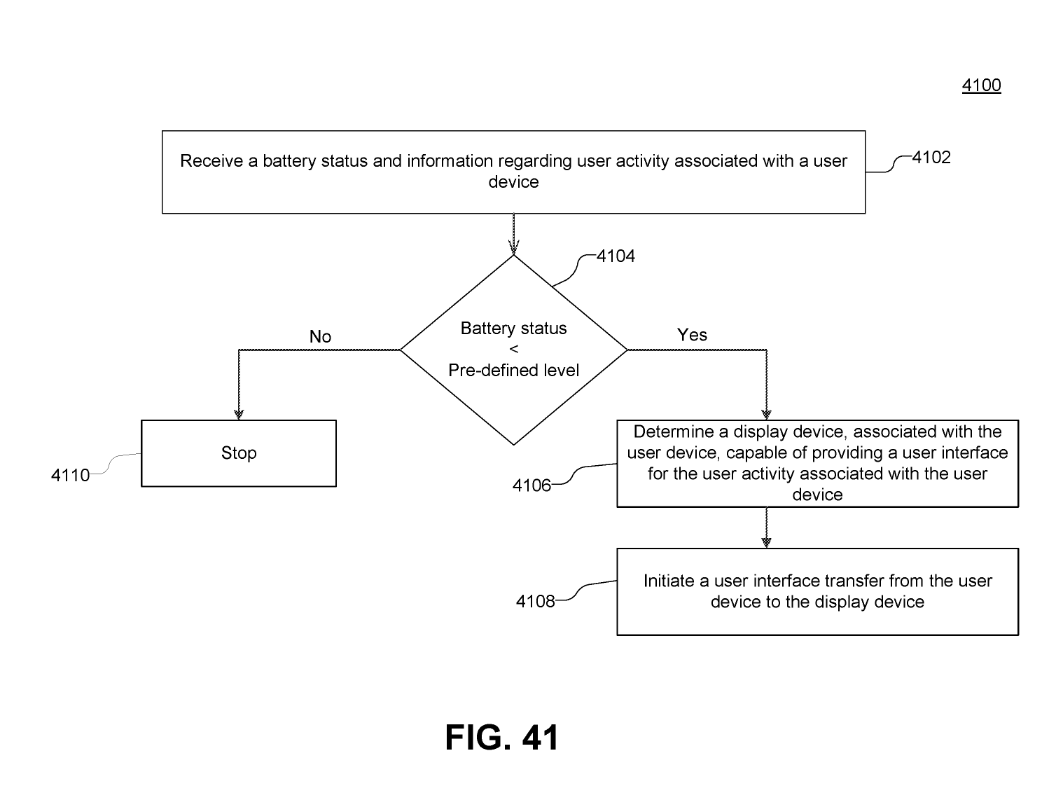

FIG. 41 illustrates an example process according to embodiments.

Referring to FIG. 41, example process 4100 is provided for the purpose of illustration only and is not limiting of embodiments. Example process 4100 may be performed by a smart space manager (e.g., smart space management server 3804).

As shown in FIG. 41, example process 4100 may begin at operation 4102, which includes receiving a battery status and information regarding user activity associated with a user device. According to certain embodiments, the information regarding user activity may include information regarding ongoing user activity on the user device. According to certain embodiments, the information regarding user activity may include information regarding anticipated user activity on the user device. According to certain embodiments, operation 4102 may include receiving the battery status in a device power state notification received from the user device. According to certain embodiments, operation 4102 may include receiving the information regarding user activity in response to sending a user activity query to the user device.

According to embodiments, at operation 4104, process 4100 may include determining whether the battery status associated with the user device is below a pre-defined level. According to certain embodiments, the pre-defined level may correspond to a High level. In such embodiments, in a case where the battery status is not below the pre-defined level (e.g., as determined at operation 4104), process 4100 may terminates in step 4110. In a case where the battery status is below the pre-defined level, process 4100 may proceed to operation 4106. According to certain embodiments, in a case where the battery level is below the pre-defined level but higher than a minimum level, process 4100 may further include (e.g., between operations 4104 and 4106) determining whether the received user activity indicates ongoing activity. In such a case, and further in a case where no ongoing activity is indicated (e.g., determined and/or detected in the received user activity), process 4100 may terminate. In a case where ongoing future activity is indicated, process 4100 may proceed to operation 4106. In a case where the battery level is below the pre-defined level but higher than a low level above the minimum level, process 4100 may further include, between operations 4104 and 4106, determining whether battery preservation is needed at the user device based on a future user activity query. According to certain embodiments, process 4100 may proceed to operations 4106 in a case where a future user activity response indicates anticipated user activity on the user device. According to certain embodiments, process 4100 may proceed to operation 4106 responsive to a predicted battery usage rate associated with the user device indicated in the future user activity response.

According to embodiments, operation 4106 may include determining a display device associated with the user device and/or capable of providing a user interface for the user activity associated with the user device. According to certain embodiments, the display device may include a low-capability embedded UI. According to certain embodiments, the display device may be associated with the user device based on proximity to the user device. According to certain embodiments, the display device may be associated with the user device based on an association with a user of the user device. According to certain embodiments, the association with the user of the user device may be established by the user interacting with the display device.

According to embodiments, process 4100 may terminate at operation 4108, which includes initiating a user interface transfer from the user device to the display device. According to certain embodiments, operation 4108 may include sending a user interface transfer request to the display device, and receiving a user interface transfer acceptance from the display device. According to certain embodiments, operation 4108 may include sending a user interface transfer notification to the user device. According to embodiments, the user interface transfer notification may cause the user device to enter a low power mode.

According to certain embodiments, process 4100 may include (e.g., after operation 4108) adapting content associated with the user activity associated with the user device based on capabilities of the display device and sending the adapted content to the display device for processing. According to embodiments, process 4100 may include terminating the user interface transfer from the user device to the display device. According to certain embodiments, the user interface transfer may be terminated in response to any of: (1) a notification of shutdown of the user device; (2) a change in the battery status of the user device; (3) a change in a predicted battery usage rate associated with the user device; and (4) user input terminating the user interface transfer received in the user device and/or the display device.

In the following, example scenarios in which embodiments may be practiced are provided. As would be understood by a person of skill in the art based on the teachings herein, embodiments are not limited by these examples.

In a first example, a user may be at an airport, about to embark on a journey that will take several hours, perhaps with layovers. The user may be reading an email while sitting on a chair in the airport lounge. The charge level of the battery of the user's device drops to a Medium level. The user device indicates its battery status to a smart space management server. In response, the smart space management server queries the user device for the current activity (e.g., email) on the user device, and then for an estimate of future user activity.

The smart space management server decides that there is a need for battery preservation at the user device, based on future user activity (e.g., estimated time to the next device charging opportunity, which may be derived from a variety of sources such as travel itinerary, target city traffic at estimated time of arrival, hotel location, etc.) and learned information regarding the user's device usage history, which gives an estimate of power consumption for the duration of the journey.

The smart space then queries for any alternate display devices in the vicinity of the user that may be used for transferring the UI from the user device in order to save battery (e.g., preserve batter power of the user device). A display device in the armrest of the chair can be associated with the user based on a variety of parameters, conditions, operations, inputs, sensors, etc., (e.g., RF proximity of the user device, a pressure sensor on the seat, the user having entered a PIN code in the display device).

The smart space begins the UI transfer from the user device to the display device in the chair armrest. The display device lights up prompting the user whether use of the user device via the UI in the armrest is desired, with an indication of battery saving mode. The user presses an accept button or enters a PIN code, and receives access to a set of functionalities of the user device via the armrest UI, at the benefit of not having to use the battery draining display of the user device.

In a second example, a user is having lunch at a café during a busy working day. A message arrives on the user's device. The battery on the user's device is half full. However, the user's device has informed a smart space management server in the café of a desire to save battery, based on an estimate that the battery might not last until the end of the workday, given the user's calendar markings and past device usage history.

A display device on the table comes to life, alerting the user that the battery on the user's device might run low during the day, and asking whether the user would like to read the message on the tabletop display. The tabletop display offers a lower user experience and less privacy, but the user still decides to accept the request to preserve battery, and reads the message on the tabletop display. The user then writes a reply on the tabletop display, and presses the Send button to have the primary user device send the message.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1-5.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed is:

1. A method of selecting for control a first device available on a network and of generating a user interface on a user interface device to operate the first device via the network, the method comprising:
detecting a pattern drawn by a user on a user interface surface of the user interface device;
analyzing the pattern to determine whether the user drew a closed figure on the user interface surface;
in response to a determination that the user drew the closed figure, determining a shape associated with the closed figure drawn by the user;
selecting, based on the determined shape associated with the closed figure, the first device to control from a plurality of devices available on the network;
determining a plurality of control elements associated with the selected first device;
generating the user interface comprising the plurality of control elements, wherein a size of the user interface is based on a size of the closed figure drawn by the user;
rendering the user interface at a position on the user interface surface where the user drew the closed figure;
detecting a user interaction with one of the plurality of control elements of the user interface on the user interface surface; and
in response to detecting the user interaction, sending a command over the network to operate the selected first device.

2. The method of claim 1 wherein the user interface surface of the user interface device comprises a touchscreen and the pattern drawn by the user on the user interface surface comprises a particular shape drawn by the user on the touchscreen.

3. The method of claim 1 wherein the shape associated with the closed figure comprises a shape of the closed figure itself.

4. The method of claim 1 wherein of the shape associated with the closed figure comprises an other shape drawn by the user on the user interface surface in proximity to the closed figure.

5. The method of claim 1 wherein generating the user interface further comprises generating the user interface of a same shape as the closed figure drawn by the user.

6. The method of claim 1 wherein the closed figure is a closed geometric shape that is any of a rectangular or a circular or a triangular shape.

7. The method of claim 1 wherein
the shape associated with the closed figure comprises an other shape drawn by the user on the user interface surface within the closed figure, wherein the other shape drawn by the user on the user interface surface within the closed figure comprises any of a letter, a number, or other language character.

8. The method of claim 1 wherein determining the shape associated with the closed figure drawn by the user further comprises:
transmitting data representing the pattern drawn by the user to a management node on the network; and
receiving a response indicating a shape recognized from the data representing the pattern.

9. The method of claim 1 wherein selecting, based on the determined shape associated with the closed figure, the first device to control from the plurality of devices available on the network further comprises:
consulting a database that stores an association between shapes and controllable devices of the plurality of devices available on the network; and
selecting the first device to control from among the controllable devices based on the determined shape associated with the closed figure.

10. The method of claim 1 wherein sending the command over the network to operate the selected first device comprises at least one of:
sending the command to the selected device over the network, or
sending the command to a management node over the network.

11. An apparatus configured to select for control a first device available on a network and configured to generate a user interface on a user interface device to operate the first device via the network comprising:
a receiver;
a transmitter; and
a processor configured to:
detect a pattern drawn by a user on a user interface surface of the user interface device;
analyze the pattern to determine whether the user drew a closed figure on the user interface surface;
in response to a determination that the user drew the closed figure, determine a shape associated with the closed figure drawn by the user;
select, based on the determined shape associated with the closed figure, the first device to control from a plurality of devices available on the network;
determine a plurality of control elements associated with the selected first device;
generate the user interface comprising the plurality of control elements, wherein a size of the user interface is based on a size of the closed figure drawn by the user;
render the user interface at a position on the user interface surface where the user drew the closed figure;
detect a user interaction with one of the plurality of control elements of the user interface on the user interface surface; and
in response to detecting the user interaction, send a command over the network to operate the selected first device.

12. The apparatus of claim 11 wherein the apparatus comprises the user interface device and wherein the user interface device comprises any of: a touchscreen, a speaker, and a microphone, and wherein the user interface device comprises the transmitter and the receiver.

13. The method of claim 10 wherein the management node comprises a smart space management server on the network.

14. The method of claim 1 wherein the
user interface surface is embedded in the armrest of a chair, and wherein the user interface surface is activated based on sensors in the chair which are configured to detect at least one of the user sitting on a seat of the chair or the user resting an arm on the armrest of the chair.

15. The apparatus of claim 11 wherein the shape associated with the closed figure comprises an other shape drawn by the user on the user interface surface within the closed figure, wherein the other shape drawn by the user on the user interface surface within the closed figure comprises any of a letter, a number, or other language character.

16. The apparatus of claim 11 wherein the user interface
surface of the user interface device comprises a touchscreen and the pattern drawn by the user on the user interface surface comprises a particular shape drawn by the user on the touchscreen.

17. The apparatus of claim 11 wherein
the shape associated with the closed figure comprises a shape of the closed figure itself.

18. The apparatus of claim 11 wherein
the shape associated with the closed figure comprises an other shape drawn by the user on the user interface surface in proximity to the closed figure.

19. The apparatus of claim 11 wherein generating the user interface further comprises generating the user interface of a same shape as the closed figure drawn by the user.

20. The apparatus of claim 11 wherein the
closed figure is a closed geometric shape that is any of a rectangular or a circular or a triangular shape.

21-81. (canceled)
